(19) United States
(12) Patent Application Publication
(10) Pub. No.: US 2025/0118468 A1
(43) Pub. Date: Apr. 10, 2025

(54) GRAIN-ORIENTED ELECTRICAL STEEL SHEET AND METHOD FOR MANUFACTURING SAME

(71) Applicant: NIPPON STEEL CORPORATION, Tokyo (JP)

(72) Inventors: Haruhiko ATSUMI, Tokyo (JP); Ryutaro YAMAGATA, Tokyo (JP); Takashi KATAOKA, Tokyo (JP); Takaaki HIRAYAMA, Tokyo (JP)

(73) Assignee: NIPPON STEEL CORPORATION, Tokyo (JP)

(21) Appl. No.: 18/832,028

(22) PCT Filed: Mar. 31, 2023
(86) PCT No.: PCT/JP2023/013466

§ 371 Date: Jul. 22, 2024

(30) Foreign Application Priority Data
Mar. 31, 2022 (JP) 2022-060901

(51) Int. Cl. H01F 1/147; C21D 6/00; C21D 8/12; C21D 9/46; C22C 38/00; C22C 38/02; C22C 38/04; C22C 38/06; C22C 38/08; C22C 38/16; C22C 38/34; C22C 38/40; C22C 38/60

(52) U.S. Cl. CPC H01F 1/14775; C21D 6/001; C21D 6/002; C21D 6/004; C21D 6/005; C21D 6/008; C21D 8/1222; C21D 8/1233; C21D 8/1255; C21D 8/1261; C21D 8/1283; C21D 9/46; C22C 38/001; C22C 38/002; C22C 38/004; C22C 38/008; C22C 38/02; C22C 38/04; C22C 38/06; C22C 38/08; C22C 38/16; C22C 38/34; C22C 38/40; C22C 38/60; C22C 2202/02

(57) ABSTRACT

This grain-oriented electrical steel sheet is characterized in that the base steel sheet has a chemical composition containing, in mass %, Si:2.5-4.5%, Mn:0.01-1.00%, N:≤0.01%, C:≤0.01%, sol.A1:0.01%, S:≤0.01%, Se:≤0.01%, P:0.00-0.05%, Sb:0.00-0.50%, Sn:0.00-0.30%, Cr:0.00-0.50%, Cu:0.00-0.50%, Ni:0.00-0.50%, and Bi:0.0000-0.0100%, with the remainder including Fe and impurities, the magnetic flux density B8 in the rolling direction of the sheet is ≥1.93 T, a deformed region extending over the entire width of the sheet is periodically formed at an interval L of 3-30 mm, in a direction intersecting the rolling direction, this region has a width W of 0.2-30.6 mm, a protrusion having a maximum height Dₚᵣₒₜᵣᵤₛᵢₒₙ of 1-5 m is formed on one surface of this region, and a recessed part having a maximum depth D_{recess} of 1-4 μm is formed on the opposite surface.

### TECHNICAL FIELD OF THE INVENTION

The present invention relates to a grain-oriented electrical steel sheet and a method for manufacturing the same.

The present application claims priority based on Japanese Patent Application No. 2022-060901 filed in Japan on Mar. 31, 2022, the contents of which are incorporated herein by reference.

### RELATED ART

A grain-oriented electrical steel sheet is a soft magnetism material, and is mainly used as an iron core material of a transformer. Thus, the grain-oriented electrical steel sheet is required to have magnetic characteristics such as high magnetization characteristics and a low iron loss.

The iron loss is a power loss due to consumption as thermal energy that occurs when the iron core is excited by an AC magnetic field, and the iron loss is required to be as low as possible from the viewpoint of energy saving. The largest dominant factor of the iron loss characteristics is the magnetic flux density (for example, magnetic flux density in a magnetic field of B8:800 A/m), and the higher the value of the magnetic flux density, the lower the iron loss. In a grain-oriented electrical steel sheet, in order to increase the magnetic flux density, the crystal orientation is generally developed, in the manufacturing process, in the Goss orientation ({1101<001> orientation), which is excellent in magnetic characteristics (the development degree of the orientation is increased). By refinement of the magnetic domain structure of the grain-oriented electrical steel sheet having a high magnetic flux density, a low iron loss is realized. In order to increase the development degree of the orientation according to the Goss orientation, high-temperature and long-time final annealing is usually performed. By the final annealing, grains in which the {110}<001> orientation is developed, that is, “Goss oriented grains” grow to a size in the order of cm while consuming the surrounding grains (secondary recrystallization), so that the crystal orientations are aligned (the development degree of the orientation is increased).

For improving the development degree of the orientation described above, in the technique described in Patent Documents 1 to 3, rapid heating is performed in the temperature-raising step of the decarburization annealing step to enrich the Goss oriented grains as the nucleus of secondary recrystallization in the steel sheet. Then, after the secondary recrystallization, a large number of grains with crystal orientations having small deviation from the Goss orientation are formed. The crystal structure thus configured achieves a high magnetic flux density.

### CITATION LIST

### Patent Document

### Patent Document 1

Japanese Unexamined Patent Application, First Publication No. H07-62436

### Patent Document 2

Japanese Unexamined Patent Application, First Publication No. H10-280040

### Patent Document 3

Japanese Unexamined Patent Application, First Publication No. 2003-096520

### SUMMARY OF INVENTION

### Problems to be Solved by the Invention

As a specific method of rapidly heating a steel sheet, there are methods such as energization heating and induction heating. However, in order to further reduce the iron loss by the above-described prior art, it is necessary to increase the temperature rising rate as compared with the conventional case. Thus, it is necessary to increase the size of the apparatus, which leads to an increase in equipment cost and manufacturing cost. In addition, there is a possibility that temperature unevenness in the steel sheet becomes significant, and there is a possibility that deterioration of the shape of the steel sheet and variation in magnetic characteristics in the final product occur. Furthermore, when the temperature rising rate is increased as compared with the conventional case, the Goss oriented grains as nuclei of secondary recrystallization are enriched, but the {111}<112> oriented grains that promote the growth of the Goss oriented grains in the secondary recrystallization process decrease. As described above, there is a limit to increasing the development degree of the orientation and realizing a high magnetic flux density only by simply increasing the temperature rising rate. When a grain-oriented electrical steel sheet is used as an iron core material of a transformer, it is also important to increase a space factor. Here, the space factor is schematically, in a stacked body formed by stacking several grain-oriented electrical steel sheets, a ratio of a total volume of the grain-oriented electrical steel sheets to a total volume (including voids) of the stacked body.

The present invention has been made to solve the above problems, and an object of the present invention is to provide a grain-oriented electrical steel sheet from which an iron core having a high magnetic flux density and a high space factor can be manufactured, and a method for manufacturing the grain-oriented electrical steel sheet.

### Means for Solving the Problem

In order to solve the above problems, according to an aspect of the present invention, there is provided a grain-oriented electrical steel sheet that is characterized in that the base steel sheet has a chemical composition containing, in mass %, Si: 2.5 to 4.5%, Mn: 0.01 to 1.00%, N: 0.01% or less, C: 0.01% or less, sol.A1: 0.01% or less, S: 0.01% or less, Se: 0.01% or less, P: 0.00 to 0.05%, Sb: 0.00 to 0.50%, Sn: 0.00 to 0.30%, Cr: 0.00 to 0.50%, Cu: 0.00 to 0.50%, Ni: 0.00 to 0.50%, and Bi: 0.0000 to 0.0100%, with the remainder including Fe and impurities, the magnetic flux density B8 in the rolling direction of the grain-oriented electrical steel sheet is 1.93 T or more, a deformed region extending over the entire width of the grain-oriented electrical steel sheet is periodically formed at an interval L of 3 mm or more and 30 mm or less, in a direction intersecting the rolling direction of the grain-oriented electrical steel sheet, the deformed region has a width W of 0.2 mm or more and 30.6 mm or less, a protrusion having a maximum height Dₚᵣₒₜᵣᵤₛᵢₒₙ of 1 μm or more and 5 μm or less is formed on one surface of the deformed region, and a recessed part having a maximum depth D_{recess} of 1 μm or more and 4 μm or less is formed on the opposite surface.

According to another aspect of the present invention, there is provided a grain-oriented electrical steel sheet that is characterized in that the base steel sheet has a chemical composition containing, in mass %, Si: 2.5 to 4.5%, Mn: 0.01 to 1.00%, N: 0.01% or less, C: 0.01% or less, sol.A1: 0.01% or less, S: 0.01% or less, Se: 0.01% or less, P: 0.00 to 0.05%, Sb: 0.00 to 0.50%, Sn: 0.00 to 0.30%, Cr: 0.00 to 0.50%, Cu: 0.00 to 0.50%, Ni: 0.00 to 0.50%, and Bi: 0.0000 to 0.0100%, with the remainder including Fe and impurities, the magnetic flux density B8 in the rolling direction of the grain-oriented electrical steel sheet is 1.93 T or more, a deformed region extending over the entire width of the grain-oriented electrical steel sheet is periodically formed at an interval L of 3 mm or more and 30 mm or less, in a direction intersecting the rolling direction of the grain-oriented electrical steel sheet, the deformed region has a width W of 0.2 mm or more and 30.6 mm or less, a protrusion having a maximum height Dₚᵣₒₜᵣᵤₛᵢₒₙ of 1 μm or more and 8 μm or less is formed on one surface of the deformed region, a recessed part having a maximum depth D_{recess} of 1 μm or more and 8 μm or less is formed on the opposite surface, and the protrusion has a steepness 2Dₚᵣₒₜᵣᵤₛᵢₒₙ/W of 0.0001 or more and less than 0.0050.

In the deformed region, the ratio of the area of the grains whose crystal orientation is deviated from the Goss orientation by 150 or more to the entire area of the deformed region may be 5% or less.

The chemical composition of the base steel sheet may contain, in mass %, one or more selected from the group consisting of P: 0.01 to 0.05%, Sb: 0.01 to 0.50%, Sn: 0.01 to 0.30%, Cr: 0.01 to 0.50%, Cu: 0.01 to 0.50%, Ni: 0.01 to 0.50%, and Bi: 0.0001 to 0.0100%.

According to another aspect of the present invention, there is provided a method for manufacturing a grain-oriented electrical steel sheet that is characterized in that the method includes a hot rolling step of heating a slab having a chemical composition that contains, in mass %, Si: 2.5 to 4.5%, Mn: 0.01 to 1.00%, N: 0.01 to 0.02%, C: 0.02 to 0.10%, sol.Al: 0.01 to 0.05%, the total of one or two of S and Se: 0.01 to 0.05%, P: 0.00 to 0.05%, Sn: 0.00 to 0.30%, Sb: 0.00 to 0.50%, Cr: 0.00 to 0.50%, Cu: 0.00 to 0.50%, Ni: 0.00 to 0.50%, and Bi: 0.0000 to 0.0100%, with the remainder including Fe and impurities, and hot rolling the heated slab to form a hot-rolled steel sheet; a hot-band annealing step of annealing the hot-rolled steel sheet; a cold rolling step of performing cold rolling on the hot-rolled steel sheet after the hot-band annealing step to form a cold-rolled steel sheet; a decarburization annealing step of subjecting the cold-rolled steel sheet to decarburization annealing to form a decarburized annealed steel sheet; a final annealing step of applying an annealing separator to the decarburized annealed steel sheet and then performing final annealing that forms a glass film on a surface of the decarburized annealed steel sheet to form a final annealed sheet; and an insulating film forming step of applying an insulating film-forming liquid to the final annealed sheet and then performing heat treatment to form an insulating film on a surface of the final annealed sheet, the decarburization annealing step includes a partial rapid heating step of heating the cold-rolled steel sheet to a temperature of 200° C. or more and 550° C. or less in a non-oxidizing atmosphere and under a tension of 0.2 kg/mm² or more and 1.2 kg/mm² or less and partial rapid heating a surface of the cold-rolled steel sheet over the entire width of the cold-rolled steel sheet, at an interval L within a range represented by Expression (1), in a direction intersecting the rolling direction; and a temperature-raising step of raising the temperature of the cold-rolled steel sheet after the partial rapid heating step from a temperature range of 550° C. or lower to a temperature range of 750 to 950° C. at an average heating rate of 5° C./s or more and 2000° C./s or less in a non-oxidizing atmosphere; and Expressions (2) to (4) are satisfied when the average intensity applied to a portion to be partially and rapidly heated that is subjected to the partial rapid heating is denoted by P (W), the diameter in the rolling direction of the portion to be partially and rapidly heated is denoted by Dl (mm), the diameter in the sheet width direction of the portion to be partially and rapidly heated is denoted by Dc (mm), the scanning speed in the sheet width direction of the portion to be partially and rapidly heated is denoted by Vc (mm/s), the irradiation energy density is denoted by Up=4/π×P/(Dl×Vc), and the instantaneous power density is denoted by Ip=4/π×P/(Dl×Dc).

$$3 mm \leq L \leq 30 mm \qquad ( 1 )$$

$$L / 50 \leq D 1 \leq L / 2 \qquad ( 2 )$$

$$5 J / {mm}^{2} \leq Up \leq 48 J / {mm}^{2} \qquad ( 3 )$$

$$0.05 kW / {mm}^{2} \leq Ip \leq 4.99 kW / {mm}^{2} \qquad ( 4 )$$

Here, the irradiation energy density Up may further satisfy Expression (5).

$$5 J / {mm}^{2} \leq U p < 62.5 \times D 1 J / {mm}^{2} \qquad ( 5 )$$

The chemical composition of the slab may contain, in mass %, one or more selected from the group consisting of P: 0.01 to 0.05%, Sn: 0.01 to 0.30%, Sb: 0.01 to 0.50%, Cr: 0.01 to 0.50%, Cu: 0.01 to 0.50%, Ni: 0.01 to 0.50%, and Bi: 0.0001 to 0.0100%.

### Effects of the Invention

According to the above aspect of the present invention, it is possible to provide a grain-oriented electrical steel sheet from which an iron core having a high magnetic flux density and a high space factor can be manufactured, and a method for manufacturing the grain-oriented electrical steel sheet.

### BRIEF DESCRIPTION OF THE DRAWING

FIG. 1 is an explanatory view illustrating an external appearance of a grain-oriented electrical steel sheet according to the present embodiment.

### EMBODIMENTS OF THE INVENTION

### 1. Study by Present Inventors

Hereinafter, embodiments of the present invention will be described. First, studies conducted by the present inventors will be described. The present inventors have conducted research and development of a rapid heating technique by a new method to solve the above-described problems. As a result, the present inventors have found that the Goss orientation can be effectively enriched in the steel sheet by applying various heating methods, such as laser beam, electron beam, infrared heating, dielectric heating, microwave heating, arc heating, plasma heating, induction heating, or electric resistance heating, to a part of the steel sheet, particularly by instantaneously heating the surface layer (from the outermost surface to about ⅕ t (t: sheet thickness) layer) from the steel sheet outermost surface. Furthermore, when the temperature rising rate of the annealing of the other region other than the partially heated region of the present method is appropriately set, it is possible to realize a state in which {111}<112>, which is the coincidence site lattice orientation, is enriched in the region (including a region from the surface layer of the steel sheet to the rear surface of the heated surface) other than the partially heated region. As a result, it is possible to realize a grain-oriented electrical steel sheet having excellent magnetic characteristics.

However, in the method for manufacturing a grain-oriented electrical steel sheet described above, since the steel sheet is partially rapidly heated, there is a problem that the shape of the heated portion becomes inferior (that is, it is greatly deformed) and the space factor decreases. That is, when this grain-oriented electrical steel sheet is used in a transformer, there is a problem that it does not sufficiently contribute to enhancement of the efficiency of the transformer.

Thus, the present inventors have extensively conducted studies on a method for manufacturing a grain-oriented electrical steel sheet capable of achieving both favorable magnetic characteristics and a favorable sheet shape even when the steel sheet is subjected to partial rapid heating, and as a result, have obtained the following findings.

### 2. Method for Manufacturing Grain-Oriented Electrical Steel Sheet

The method for manufacturing a grain-oriented electrical steel sheet according to the present embodiment includes the following steps.
(1) A hot rolling step of heating a slab having a predetermined composition and hot rolling the heated slab to form a hot-rolled steel sheet;
(2) a hot-band annealing step of annealing the hot-rolled steel sheet;
(3) a cold rolling step of performing cold rolling on the hot-rolled steel sheet after the hot-band annealing step to form a cold-rolled steel sheet;
(4) a decarburization annealing step of subjecting the cold-rolled steel sheet to decarburization annealing to form a decarburized annealed steel sheet;
(5) a final annealing step of applying an annealing separator to the decarburized annealed steel sheet and then performing final annealing that forms a glass film on a surface of the decarburized annealed steel sheet to form a final annealed sheet; and
(6) an insulating film forming step of applying an insulating film-forming liquid to the final annealed sheet and then performing heat treatment to form an insulating film on a surface of the final annealed sheet.

Each step will be described below. For steps or conditions that are not described, known steps and conditions can be applied.

### 2-1. Hot Rolling Step

In the hot rolling step, a slab having a predetermined composition is heated, and the heated slab is hot rolled to form a hot-rolled steel sheet. Here, the heating temperature is not particularly limited, but is preferably 1100° C. or higher. When the heating temperature is lower than 1100° C., the inclusion formed in the slab cannot be dissolved, and there is a possibility that inhibitors are not sufficiently formed in the hot rolling step or the hot-band annealing step described later. Thus, the heating temperature of the slab is preferably 1100° C. or higher. The upper limit of the slab heating temperature is not limited, but heating at higher than 1450° C. may melt the slab or the like, making hot rolling difficult. Thus, the slab heating temperature is preferably 1450° C. or lower.

The hot rolling conditions are not particularly limited, and may be appropriately set based on required characteristics. The thickness of the hot-rolled steel sheet obtained by hot rolling is preferably, for example, in a range of 1.0 mm or more and 4.0 mm or less.

### 2-2. Chemical Composition of Slab

In order to obtain preferable magnetic characteristics as a grain-oriented electrical steel sheet, the chemical composition of the slab subjected to hot rolling is in the following range. In the following description, unless otherwise specified, the notation “%” represents “mass %” with respect to the total mass of the slab.

### Si: 2.5 to 4.5%

Silicon (Si) is an extremely effective element for increasing electric resistance (specific resistance) of steel to reduce eddy-current loss constituting a part of iron loss. When the Si content of the slab is less than 2.5%, the resistivity is small, and the eddy-current loss cannot be sufficiently reduced. In addition, since the steel undergoes phase transformation in the final annealing, secondary recrystallization does not sufficiently proceed, and a favorable magnetic flux density and a low iron loss cannot be obtained. Thus, the Si content of the slab is 2.5% or more. The Si content of the slab is preferably 2.6% or more, more preferably 2.7% or more.

On the other hand, when the Si content exceeds 4.5%, the steel sheet is embrittled, and passability of the sheet in the manufacturing step is remarkably deteriorated. Thus, the Si content of the slab is 4.5% or less. The Si content of the slab is preferably 4.4% or less, more preferably 4.2% or less.

### Mn: 0.01 to 1.00%

Manganese (Mn) is an important element that forms MnS or MnSe, which is one of the major inhibitors. When the Mn content of the slab is less than 0.01%, the absolute amount of MnS or MnSe required to cause secondary recrystallization is insufficient. Thus, the Mn content of the slab is 0.01% or more. The Mn content is preferably 0.03% or more, more preferably 0.06% or more.

On the other hand, when the Mn content of the slab exceeds 1.00%, the steel undergoes phase transformation in the final annealing, secondary recrystallization does not sufficiently proceed, and a favorable magnetic flux density and a low iron loss cannot be obtained. Thus, the Mn content of the slab is 1.00% or less. The Mn content is preferably 0.98% or less, more preferably 0.96% or less.

### N: 0.01 to 0.02%

Nitrogen (N) is an element that reacts with sol.Al (acid-soluble aluminum) described later to form AlN that functions as an inhibitor. In order to sufficiently form AlN functioning as an inhibitor, the N content is 0.01% or more.

On the other hand, when the N content is more than 0.02%, blisters (pores) are generated in the steel sheet during cold rolling, the strength of the steel sheet increases, and passability of the sheet during manufacture deteriorates. Thus, the N content of the slab is 0.020% or less.

### C: 0.02 to 0.10%

Carbon (C) is an element exhibiting an effect of improving the magnetic flux density, but when the C content of the slab exceeds 0.10%, productivity in the decarburization annealing step decreases. In addition, when the C content of the slab is large and decarburization is insufficient, steel undergoes phase transformation in secondary recrystallization annealing (that is, final annealing), and secondary recrystallization does not sufficiently proceed, as a result of which a favorable magnetic flux density and a low iron loss cannot be obtained, or magnetic characteristics are deteriorated due to magnetic aging. Thus, the C content of the slab is 0.10% or less. The lower the C content, the better for productivity and iron loss reduction. From the viewpoint of productivity and iron loss reduction, the C content is preferably 0.09% or less, and more preferably 0.08% or less.

On the other hand, when the C content of the slab is less than 0.02%, the effect of improving the magnetic flux density cannot be obtained. Thus, the C content of the slab is 0.02% or more. The C content is preferably 0.04% or more, more preferably 0.06% or more.

### sol.Al: 0.01 to 0.05%

Acid-soluble aluminum (sol.Al) is a constituent element of a main inhibitor among compounds called inhibitors that influence secondary recrystallization in the grain-oriented electrical steel sheet, and is an essential element from the viewpoint of development of secondary recrystallization in the base steel sheet according to the present embodiment. When the sol.Al content of the slab is less than 0.01%, AlN functioning as an inhibitor is not sufficiently generated, and secondary recrystallization becomes insufficient. Thus, the content of sol.Al is 0.01% or more. The content of sol.Al is preferably 0.02% or more.

On the other hand, when the content of sol.Al exceeds 0.05%, AlN functioning as an inhibitor is not sufficiently generated, and secondary recrystallization becomes insufficient. Thus, the content of sol.Al is 0.05% or less. The content of sol.Al is preferably 0.04% or less, and more preferably 0.03% or less.

### Total of One or Two of S and Se: 0.01 to 0.05%

Sulfur (S) and Selenium (Se) are important elements that react with the Mn to form inhibitors MnS and MnSe. Since MnS or MnSe is required to form as the inhibitor, one of S and Se may be contained in the slab, or two of S and Se may be contained in the slab. When the total of one or two of S and Se is less than 0.01%, a sufficient inhibitor is not formed. Thus, the total of one or two of S and Se is 0.01% or more. The total of one or two of S and Se is preferably 0.02% or more.

On the other hand, when the total of one or two of S and Se exceeds 0.05%, hot embrittlement is caused, and hot rolling is significantly difficult. Thus, the total of one or two of S and Se is 0.05% or less. The total of one or two of S and Se is preferably 0.04% or less, and more preferably 0.03% or less.

The slab may contain one or more optional additive elements listed below in addition to the elements described above.

### P: 0.00 to 0.05%

Phosphorus (P) is an element that lowers the workability in rolling. By setting the P content to 0.05% or less, it is possible to suppress excessive reduction in rolling workability and to suppress fracture during manufacture. From such a viewpoint, the P content is 0.05% or less. The P content is preferably 0.04% or less, and more preferably 0.03% or less.

The lower limit of the P content is not limited, and may include 0.00%, but P is also an element having an effect of improving the texture and improving the magnetic characteristics. In order to obtain this effect, the P content may be 0.005% or more or 0.01% or more.

### Sn: 0.00 to 0.30%

Tin (Sn) is an element having an effect of improving magnetic characteristics. Thus, Sn may be contained in the slab. When Sn is contained, the content of Sn is preferably 0.01% or more in order to favorably exhibit the effect of improving magnetic characteristics. The Sn content is preferably 0.03% or more, and more preferably 0.05% or more in consideration of both magnetic characteristics and film adhesion.

On the other hand, when the Sn content exceeds 0.30%, the glass film is remarkably deteriorated, and tension sufficient for magnetic domain refinement cannot be obtained, as a result of which iron loss characteristics are deteriorated. Thus, the Sn content is 0.30% or less. The Sn content is preferably 0.20% or less, more preferably 0.10% or less.

### Sb: 0.00 to 0.50%

Antimony (Sb) is an element having an effect of improving magnetic characteristics. Thus, it may be contained in the slab. When Sb is contained, the content of Sb is preferably 0.01% or more in order to favorably exhibit the effect of improving magnetic characteristics. The Sb content is more preferably 0.02% or more.

On the other hand, when the Sb content exceeds 0.50%, the adhesion of the glass film is deteriorated. Thus, the Sb content is 0.50% or less. The Sb content is preferably 0.40% or less.

### Cr: 0.00 to 0.50%

Chromium (Cr) is an element that contributes to an increase in the occupancy rate of the Goss orientation in the secondary recrystallization structure to improve the magnetic characteristics, and contributes to an improvement in the adhesion of the glass film, similarly to Sn and Cu described later. Thus, it may be contained in the slab. In order to obtain the above effect, the Cr content is preferably 0.01% or more, more preferably 0.02% or more, and still more preferably 0.03% or more.

On the other hand, when the Cr content exceeds 0.50%, Cr oxide is formed, and the magnetic characteristics are deteriorated. Thus, the Cr content is 0.50% or less. The Cr content is preferably 0.30% or less, more preferably 0.10% or less.

### Cu: 0.00 to 0.50%

Copper (Cu) is an element that contributes to an increase in the occupancy rate of the Goss orientation in the secondary recrystallization structure and contributes to an improvement in the adhesion of the glass film. Thus, it may be contained. In the case of obtaining the above effect, the Cu content is preferably 0.01% or more. The Cu content is more preferably 0.02% or more, still more preferably 0.03% or more.

On the other hand, when the Cu content exceeds 0.50%, the steel sheet is embrittled during hot rolling. Thus, the Cu content of the slab is 0.50% or less. The Cu content is preferably 0.30% or less, more preferably 0.10% or less.

### Ni: 0.00 to 0.50%

Nickel (Ni) is an element effective for increasing electric resistance and reducing iron loss. Ni is an element effective for controlling the metallographic structure of the hot-rolled steel sheet to enhance the magnetic characteristics. Thus, Ni may be contained. In the case of obtaining the above effect, the Ni content is preferably 0.01% or more. The Ni content is more preferably 0.02% or more.

On the other hand, when the Ni content is more than 0.50%, secondary recrystallization may become unstable. Thus, the Ni content is 0.50% or less. The Ni content is preferably 0.30% or less.

### Bi: 0.0000 to 0.0100%

Bi has an effect of enhancing the function of inhibitors and improving magnetic characteristics. However, when the Bi content exceeds 0.0100%, Bi adversely affects the formation of the glass film, and thus the Bi content is preferably 0.0100% or less. The Bi content is preferably 0.0050% or less, more preferably 0.0030% or less. The lower limit of the Bi content may be 0%, but since the above-described effect can be expected, the Bi content may be 0.0001% or more or 0.0005% or more.

### Remainder: Fe and Impurities

The chemical composition of the slab used in the method for manufacturing a grain-oriented electrical steel sheet according to the present embodiment may contain the above-described elements, and the remainder may be Fe and impurities. Here, the impurity is an element that is a contaminant derived from ore or scrap as a raw material, a manufacturing environment, or the like when the base steel sheet is industrially manufactured, and means an element that is allowed to be contained in a content that does not adversely affect the operation of the grain-oriented electrical steel sheet according to the present embodiment.

The chemical composition of the slab described above may be measured by a general analysis method. For example, the steel components may be measured using Inductively Coupled Plasma-Atomic Emission Spectrometry (ICP-AES). C and S may be measured by a combustion-infrared absorption method, N may be measured by an inert gas fusion-thermal conductivity method, and O may be measured by an inert gas fusion-non-dispersive infrared absorption method.

### 2-3. Hot-Band Annealing Step

The hot-band annealing step is a step of annealing the hot-rolled steel sheet manufactured through the hot rolling step. By performing such an annealing treatment, recrystallization occurs in the metallographic structure, and favorable magnetic characteristics can be realized.

In the hot-band annealing step of the present embodiment, the hot-rolled steel sheet manufactured through the hot rolling step may be annealed according to a known method. Methods for heating the hot-rolled steel sheet at the time of annealing is not particularly limited, and a known heating method can be adopted. The annealing conditions are also not particularly limited, but for example, the hot-rolled steel sheet can be annealed in a temperature range of 900 to 1200° C. for 10 seconds to 5 minutes.

### 2-4. Cold Rolling Step

In the cold rolling step, the hot-rolled steel sheet after the hot-band annealing step is subjected to cold rolling including a plurality of passes to form a cold-rolled steel sheet. The cold rolling may be one time of cold rolling, or a plurality of times of cold rolling including an intermediate annealing therebetween may be performed by interrupting the cold rolling and performing at least one or two times of intermediate annealing before the final pass of the cold rolling step. In addition, the type of rolling apparatus used in the cold rolling is not limited, and may be a tandem rolling mill, a reverse rolling mill, or a rolling method combining them.

When the intermediate annealing is performed, it is preferable to hold the intermediate annealing at a temperature of 1000 to 1200° C. for 5 to 180 seconds. The annealing atmosphere is not particularly limited. The number of times of intermediate annealing is preferably three or less in consideration of manufacturing cost. Before the cold rolling step, the surface of the hot-rolled steel sheet may be subjected to pickling under known conditions.

### 2-5. Decarburization Annealing Step

In the decarburization annealing step, the cold-rolled steel sheet is subjected to decarburization annealing to form a decarburized annealed steel sheet. In decarburization annealing, the cold-rolled steel sheet is primarily recrystallized, and C that adversely affects magnetic characteristics is removed from the steel sheet. Details of the decarburization annealing step will be described later.

### 2-6. Final Annealing Step

In the final annealing step, a predetermined annealing separator is applied to one surface or both surfaces of the decarburized annealed steel sheet obtained in the decarburization annealing step, and then final annealing is performed. In this way, a final annealed sheet is produced. By the final annealing, grains in which the {1101<001> orientation is developed, that is, “Goss oriented grains” grow to a size in the order of cm while consuming the surrounding grains (secondary recrystallization), so that the crystal orientations are aligned (the development degree of the orientation is increased). The final annealing is generally performed for a long time in a state where the steel sheet is wound in a coil shape. Thus, prior to the final annealing, an annealing separator is applied to the decarburized annealed steel sheet and dried for the purpose of preventing seizure inside and outside the winding of the coil.

As the annealing separator to be applied, an annealing separator containing MgO as a main component (for example, containing 80% or more in terms of weight fraction) is used. By using an annealing separator containing MgO as a main component, a glass film can be formed on the surface of the base steel sheet. When MgO is not the main component, no glass film is formed. This is because the glass film is made of an Mg₂SiO₄ or MgAl₂O₄ compound, and Mg necessary for the formation reaction is insufficient when MgO is not a main component. The glass film may or may not be formed.

The final annealing may be performed, for example, under conditions in which the temperature is raised to 1150 to 1250° C. in an atmosphere gas containing hydrogen and nitrogen, and annealing is performed in the temperature range for 10 to 60 hours.

### 2-7. Insulating Film Forming Step

In the insulating film forming step, an insulating film-forming liquid is applied to the final annealed sheet, and then heat treatment is performed to form an insulating film on the surface of the final annealed sheet. By this heat treatment, an insulating film is formed on the surface of the final annealed steel sheet. For example, the insulating film-forming liquid may contain colloidal silica and phosphate. The insulating film-forming liquid may contain chromium. In addition, in order to reduce the iron loss, the magnetic domain refinement treatment may be performed after the formation of the insulating film. For example, mechanical strain as a groove or the like may be imparted by a roller or the like, or linear thermal strain may be imparted by a laser or the like.

### 2-8. Details of Decarburization Annealing Step

Next, details of the decarburization annealing step will be described. The decarburization annealing step includes a partial rapid heating step and a temperature-raising step.

### 2-8-1. Partial Rapid Heating Step

In the partial rapid heating step, the cold-rolled steel sheet is heated to a temperature of 200° C. or more and 550° C. or less in a non-oxidizing atmosphere and under a tension of 0.2 kg/mm² or more and 1.2 kg/mm² or less, and a surface of the cold-rolled steel sheet is partially and rapidly heated over the entire width of the cold-rolled steel sheet, at an interval L within a range represented by Expression (1), in a direction intersecting the rolling direction (for example, in a direction of 30 to 150 degrees, preferably 60 to 120 degrees, more preferably 80 to 100 degrees with respect to the rolling direction, still more preferably approximately perpendicular to the rolling direction (90 degrees)).

$$3 mm \leq L \leq 30 mm \qquad ( 1 )$$

The non-oxidizing atmosphere is, for example, a nitrogen atmosphere. When the hydrogen gas in the atmosphere is less than 4% by volume, oxygen may be contained at 100 ppm or less. When the atmosphere in the partial rapid heating step is not a non-oxidizing atmosphere, magnetism deterioration due to oxidation of a portion (partially and rapidly heated portion) irradiated with the laser described later and magnetism deterioration due to oxidation during heating of the cold-rolled steel sheet may occur.

A heating temperature of the cold-rolled steel sheet is 200° C. or more and less than 550° C. When the heating temperature of the cold-rolled steel sheet is lower than 200° C., shape deterioration of the cold-rolled steel sheet due to insufficient temperature may occur. When the heating temperature of the cold-rolled steel sheet exceeds 550° C., magnetism deterioration due to recovery may occur. The heating temperature of the cold-rolled steel sheet is preferably 250° C. or higher, and more preferably 300° C. or higher. The heating temperature of the cold-rolled steel sheet is preferably 500° C. or lower, and more preferably 450° C. or lower.

The tension applied to the cold-rolled steel sheet is 0.2 kg/mm² or more and 1.2 kg/mm² or less in the rolling direction (sheet passing direction). When the tension is less than 0.2 kg/mm², shape deterioration of the cold-rolled steel sheet due to insufficient tension may occur. When the tension exceeds 1.2 kg/mm², magnetism deterioration may occur. The tension is preferably 0.3 kg/mm² or more, more preferably 0.4 kg/mm² or more. The tension is preferably 1.1 kg/mm², more preferably 1.0 kg/mm².

Specific methods for partially rapidly heating the cold-rolled steel sheet include irradiation with a laser beam or an electron beam (hereinafter, these are collectively referred to as “beams”), infrared heating, dielectric heating, microwave heating, arc heating, plasma heating, induction heating, electric resistance heating, and the like. In the present embodiment, the surface of the cold-rolled steel sheet is partially rapidly heated by irradiating the entire width of the cold-rolled steel sheet with the beam at the interval L. Here, the interval L is 3 mm or more and 30 mm or less. When the interval L is less than 3 mm, the effect of the present embodiment cannot be obtained. When the interval L exceeds 30 mm, the effect of the present embodiment is reduced.

The interval L is preferably 5 mm or more, and more preferably 7 mm or more. The interval L is preferably 25 mm or less, and more preferably 20 mm or less.

Further, Expressions (2) to (4) are satisfied when the intensity applied to a portion to be partially and rapidly heated that is subjected to the partial rapid heating (for example, focused portion of the laser) is denoted by P (W), the diameter in the rolling direction of the portion to be partially and rapidly heated (for example, the diameter in the rolling direction of the focused diameter of the laser) is denoted by Dl (mm), the diameter in the sheet width direction of the portion to be partially and rapidly heated (for example, the diameter in the sheet width direction of the focused diameter of the laser) is denoted by Dc (mm), the scanning speed in the sheet width direction of the portion to be partially and rapidly heated (for example, the scanning speed of the laser) is denoted by Vc (mm/s), the irradiation energy density is denoted by Up=4/π×P/(Dl×Vc), and the instantaneous power density is denoted by Ip=4/π×P/(Dl×Dc).

$$L / 50 \leq D1 \leq L / 2 \qquad ( 2 )$$

$$5 J / {mm}^{2} \leq U p \leq 48 J / {mm}^{2} \qquad ( 3 )$$

$$0.05 kW / {mm}^{2} \leq I p \leq 4.99 kW / {mm}^{2} \qquad ( 4 )$$

The focused diameter Dl is L/50 or more and L/2 or less. When the focused diameter D1 is less than L/50, the partially and rapidly heated portion is insufficient, the secondary recrystallization nuclei become insufficient, and the secondary recrystallization failure generates. When the focused diameter Dl exceeds 2/L, the partially and rapidly heated portion becomes excessive, the coincidence site lattice orientation for promoting the growth of secondary recrystallization nuclei becomes insufficient, and the secondary recrystallization orientation deteriorates.

The focused diameter Dl is preferably L/25 or more, and more preferably 3L/50 or more. The focused diameter Dl is preferably 9L/20 or less, and more preferably 2L/5 or less.

The irradiation energy density Up is represented by 4/π×P/(Dl×Vc), and is 5 J/mm² or more and 48 J/mm² or less. When the irradiation energy density Up is less than 5 J/mm², recrystallization/grain growth of the surface layer of the steel sheet does not sufficiently proceed, and the effect by rapid heating cannot be obtained. When the irradiation energy density Up exceeds 48 J/mm², the microstructure of the surface layer of the steel sheet is significantly coarsened due to excessive heat input, and secondary recrystallization failure generates. In addition, since the shape of the steel sheet is also inferior, the irradiation energy density Up is limited to 48 J/mm² or less.

The irradiation energy density Up is preferably 45 J/mm² or less, more preferably 40 J/mm² or less, and still more preferably less than 62.5×Dl J/mm². That is, the irradiation energy density Up preferably further satisfies Expression (5).

$$5 J / {mm}^{2} \leq U p < 62.5 \times D 1 J / {mm}^{2} \qquad ( 5 )$$

The irradiation energy density Up is preferably 7 J/mm² or more, and more preferably 9 J/mm² or more.

The instantaneous power density is represented by Ip=4/π×P/(Dl×Dc), and is 0.05 kW/nm² or more and 4.99 kW/mm² or less. When the instantaneous power density is less than 0.05 kW/mm², the effect of rapid heating cannot be obtained, and the magnetism becomes inferior. When the instantaneous power density exceeds 4.99 kW/mm², defects are generated in the steel sheet.

The instantaneous power density is preferably 0.07 kW/mm² or more, and more preferably 0.09 kW/mm² or more. The instantaneous power density is preferably 4.0 kW/mm² or less, and more preferably 3.0 kW/mm² or less.

### 2-8-2. Temperature-Raising Step

In the temperature-raising step, the cold-rolled steel sheet after the partial rapid heating step is heated from a temperature range of 550° C. or lower to a temperature range of 750 to 950° C. at an average heating rate of 5° C./sec or more and 2000° C./sec or less in a non-oxidizing atmosphere. When the temperature of the cold-rolled steel sheet after the partial rapid heating step is higher than the temperature at the start of the temperature-raising step, the cold-rolled steel sheet is once cooled. The average here is a time average. When the temperature rising rate is less than 5° C./sec, the coincidence site lattice orientation for promoting the growth of the secondary recrystallization nuclei is excessive, and the magnetism becomes inferior. When the temperature rising rate exceeds 2000° C./sec, the coincidence site lattice orientation decreases, and the magnetism becomes inferior.

By the decarburization annealing step, C that adversely affects the magnetic characteristics can be removed from the steel sheet, and the Goss orientation can be enriched in the surface layer of the portion irradiated with the laser. Furthermore, {111}<112>, which is a coincidence site lattice orientation, can be enriched in the crystal orientations of the peripheral region. Furthermore, deformation of the portion irradiated with the laser can be suppressed, and the space factor can be increased. Thus, according to the present embodiment, it is possible to provide a method for manufacturing a grain-oriented electrical steel sheet capable of achieving both favorable magnetic characteristics and a favorable sheet shape even when the steel sheet is subjected to partial rapid heating with a laser beam, an electron beam, or the like.

### 2-9. Nitriding Treatment

In addition to the above-described treatment, a nitriding treatment may be performed. The nitriding treatment may be performed, for example, at a timing after decarburization is completed in the decarburization annealing step. The nitriding treatment may be performed under known conditions. Preferable nitriding treatment conditions are, for example, as follows.
Nitriding treatment temperature: 700 to 850° C.
Atmosphere in nitriding treatment furnace (nitriding treatment atmosphere): atmosphere containing hydrogen, nitrogen, and gas having nitriding ability such as ammonia

When the nitriding treatment temperature is 700° C. or higher, or the nitriding treatment temperature is 850° C. or lower, nitrogen easily enters the steel sheet during the nitriding treatment. When the nitriding treatment is performed within this temperature range, a preferable amount of nitrogen can be provided inside the steel sheet. Thus, fine AlN is favorably formed in the steel sheet before secondary recrystallization. As a result, secondary recrystallization is favorably developed during the final annealing. The time for holding the steel sheet at the nitriding treatment temperature is not particularly limited, and may be, for example, 10 to 60 seconds.

### 3. Configuration of Grain-Oriented Electrical Steel Sheet

### 3-1. Chemical Composition

Next, a configuration of a grain-oriented electrical steel sheet manufactured by the above-described method for manufacturing a grain-oriented electrical steel sheet will be described. First, the chemical composition of the grain-oriented electrical steel sheet will be described. In the following description, unless otherwise specified, the notation “%” represents “mass %” with respect to the total mass of the base steel sheet. The base steel sheet means a steel sheet portion of the grain-oriented electrical steel sheet.

### Si: 2.5 to 4.5%

Silicon (Si) is an extremely effective element for increasing electric resistance (specific resistance) of steel to reduce eddy-current loss constituting a part of iron loss. When the Si content of the base steel sheet is less than 2.5%, the resistivity is small, and the eddy-current loss cannot be sufficiently reduced. In addition, since the steel undergoes phase transformation in the secondary recrystallization annealing, the secondary recrystallization does not sufficiently proceed, and a favorable magnetic flux density and a low iron loss cannot be obtained. Thus, the Si content of the base steel sheet is 2.5% or more. The Si content of the slab is preferably 2.6% or more, more preferably 2.7% or more.

On the other hand, when the Si content exceeds 4.5%, the steel sheet is embrittled, and passability of the sheet in the manufacturing step is remarkably deteriorated. Thus, the Si content of the base steel sheet is 4.5% or less. The Si content of the base steel sheet is preferably 4.4% or less, and more preferably 4.2% or less.

### Mn: 0.01 to 1.00%

In the grain-oriented electrical steel sheet, Mn is present as a solid solution Mn. Since the solid solution Mn increases the resistivity, it can reduce the iron loss. Thus, it may be contained in a content of 0.01 to 1.00% in the grain-oriented electrical steel sheet. Since the solid solution Mn has a smaller effect of increasing the resistivity than Si and the content is smaller than that of Si, the effect is limited.

### N: 0.01% or Less

N is a raw material of AlN as an inhibitor as described above, but the content is preferably as low as possible because N is an element that adversely affects the magnetic characteristics of the grain-oriented electrical steel sheet. In the present embodiment, the content of N is 0.01% or less. The lower limit includes 0, but it is industrially difficult to reduce the content to completely 0, and thus about 0.0005% is the substantial lower limit.

### C: 0.01% or Less

Since C is an element that adversely affects the magnetic characteristics of the grain-oriented electrical steel sheet, the content of C is preferably as low as possible. In the present embodiment, the content of C is 0.01% or less. The lower limit includes 0, but it is industrially difficult to reduce the content to completely 0, and thus about 0.0005% is the substantial lower limit.

### sol.Al: 0.01% or Less

As described above, sol.Al is a raw material of AlN as an inhibitor, but the content is preferably as low as possible because sol.Al is an element that adversely affects the magnetic characteristics of the grain-oriented electrical steel sheet. In the present embodiment, the content of sol.Al is 0.01% or less. The lower limit includes 0, but it is industrially difficult to reduce the content to completely 0, and thus about 0.0005% is the substantial lower limit.

### S: 0.01% or Less, Se: 0.01% or Less

S and Se are raw materials of MnS and MnSe as inhibitors, but the contents are preferably as low as possible because S and Se are elements that adversely affect the magnetic characteristics of the grain-oriented electrical steel sheet. In the present embodiment, the contents of S and Se are 0.01% or less. The lower limit includes 0, but it is industrially difficult to reduce the content to completely 0, and thus about 0.0005% is the substantial lower limit.

The grain-oriented electrical steel sheet may further contain any one or more selected from the group consisting of P: 0.00 to 0.05%, Sb: 0.00 to 0.50%, Sn: 0.00 to 0.30%, Cr: 0.00 to 0.50%, Cu: 0.00 to 0.50%, Ni: 0.00 to 0.50%, and Bi: 0.0000 to 0.0100% as optional additive elements. These preferable contents and characteristics are as described above. In the grain-oriented electrical steel sheet, the remainder is iron and impurities. The definition of impurities is as described above.

The chemical composition of the base steel sheet described above may be measured by a general analysis method. For example, the steel components may be measured using Inductively Coupled Plasma-Atomic Emission Spectrometry (ICP-AES). C and S may be measured by a combustion-infrared absorption method, N may be measured by an inert gas fusion-thermal conductivity method, and O may be measured by an inert gas fusion-non-dispersive infrared absorption method.

### 3-2. Characteristics of Grain-Oriented Electrical Steel Sheet

The magnetic flux density B8 in the rolling direction of the grain-oriented electrical steel sheet is 1.93 T or more. As described above, the grain-oriented electrical steel sheet according to the present embodiment has high magnetic characteristics. The magnetic flux density B8 in the rolling direction of the grain-oriented electrical steel sheet is preferably 1.94 T or more, and more preferably 1.95 T or more. In order to obtain a magnetic flux density B8 of 1.94 T or more, for example, the irradiation energy density Up may be set to 5 to 41 J/mm², and the temperature rising rate in the temperature-raising step may be set to 20 to 1500° C./sec.

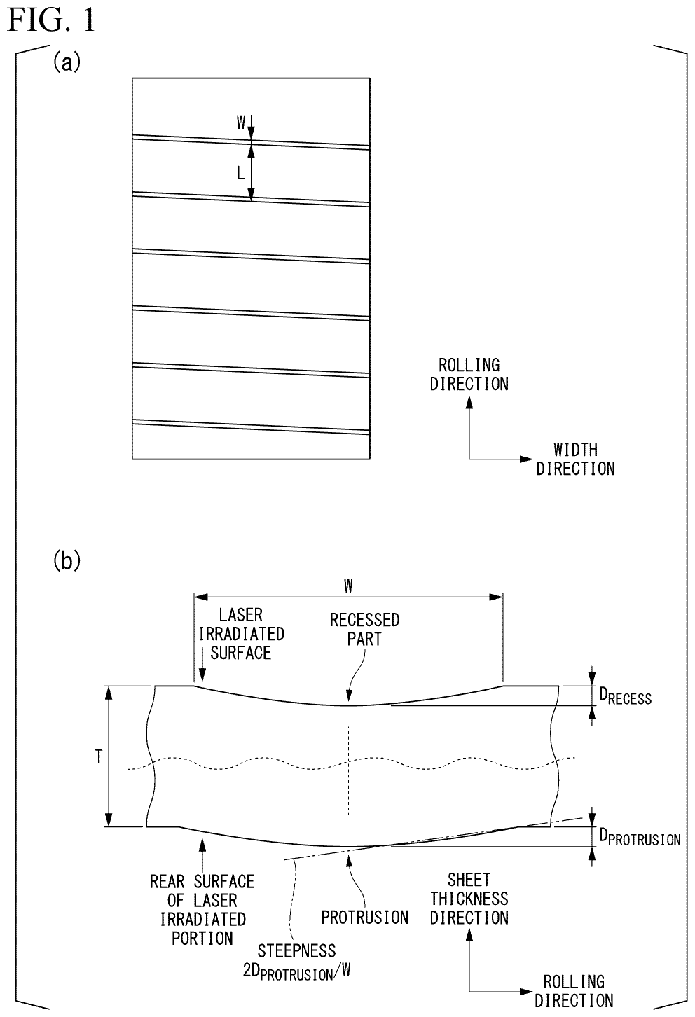

A deformed region extending over the entire width of the grain-oriented electrical steel sheet is periodically formed at an interval L of 3 mm or more and 30 mm or less, in a direction intersecting the rolling direction of the grain-oriented electrical steel sheet (for example, 30 to 150 degrees with respect to the rolling direction). Such a deformed region is formed by the decarburization annealing step described above. The deformed region has a width W of 0.2 mm or more and 30.6 mm or less. A protrusion having a maximum height Dₚᵣₒₜᵣᵤₛᵢₒₙ of 5 μm or less is formed on one surface of the deformed region, and a recessed part having a maximum depth D_{recess} of 4 μm or less is formed on the opposite surface. Alternatively, a protrusion having a maximum height Dₚᵣₒₜᵣᵤₛᵢₒₙ of 8 μm or less is formed on one surface of the deformed region, a recessed part having a maximum depth D_{recess} of 8 μm or less is formed on the opposite surface, and the protrusion has a steepness 2Dₚᵣₒₜᵣᵤₛᵢₒₙ/W of 0.0001 or more and less than 0.0050. As described above, since the degree of deformation of the deformed region, which is the region irradiated with the laser, is suppressed to be low, the space factor can be increased. The external appearance of the grain-oriented electrical steel sheet is shown in FIGS. 1 (a) and 1 (b). FIG. 1 (a) is a plan view of a grain-oriented electrical steel sheet, and FIG. 1 (b) is a side sectional view of a deformed region (a sectional view perpendicular to a surface of the grain-oriented electrical steel sheet). The lower limits of the maximum height Dₚᵣₒₜᵣᵤₛᵢₒₙ and the maximum depth D_{recess} are about 1 μm because the steel sheet is slightly deformed when partial rapid heating is applied. In FIG. 1 (b), Reference T represents the sheet thickness of the grain-oriented electrical steel sheet.

Here, when a protrusion having a maximum height Dₚᵣₒₜᵣᵤₛᵢₒₙ of 8 μm or less is formed on one surface of the deformed region and a recessed part having a maximum depth D_{recess} of 8 μm or less is formed on the opposite surface, the protrusion has a steepness 2Dₚᵣₒₜᵣᵤₛᵢₒₙ/W of preferably 0.0001 or more and less than 0.0050. In this case, the space factor can be further increased. Here, in order to obtain a steepness 2Dₚᵣₒₜᵣᵤₛᵢₒₙ/W of 0.0001 or more and less than 0.0050, for example, in the decarburization annealing step described above, Up may be set to less than 62.5×Dl J/mm². When a protrusion having a maximum height Dₚᵣₒₜᵣᵤₛᵢₒₙ of 5 μm or less is formed on one surface of the deformed region and a recessed part having a maximum depth D_{recess} of 4 μm or less is formed on the opposite surface, the magnitude of the steepness 2Dₚᵣₒₜᵢᵤₛᵢₒₙ/W is not particularly limited. That is, according to the above-described method for manufacturing a grain-oriented electrical steel sheet, the maximum height of protrusion Dₚᵣₒₜᵣᵤₛᵢₒₙ is at least 8 μm or less, and the maximum depth of recessed part D_{recess} is 8 μm or less. When the maximum height of protrusion Dₚᵣₒₜᵣᵤₛᵢₒₙ exceeds 5 μm or when the maximum depth of recessed part D_{recess} exceeds 4 μm, the steepness 2Dₚᵣₒₜᵣᵤₛᵢₒₙ/W is preferably 0.0001 or more and less than 0.0050. When the steepness is calculated, the unit of the maximum height of protrusion Dₚᵣₒₜᵣᵤₛᵢₒₙ is converted to mm to match with the unit of the width of deformed region W before calculation of the steepness.

Furthermore, in the deformed region, the ratio (area fraction) of the area of grains (abnormal grains) whose crystal orientation is deviated from the Goss orientation by 15° or more to the entire area of the deformed region is preferably 5% or less. This can further enhance the magnetic characteristics of the grain-oriented electrical steel sheet. In order to obtain such a crystal orientation, for example, in the decarburization annealing step described above, Up may be set to 48 J/mm² or less.

Thus, the grain-oriented electrical steel sheet according to the present embodiment can achieve both favorable magnetic characteristics and a favorable sheet shape. That is, from the grain-oriented electrical steel sheet according to the present embodiment, an iron core having a high magnetic flux density and a high space factor can be manufactured.

### EXAMPLES

### 1. Example 1

Next, the effects of one aspect of the present invention will be more specifically described in detail with reference to Examples, but the conditions in Examples are one example of conditions adopted to confirm the feasibility and effects of the present invention, and the present invention is not limited to this one example of conditions. The present invention can adopt various conditions as long as the object of the present invention is achieved without departing from the gist of the present invention.

A slab was prepared in which the chemical composition contained, in mass %, C: 0.08%, Si: 3.3%, Mn: 0.08%, S: 0.02%, sol.Al: 0.03%, and N: 0.01%, with the remainder being Fe and impurities.

This slab was heated to 1350° C. in a heating furnace. A hot rolling step was performed on the heated slab to manufacture a hot-rolled steel sheet having a sheet thickness of 2.3 mm. The hot-rolled steel sheet was subjected to a hot-band annealing step of annealing, and then to cold rolling to manufacture a cold-rolled steel sheet having a thickness of 0.22 mm. A decarburization annealing step was performed on the cold-rolled steel sheet after the cold rolling step. In this decarburization annealing step, partial rapid heating with a laser beam was performed on one surface of the steel sheet under the conditions shown in Tables 1A to C before the temperature was raised. In Example 1, the focused diameter in the rolling direction Dl and the laser irradiation interval L were varied. The scanning direction of the laser was set to 90 degrees with respect to the rolling direction. At this time, the focused diameter in the width direction Dc and the scanning speed Vc were adjusted such that the irradiation energy density Up and the instantaneous power density Ip did not varied.

After the partial rapid heating, the steel sheet was primary recrystallized by heating in a non-oxidizing atmosphere containing hydrogen and nitrogen at the temperature rising rate shown in Tables 1D to F, then the decarburization annealing temperature was set to 830° C., and the steel sheet was soaked for 60 seconds. At this time, the atmosphere in the heat treatment furnace for performing the decarburization annealing treatment was a wet atmosphere containing hydrogen and nitrogen. An annealing separator (water slurry) containing MgO as a main component was applied to the surface of the steel sheet after decarburization annealing, and then the steel sheet was wound into a coil shape. The steel sheet wound in a coil shape was subjected to final annealing.

On the steel sheet after the final annealing step, an insulating film forming step was performed. In the insulating film forming step, an insulating coating agent mainly composed of colloidal silica and phosphate was applied to the surface (on the glass film) of the grain-oriented electrical steel sheet after the final annealing step, and then baking was performed. In this way, an insulating film as a high-tension insulating film was formed on the glass film. A grain-oriented electrical steel sheet of each Test No. was manufactured by the above manufacturing steps.

### 1-1. Removal of Film

The chemical composition of the base steel sheet can be measured by a well-known component analysis method. First, the primary film (glass film) and the secondary film (insulating film) are removed from the base steel sheet by the following method. Specifically, the grain-oriented electrical steel sheet including the secondary film is immersed in a high-temperature alkaline solution to remove the secondary film. The composition and temperature of the alkali solution, and the immersion time may be appropriately adjusted. For example, the grain-oriented electrical steel sheet including a secondary film is immersed in a sodium hydroxide aqueous solution of NaOH: 30 to 50 mass %+H₂O: 50 to 70 mass % at 80 to 90° C. for 5 to 10 minutes, and after immersion, washed with water, and dried. By this step, the secondary film is removed from the grain-oriented electrical steel sheet.

Further, the grain-oriented electrical steel sheet from which the secondary film has been removed and on which the primary film remains is immersed in high-temperature hydrochloric acid to remove the primary film. The concentration and temperature of the hydrochloric acid, and the immersion time may be appropriately adjusted. For example, the grain-oriented electrical steel sheet from which the secondary film has been removed and on which the primary film remains is immersed in 30 to 40 mass % hydrochloric acid at 80 to 90° C. for 1 to 5 minutes, and after immersion, washed with water, and dried. Through the above steps, a base steel sheet from which the secondary film and the primary film have been removed is obtained.

### 1-2. Measurement Experiment of Chemical Composition of Base Steel Sheet

The chemical composition of the base steel sheet of the grain-oriented electrical steel sheet of each Test No. was measured by the following method. First, the primary film and the secondary film of the grain-oriented electrical steel sheet were removed by the above-described method to extract the base steel sheet. Using the base steel sheet, the chemical composition of the base steel sheet was analyzed based on the following [Method for measuring chemical composition of steel sheet].

The chips were collected from the obtained base steel sheet. The collected chips were dissolved in an acid to obtain a solution. The solution was subjected to Inductively Coupled Plasma Atomic Emission Spectrometry (ICP-AES) to perform elemental analysis of chemical composition. The C content and the S content were determined by a well-known high frequency combustion method (combustion-infrared absorption method). The N content was determined using a well-known inert gas fusion-thermal conductivity method. Specifically, measurement was performed using a component analyzer (trade name: ICPS-8000) manufactured by Shimadzu Corporation.

The results of the analysis showed that the chemical composition of the base steel sheet in any of the Test Nos. in Example 1 contained, in mass %, C: 0.01% or less, Si: 3.3%, Mn: 0.08%, S: 0.01% or less, sol.Al: 0.01% or less, and N: 0.01% or less, with the remainder being Fe and impurities.

The magnetic characteristic (magnetic flux density B8 value) of the grain-oriented electrical steel sheet of each Test No. was evaluated in accordance with JIS C2556 (2015). The obtained magnetic flux density B8 is shown in Tables 1D to F

The shape of the deformed region of the grain-oriented electrical steel sheet of each Test No. was measured by the following method. That is, using a commercially available surface roughness measurement device (SE3500, manufactured by Kosaka Laboratory Ltd.) and SE2555N (radius of tip curvature: 2 μm) as a stylus of the detection unit, under a setting of a measurement length in the rolling direction of 15 mm per measurement, measurement was performed continuously 5 times, whereby the surface roughness over a length of 75 mm in total was measured. The measurement was performed in both the front and the rear. W, Dₚᵣₒₜᵣᵤₛᵢₒₙ, and D_{recess} at each of five points in the measurement regions of the front and the rear were measured, and evaluated by an average value thereof. The width of the obtained deformed region W, the maximum depth of recessed part on one surface side of the deformed region D_{recess}, and the maximum height of protrusion on the rear surface side of the deformed region Dₚᵣₒₜᵣᵤₛᵢₒₙ are shown in Tables 1D to F.

Further, the space factor of the grain-oriented electrical steel sheet of each Test No. was evaluated in accordance with JIS C2550-5 (2020). The obtained space factor is shown in Tables 1D to F.

Further, the area fraction of abnormal grains in the deformed region of the grain-oriented electrical steel sheet of each Test No. was measured by the following method. That is, the crystal orientation of the region with the width of deformed region W was measured at a pitch of 2 mm in the width direction of the grain-oriented electrical steel sheet along the center line in the longitudinal direction of the deformed region using a Laue diffractometer. Then, from the crystal orientation of each measurement point, the number of measurement points indicating abnormal grains having a deviation angle of 150 or more from the Goss orientation was extracted, and the ratio of the number of these measurement points to the total number of measurement points was taken as the area fraction of abnormal grains. However, for the steel No. with an inferior magnetism of less than 1.93 T in the measurement of the magnetic characteristics described above, measurement of the area fraction of abnormal grains by a Laue diffractometer was not performed. The area fraction of the obtained abnormal grains is shown in Tables 1D to F.

With reference to Tables 1A to F, in steel Nos. 1 to 10, the laser irradiation interval L was small, the laser effect was excessive, and the magnetic flux density was less than 1.93 T, which was inferior.

In steel Nos. 61 to 70, since the laser irradiation interval L was large, the laser irradiation effect was small, and the magnetic characteristic was less than 1.93 T, which was inferior.

In steel Nos. 11, 21, 31, 41, and 51, since the focused diameter in the rolling direction Dl was small relative to the laser irradiation interval L, the size of the rapidly heated portion was insufficient, and the magnetic flux density was less than 1.93 T, which was inferior.

In steel Nos. 20, 30, 40, 50, and 60, since the focused diameter in the rolling direction Dl was large relative to the laser irradiation interval L, the rapidly heated portion was excessive, and the magnetic flux density was less than 1.93 T, which was inferior.

In the steel No. other than the above, since all the manufacturing step conditions were appropriate, the magnetic flux density was 1.93 T or more, which was excellent, and the space factor was also as high as 96% or more.

TABLE 1A

| | Laser irradiation conditions | | | | | | | | | |
|---|---|---|---|---|---|---|---|---|---|---|
| | | | | Focused | Focused | | | | | |
| | | | Steel | diameter | diameter | | | Irradiation | Instantaneous | Laser |
| | | Steel sheet | sheet | in rolling | in width | | Speed | energy | power | irradiation |
| Steel | | temperature | tension | direction | direction | Output | Vc | density Up | density Ip | interval |
| No. | Atmosphere | ° C. | kg/mm² | Dl mm | Dc mm | P W | mm/s | J/mm² | kW/mm² | L mm |
| 1 | Nitrogen | 400 | 0.8 | 0.01 | 29.00 | 45 | 700.0 | 8 | 0.20 | 1 |
| 2 | Nitrogen | 400 | 0.8 | 0.02 | 14.00 | 45 | 360.0 | 8 | 0.20 | 1 |
| 3 | Nitrogen | 400 | 0.8 | 0.04 | 7.00 | 45 | 180.0 | 8 | 0.20 | 1 |
| 4 | Nitrogen | 400 | 0.8 | 0.06 | 5.00 | 45 | 120.0 | 8 | 0.19 | 1 |
| 5 | Nitrogen | 400 | 0.8 | 0.10 | 3.00 | 45 | 70.0 | 8 | 0.19 | 1 |
| 6 | Nitrogen | 400 | 0.8 | 0.20 | 1.50 | 45 | 35.0 | 8 | 0.19 | 1 |
| 7 | Nitrogen | 400 | 0.8 | 0.40 | 0.80 | 45 | 18.0 | 8 | 0.18 | 1 |
| 8 | Nitrogen | 400 | 0.8 | 0.45 | 0.60 | 45 | 16.0 | 8 | 0.21 | 1 |
| 9 | Nitrogen | 400 | 0.8 | 0.50 | 0.60 | 45 | 14.0 | 8 | 0.19 | 1 |
| 10 | Nitrogen | 400 | 0.8 | 0.60 | 0.50 | 45 | 12.0 | 8 | 0.19 | 1 |
| 11 | Nitrogen | 400 | 0.8 | 0.05 | 6.00 | 45 | 143.0 | 8 | 0.19 | 3 |
| 12 | Nitrogen | 400 | 0.8 | 0.06 | 5.00 | 45 | 120.0 | 8 | 0.19 | 3 |
| 13 | Nitrogen | 400 | 0.8 | 0.12 | 2.50 | 45 | 60.0 | 8 | 0.19 | 3 |
| 14 | Nitrogen | 400 | 0.8 | 0.18 | 1.50 | 45 | 40.0 | 8 | 0.21 | 3 |
| 15 | Nitrogen | 400 | 0.8 | 0.30 | 1.00 | 45 | 24.0 | 8 | 0.19 | 3 |
| 16 | Nitrogen | 400 | 0.8 | 0.60 | 0.50 | 45 | 12.0 | 8 | 0.19 | 3 |
| 17 | Nitrogen | 400 | 0.8 | 1.20 | 0.25 | 45 | 6.0 | 8 | 0.19 | 3 |
| 18 | Nitrogen | 400 | 0.8 | 1.35 | 0.22 | 45 | 5.0 | 8 | 0.19 | 3 |
| 19 | Nitrogen | 400 | 0.8 | 1.50 | 0.20 | 45 | 5.0 | 8 | 0.19 | 3 |
| 20 | Nitrogen | 400 | 0.8 | 1.60 | 0.18 | 45 | 4.5 | 8 | 0.20 | 3 |

TABLE 1B

| | Laser irradiation conditions | | | | | | | | | |
|---|---|---|---|---|---|---|---|---|---|---|
| | | | | Focused | Focused | | | | | |
| | | | Steel | diameter | diameter | | | Irradiation | Instantaneous | Laser |
| | | Steel sheet | sheet | in rolling | in width | | Speed | energy | power | irradiation |
| Steel | | temperature | tension | direction | direction | Output | Vc | density Up | density Ip | interval |
| No. | Atmosphere | ° C. | kg/mm² | Dl mm | Dc mm | P W | mm/s | J/mm² | kW/mm² | L mm |
| 21 | Nitrogen | 400 | 0.8 | 0.08 | 4.00 | 45 | 90.0 | 8 | 0.18 | 5 |
| 22 | Nitrogen | 400 | 0.8 | 0.10 | 3.00 | 45 | 70.0 | 8 | 0.19 | 5 |
| 23 | Nitrogen | 400 | 0.8 | 0.20 | 1.50 | 45 | 36.0 | 8 | 0.19 | 5 |
| 24 | Nitrogen | 400 | 0.8 | 0.30 | 1.00 | 46 | 24.0 | 8 | 0.20 | 5 |
| 25 | Nitrogen | 400 | 0.8 | 0.50 | 0.60 | 47 | 15.0 | 8 | 0.20 | 5 |
| 26 | Nitrogen | 400 | 0.8 | 1.00 | 0.30 | 48 | 8.0 | 8 | 0.20 | 5 |
| 27 | Nitrogen | 400 | 0.8 | 2.00 | 0.15 | 49 | 4.0 | 8 | 0.21 | 5 |
| 28 | Nitrogen | 400 | 0.8 | 2.30 | 0.13 | 45 | 3.0 | 8 | 0.19 | 5 |
| 29 | Nitrogen | 400 | 0.8 | 2.50 | 0.12 | 45 | 3.0 | 8 | 0.19 | 5 |
| 30 | Nitrogen | 400 | 0.8 | 2.60 | 0.11 | 45 | 2.8 | 8 | 0.20 | 5 |
| 31 | Nitrogen | 400 | 0.8 | 0.18 | 1.50 | 45 | 40.0 | 8 | 0.21 | 10 |
| 32 | Nitrogen | 400 | 0.8 | 0.20 | 1.50 | 45 | 36.0 | 8 | 0.19 | 10 |
| 33 | Nitrogen | 400 | 0.8 | 0.40 | 0.70 | 45 | 18.0 | 8 | 0.20 | 10 |
| 34 | Nitrogen | 400 | 0.8 | 0.60 | 0.50 | 45 | 12.0 | 8 | 0.19 | 10 |
| 35 | Nitrogen | 400 | 0.8 | 1.00 | 0.30 | 45 | 7.0 | 8 | 0.19 | 10 |
| 36 | Nitrogen | 400 | 0.8 | 2.50 | 0.12 | 45 | 3.0 | 8 | 0.19 | 10 |
| 37 | Nitrogen | 400 | 0.8 | 3.80 | 0.08 | 45 | 2.0 | 8 | 0.19 | 10 |
| 38 | Nitrogen | 400 | 0.8 | 4.50 | 0.07 | 45 | 1.5 | 8 | 0.18 | 10 |
| 39 | Nitrogen | 400 | 0.8 | 5.00 | 0.06 | 45 | 1.5 | 8 | 0.19 | 10 |
| 40 | Nitrogen | 400 | 0.8 | 5.20 | 0.05 | 45 | 1.3 | 8 | 0.22 | 10 |

TABLE 1C

| | Laser irradiation conditions | | | | | | | | | |
|---|---|---|---|---|---|---|---|---|---|---|
| | | | | Focused | Focused | | | | | |
| | | | Steel | diameter | diameter | | | Irradiation | Instantaneous | Laser |
| | | Steel sheet | sheet | in rolling | in width | | Speed | energy | power | irradiation |
| Steel | | temperature | tension | direction | direction | Output | Vc | density Up | density Ip | interval |
| No. | Atmosphere | ° C. | kg/mm² | Dl mm | Dc mm | P W | mm/s | J/mm² | kW/mm² | L mm |
| 41 | Nitrogen | 400 | 0.8 | 0.20 | 1.40 | 45 | 36.0 | 8 | 0.20 | 20 |
| 42 | Nitrogen | 400 | 0.8 | 0.40 | 0.70 | 45 | 18.0 | 8 | 0.20 | 20 |
| 43 | Nitrogen | 400 | 0.8 | 0.80 | 0.40 | 45 | 9.0 | 8 | 0.18 | 20 |
| 44 | Nitrogen | 400 | 0.8 | 1.20 | 0.25 | 45 | 6.0 | 8 | 0.19 | 20 |
| 45 | Nitrogen | 400 | 0.8 | 2.40 | 0.13 | 45 | 3.0 | 8 | 0.18 | 20 |
| 46 | Nitrogen | 400 | 0.8 | 4.00 | 0.07 | 45 | 1.8 | 8 | 0.20 | 20 |
| 47 | Nitrogen | 400 | 0.8 | 8.00 | 0.04 | 45 | 0.9 | 8 | 0.18 | 20 |
| 48 | Nitrogen | 400 | 0.8 | 9.00 | 0.03 | 45 | 0.8 | 8 | 0.21 | 20 |
| 49 | Nitrogen | 400 | 0.8 | 10.00 | 0.03 | 45 | 0.7 | 8 | 0.19 | 20 |
| 50 | Nitrogen | 400 | 0.8 | 10.50 | 0.03 | 45 | 0.7 | 8 | 0.18 | 20 |
| 51 | Nitrogen | 400 | 0.8 | 0.50 | 0.60 | 45 | 14.0 | 8 | 0.19 | 30 |
| 52 | Nitrogen | 400 | 0.8 | 0.60 | 0.50 | 45 | 12.0 | 8 | 0.19 | 30 |
| 53 | Nitrogen | 400 | 0.8 | 1.20 | 0.25 | 45 | 6.0 | 8 | 0.19 | 30 |
| 54 | Nitrogen | 400 | 0.8 | 1.80 | 0.15 | 45 | 4.0 | 8 | 0.21 | 30 |
| 55 | Nitrogen | 400 | 0.8 | 3.00 | 0.10 | 45 | 2.4 | 8 | 0.19 | 30 |
| 56 | Nitrogen | 400 | 0.8 | 6.00 | 0.05 | 45 | 1.2 | 8 | 0.19 | 30 |
| 57 | Nitrogen | 400 | 0.8 | 12.00 | 0.03 | 45 | 0.6 | 8 | 0.16 | 30 |
| 58 | Nitrogen | 400 | 0.8 | 13.50 | 0.02 | 45 | 0.5 | 8 | 0.21 | 30 |
| 59 | Nitrogen | 400 | 0.8 | 15.00 | 0.02 | 45 | 0.5 | 8 | 0.19 | 30 |
| 60 | Nitrogen | 400 | 0.8 | 17.00 | 0.02 | 45 | 0.4 | 8 | 0.17 | 30 |
| 61 | Nitrogen | 400 | 0.8 | 0.50 | 0.60 | 45 | 14.0 | 8 | 0.19 | 35 |
| 62 | Nitrogen | 400 | 0.8 | 0.70 | 0.40 | 45 | 10.0 | 8 | 0.20 | 35 |
| 63 | Nitrogen | 400 | 0.8 | 1.40 | 0.20 | 45 | 5.0 | 8 | 0.20 | 35 |
| 64 | Nitrogen | 400 | 0.8 | 2.10 | 0.15 | 45 | 3.5 | 8 | 0.18 | 35 |
| 65 | Nitrogen | 400 | 0.8 | 3.50 | 0.10 | 45 | 2.0 | 8 | 0.16 | 35 |
| 66 | Nitrogen | 400 | 0.8 | 7.00 | 0.04 | 45 | 1.0 | 8 | 0.20 | 35 |
| 67 | Nitrogen | 400 | 0.8 | 14.00 | 0.02 | 45 | 0.5 | 8 | 0.20 | 35 |
| 68 | Nitrogen | 400 | 0.8 | 17.00 | 0.02 | 45 | 0.4 | 8 | 0.17 | 35 |
| 69 | Nitrogen | 400 | 0.8 | 17.50 | 0.02 | 45 | 0.4 | 8 | 0.16 | 35 |
| 70 | Nitrogen | 400 | 0.8 | 18.00 | 0.02 | 45 | 0.4 | 8 | 0.16 | 35 |

TABLE 1D

| | | | | Maximum | | | | | |
|---|---|---|---|---|---|---|---|---|---|
| | | | Maximum | height of | | | | | |
| | | | depth of | protrusion | | | | | |
| | | | recessed | on rear | | | | | |
| | | | part on | surface | | | | | |
| | Temperature | | laser | of laser | | | | | |
| | rising rate in | Width of | irradiated | irradiated | | | Magnetic | | |
| | decarburization | deformed | surface | portion | | Ratio of | flux | | |
| Steel | annealing step | region | D_{recess} | Dₚᵣₒₜᵣᵤₛᵢₒₙ | Steepness | abnormal | density | Space | |
| No. | V ° C./s | W mm | mm | mm | 2Dₚᵣₒₜᵣᵤₛᵢₒₙ/W | grains % | B8 T | factor % | Remarks |
| 1 | 1000 | 0.1 | 0.001 | 0.003 | 0.0600 | — | 1.84 | 97 | Comparative |
| | | | | | | | | | Example |
| 2 | 1000 | 0.1 | 0.001 | 0.002 | 0.0400 | — | 1.90 | 97 | Comparative |
| | | | | | | | | | Example |
| 3 | 1000 | 0.2 | 0.001 | 0.002 | 0.0200 | — | 1.91 | 97 | Comparative |
| | | | | | | | | | Example |
| 4 | 1000 | 0.3 | 0.001 | 0.002 | 0.0133 | — | 1.92 | 97 | Comparative |
| | | | | | | | | | Example |
| 5 | 1000 | 0.4 | 0.001 | 0.001 | 0.0050 | — | 1.92 | 97 | Comparative |
| | | | | | | | | | Example |
| 6 | 1000 | 0.8 | 0.001 | 0.001 | 0.0025 | — | 1.92 | 98 | Comparative |
| | | | | | | | | | Example |
| 7 | 1000 | 1.0 | 0.001 | 0.001 | 0.0020 | — | 1.92 | 98 | Comparative |
| | | | | | | | | | Example |
| 8 | 1000 | 1.0 | 0.001 | 0.002 | 0.0040 | — | 1.91 | 98 | Comparative |
| | | | | | | | | | Example |
| 9 | 1000 | 0.9 | 0.001 | 0.001 | 0.0022 | — | 1.90 | 98 | Comparative |
| | | | | | | | | | Example |
| 10 | 1000 | 1.0 | 0.001 | 0.001 | 0.0020 | — | 1.88 | 98 | Comparative |
| | | | | | | | | | Example |
| 11 | 1000 | 0.2 | 0.001 | 0.002 | 0.0200 | — | 1.89 | 97 | Comparative |
| | | | | | | | | | Example |
| 12 | 1000 | 0.2 | 0.001 | 0.002 | 0.0200 | 0 | 1.93 | 97 | Invention |
| | | | | | | | | | Example |
| 13 | 1000 | 0.4 | 0.001 | 0.001 | 0.0050 | 0 | 1.93 | 97 | Invention |
| | | | | | | | | | Example |
| 14 | 1000 | 0.7 | 0.001 | 0.001 | 0.0029 | 0 | 1.94 | 98 | Invention |
| | | | | | | | | | Example |
| 15 | 1000 | 1.1 | 0.001 | 0.001 | 0.0018 | 0 | 1.94 | 98 | Invention |
| | | | | | | | | | Example |
| 16 | 1000 | 2.8 | 0.001 | 0.002 | 0.0014 | 0 | 1.94 | 98 | Invention |
| | | | | | | | | | Example |
| 17 | 1000 | 3.0 | 0.001 | 0.001 | 0.0007 | 0 | 1.94 | 98 | Invention |
| | | | | | | | | | Example |
| 18 | 1000 | 2.9 | 0.001 | 0.001 | 0.0007 | 0 | 1.93 | 98 | Invention |
| | | | | | | | | | Example |
| 19 | 1000 | 2.7 | 0.001 | 0.001 | 0.0007 | 0 | 1.93 | 98 | Invention |
| | | | | | | | | | Example |
| 20 | 1000 | 2.9 | 0.001 | 0.001 | 0.0007 | — | 1.91 | 98 | Comparative |
| | | | | | | | | | Example |

TABLE 1E

| | | | | Maximum | | | | | |
|---|---|---|---|---|---|---|---|---|---|
| | | | Maximum | height of | | | | | |
| | | | depth of | protrusion | | | | | |
| | | | recessed | on rear | | | | | |
| | | | part on | surface | | | | | |
| | Temperature | | laser | of laser | | | | | |
| | rising rate in | Width of | irradiated | irradiated | | | Magnetic | | |
| | decarburization | deformed | surface | portion | | Ratio of | flux | | |
| Steel | annealing step | region | D_{recess} | Dₚᵣₒₜᵣᵤₛᵢₒₙ | Steepness | abnormal | density | Space | |
| No. | V ° C./s | W mm | mm | mm | 2Dₚᵣₒₜᵣᵤₛᵢₒₙ/W | grains % | B8 T | factor % | Remarks |
| 21 | 1000 | 0.3 | 0.001 | 0.002 | 0.0133 | — | 1.88 | 97 | Comparative |
| | | | | | | | | | Example |
| 22 | 1000 | 0.5 | 0.001 | 0.002 | 0.0080 | 0 | 1.93 | 97 | Invention |
| | | | | | | | | | Example |
| 23 | 1000 | 0.8 | 0.001 | 0.001 | 0.0025 | 0 | 1.93 | 98 | Invention |
| | | | | | | | | | Example |
| 24 | 1000 | 1.1 | 0.001 | 0.001 | 0.0018 | 0 | 1.94 | 98 | Invention |
| | | | | | | | | | Example |
| 25 | 1000 | 2.0 | 0.001 | 0.001 | 0.0010 | 0 | 1.94 | 98 | Invention |
| | | | | | | | | | Example |
| 26 | 1000 | 4.2 | 0.001 | 0.002 | 0.0010 | 0 | 1.94 | 98 | Invention |
| | | | | | | | | | Example |
| 27 | 1000 | 5.0 | 0.001 | 0.001 | 0.0004 | 0 | 1.94 | 98 | Invention |
| | | | | | | | | | Example |
| 28 | 1000 | 5.0 | 0.001 | 0.001 | 0.0004 | 0 | 1.93 | 98 | Invention |
| | | | | | | | | | Example |
| 29 | 1000 | 5.0 | 0.001 | 0.002 | 0.0008 | 0 | 1.93 | 98 | Invention |
| | | | | | | | | | Example |
| 30 | 1000 | 5.0 | 0.001 | 0.001 | 0.0004 | — | 1.91 | 98 | Comparative |
| | | | | | | | | | Example |
| 31 | 1000 | 0.7 | 0.001 | 0.001 | 0.0029 | 0 | 1.89 | 98 | Comparative |
| | | | | | | | | | Example |
| 32 | 1000 | 0.9 | 0.001 | 0.001 | 0.0022 | 0 | 1.94 | 98 | Invention |
| | | | | | | | | | Example |
| 33 | 1000 | 1.8 | 0.001 | 0.001 | 0.0011 | 0 | 1.94 | 98 | Invention |
| | | | | | | | | | Example |
| 34 | 1000 | 2.2 | 0.001 | 0.001 | 0.0009 | 0 | 1.95 | 98 | Invention |
| | | | | | | | | | Example |
| 35 | 1000 | 4.3 | 0.001 | 0.001 | 0.0005 | 0 | 1.95 | 98 | Invention |
| | | | | | | | | | Example |
| 36 | 1000 | 7.8 | 0.001 | 0.001 | 0.0003 | 0 | 1.95 | 98 | Invention |
| | | | | | | | | | Example |
| 37 | 1000 | 9.8 | 0.001 | 0.002 | 0.0004 | 0 | 1.95 | 98 | Invention |
| | | | | | | | | | Example |
| 38 | 1000 | 9.9 | 0.001 | 0.001 | 0.0002 | 0 | 1.94 | 98 | Invention |
| | | | | | | | | | Example |
| 39 | 1000 | 9.8 | 0.001 | 0.001 | 0.0002 | 0 | 1.94 | 98 | Invention |
| | | | | | | | | | Example |
| 40 | 1000 | 10.0 | 0.001 | 0.001 | 0.0002 | — | 1.92 | 98 | Comparative |
| | | | | | | | | | Example |

TABLE 1F

| | | | | Maximum | | | | | |
|---|---|---|---|---|---|---|---|---|---|
| | | | Maximum | height of | | | | | |
| | | | depth of | protrusion | | | | | |
| | | | recessed | on rear | | | | | |
| | | | part on | surface | | | | | |
| | Temperature | | laser | of laser | | | | | |
| | rising rate in | Width of | irradiated | irradiated | | | Magnetic | | |
| | decarburization | deformed | surface | portion | | Ratio of | flux | | |
| Steel | annealing step | region | D_{recess} | Dₚᵣₒₜᵣᵤₛᵢₒₙ | Steepness | abnormal | density | Space | |
| No. | V ° C./s | W mm | mm | mm | 2Dₚᵣₒₜᵣᵤₛᵢₒₙ/W | grains % | B8 T | factor % | Remarks |
| 41 | 1000 | 1.1 | 0.001 | 0.002 | 0.0036 | — | 1.90 | 98 | Comparative |
| | | | | | | | | | Example |
| 42 | 1000 | 1.7 | 0.001 | 0.001 | 0.0012 | 0 | 1.94 | 98 | Invention |
| | | | | | | | | | Example |
| 43 | 1000 | 3.3 | 0.001 | 0.001 | 0.0006 | 0 | 1.94 | 98 | Invention |
| | | | | | | | | | Example |
| 44 | 1000 | 4.6 | 0.001 | 0.002 | 0.0009 | 0 | 1.95 | 98 | Invention |
| | | | | | | | | | Example |
| 45 | 1000 | 7.7 | 0.001 | 0.001 | 0.0003 | 0 | 1.95 | 98 | Invention |
| | | | | | | | | | Example |
| 46 | 1000 | 15.8 | 0.001 | 0.001 | 0.0001 | 0 | 1.95 | 98 | Invention |
| | | | | | | | | | Example |
| 47 | 1000 | 19.8 | 0.001 | 0.002 | 0.0002 | 0 | 1.95 | 98 | Invention |
| | | | | | | | | | Example |
| 48 | 1000 | 21.0 | 0.001 | 0.001 | 0.0001 | 0 | 1.94 | 98 | Invention |
| | | | | | | | | | Example |
| 49 | 1000 | 20.6 | 0.001 | 0.001 | 0.0001 | 0 | 1.94 | 98 | Invention |
| | | | | | | | | | Example |
| 50 | 1000 | 19.7 | 0.001 | 0.001 | 0.0001 | — | 1.92 | 98 | Comparative |
| | | | | | | | | | Example |
| 51 | 1000 | 2.0 | 0.001 | 0.001 | 0.0010 | — | 1.88 | 98 | Comparative |
| | | | | | | | | | Example |
| 52 | 1000 | 2.2 | 0.001 | 0.001 | 0.0009 | 0 | 1.93 | 98 | Invention |
| | | | | | | | | | Example |
| 53 | 1000 | 4.6 | 0.001 | 0.002 | 0.0009 | 0 | 1.93 | 98 | Invention |
| | | | | | | | | | Example |
| 54 | 1000 | 7.1 | 0.001 | 0.001 | 0.0003 | 0 | 1.94 | 98 | Invention |
| | | | | | | | | | Example |
| 55 | 1000 | 12.4 | 0.001 | 0.001 | 0.0002 | 0 | 1.94 | 98 | Invention |
| | | | | | | | | | Example |
| 56 | 1000 | 22.9 | 0.001 | 0.002 | 0.0002 | 0 | 1.94 | 98 | Invention |
| | | | | | | | | | Example |
| 57 | 1000 | 29.6 | 0.001 | 0.002 | 0.0001 | 0 | 1.94 | 98 | Invention |
| | | | | | | | | | Example |
| 58 | 1000 | 30.0 | 0.001 | 0.001 | 0.0001 | 0 | 1.93 | 98 | Invention |
| | | | | | | | | | Example |
| 59 | 1000 | 30.6 | 0.001 | 0.001 | 0.0001 | 0 | 1.93 | 98 | Invention |
| | | | | | | | | | Example |
| 60 | 1000 | 29.9 | 0.001 | 0.001 | 0.0001 | — | 1.91 | 98 | Comparative |
| | | | | | | | | | Example |
| 61 | 1000 | 1.8 | 0.001 | 0.001 | 0.0011 | — | 1.76 | 98 | Comparative |
| | | | | | | | | | Example |
| 62 | 1000 | 2.9 | 0.001 | 0.001 | 0.0007 | — | 1.87 | 98 | Comparative |
| | | | | | | | | | Example |
| 63 | 1000 | 5.6 | 0.001 | 0.001 | 0.0004 | — | 1.88 | 98 | Comparative |
| | | | | | | | | | Example |
| 64 | 1000 | 8.0 | 0.001 | 0.001 | 0.0003 | — | 1.89 | 98 | Comparative |
| | | | | | | | | | Example |
| 65 | 1000 | 13.8 | 0.001 | 0.001 | 0.0001 | — | 1.89 | 98 | Comparative |
| | | | | | | | | | Example |
| 66 | 1000 | 28.2 | 0.001 | 0.001 | 0.0001 | — | 1.89 | 98 | Comparative |
| | | | | | | | | | Example |
| 67 | 1000 | 34.8 | 0.001 | 0.002 | 0.0001 | — | 1.89 | 98 | Comparative |
| | | | | | | | | | Example |
| 68 | 1000 | 35.0 | 0.001 | 0.001 | 0.0001 | — | 1.89 | 98 | Comparative |
| | | | | | | | | | Example |
| 69 | 1000 | 35.0 | 0.001 | 0.001 | 0.0001 | — | 1.90 | 98 | Comparative |
| | | | | | | | | | Example |
| 70 | 1000 | 35.3 | 0.001 | 0.001 | 0.0001 | — | 1.90 | 98 | Comparative |
| | | | | | | | | | Example |

### 2. Example 2

A slab was prepared in which the chemical composition contained, in mass %, C: 0.08%, Si: 3.3%, Mn: 0.08%, S: 0.02%, sol.A1: 0.03%, and N: 0.01%, with the remainder being Fe and impurities.

This slab was heated to 1350° C. in a heating furnace. A hot rolling step was performed on the heated slab to manufacture a hot-rolled steel sheet having a sheet thickness of 2.3 mm. The hot-rolled steel sheet was subjected to a hot-band annealing step of annealing, and then to cold rolling to manufacture a cold-rolled steel sheet having a thickness of 0.22 mm. A decarburization annealing step was performed on the cold-rolled steel sheet after the cold rolling step. In this decarburization annealing step, partial rapid heating with a laser beam was performed on one surface of the steel sheet under the conditions shown in Tables 2A to C before the temperature was raised. The scanning direction of the laser was set to 90 degrees with respect to the rolling direction. At this time, the focused diameter in the width direction Dc and the scanning speed Vc were varied such that the irradiation energy density Up and the instantaneous power density Ip were varied.

After the partial rapid heating, the steel sheet was primary recrystallized by heating in a non-oxidizing atmosphere containing hydrogen and nitrogen at the temperature rising rate shown in Tables 2D to F, then the decarburization annealing temperature was set to 830° C., and the steel sheet was soaked for 60 seconds. At this time, the atmosphere in the heat treatment furnace for performing the decarburization annealing treatment was a wet atmosphere containing hydrogen and nitrogen. An annealing separator (water slurry) containing MgO as a main component was applied to the surface of the steel sheet after decarburization annealing, and then the steel sheet was wound into a coil shape. The steel sheet wound in a coil shape was subjected to final annealing.

On the steel sheet after the final annealing step, an insulating film forming step was performed. In the insulating film forming step, an insulating coating agent mainly composed of colloidal silica and phosphate was applied to the surface (on the glass film) of the grain-oriented electrical steel sheet after the final annealing step, and then baking was performed. In this way, an insulating film as a high-tension insulating film was formed on the glass film. A grain-oriented electrical steel sheet of each Test No. was manufactured by the above manufacturing steps.

### 2-1. Removal of Film

The chemical composition of the base steel sheet can be measured by a well-known component analysis method. First, the primary film and the secondary film are removed from the base steel sheet by the following method. Specifically, the grain-oriented electrical steel sheet including the secondary film is immersed in a high-temperature alkaline solution to remove the secondary film. The composition and temperature of the alkali solution, and the immersion time may be appropriately adjusted.

For example, the grain-oriented electrical steel sheet including a secondary film is immersed in a sodium hydroxide aqueous solution of NaOH: 30 to 50 mass %+H₂O: 50 to 70 mass % at 80 to 90° C. for 5 to 10 minutes, and after immersion, washed with water, and dried. By this step, the secondary film is removed from the grain-oriented electrical steel sheet.

Further, the grain-oriented electrical steel sheet from which the secondary film has been removed and on which the primary film remains is immersed in high-temperature hydrochloric acid to remove the primary film. The concentration and temperature of the hydrochloric acid, and the immersion time may be appropriately adjusted. For example, the grain-oriented electrical steel sheet from which the secondary film has been removed and on which the primary film remains is immersed in 30 to 40 mass % hydrochloric acid at 80 to 90° C. for 1 to 5 minutes, and after immersion, washed with water, and dried. Through the above steps, a base steel sheet from which the secondary film and the primary film have been removed is obtained.

### 2-2. Measurement Experiment of Chemical Composition of Base Steel Sheet

The chemical composition of the base steel sheet of the grain-oriented electrical steel sheet of each Test No. was measured by the following method. First, the primary film and the secondary film of the grain-oriented electrical steel sheet were removed by the above-described method to extract the base steel sheet. Using the base steel sheet, the chemical composition of the base steel sheet was analyzed based on the following

### [Method for Measuring Chemical Composition of Steel Sheet].

The chips were collected from the obtained base steel sheet. The collected chips were dissolved in an acid to obtain a solution. The solution was subjected to Inductively Coupled Plasma Atomic Emission Spectrometry (ICP-AES) to perform elemental analysis of chemical composition. The C content and the S content were determined by a well-known high frequency combustion method (combustion-infrared absorption method). The N content was determined using a well-known inert gas fusion-thermal conductivity method. Specifically, measurement was performed using a component analyzer (trade name: ICPS-8000) manufactured by Shimadzu Corporation.

The results of the analysis showed that the chemical composition of the base steel sheet in any of the Test Nos. in Example 2 contained, in mass %, C: 0.01% or less, Si: 3.3%, Mn: 0.08%, S: 0.01% or less, sol.A1: 0.01% or less, and N: 0.01% or less, with the remainder being Fe and impurities.

The magnetic characteristic (magnetic flux density B8 value) of the grain-oriented electrical steel sheet of each Test No. was evaluated in accordance with JIS C2556 (2015). The obtained magnetic flux density B8 is shown in Tables 2D to F.

The shape of the deformed region of the grain-oriented electrical steel sheet of each Test No. was measured by the following method. That is, using a commercially available surface roughness measurement device (SE3500, manufactured by Kosaka Laboratory Ltd.) and SE2555N (radius of tip curvature: 2 μm) as a stylus of the detection unit, under a setting of a measurement length in the rolling direction of 15 mm per measurement, measurement was performed continuously 5 times, whereby the surface roughness over a length of 75 mm in total was measured. The measurement was performed in both the front and the rear. W, Dₚᵣₒₜᵣᵤₛᵢₒₙ, and D_{recess} at each of five points in the measurement regions of the front and the rear were measured, and evaluated by an average value thereof. However, for the steel No. in which Ip was excessive and defects were obviously generated in the laser irradiated portion, evaluation with a roughness meter was not performed. The width of the obtained deformed region W, the maximum depth of recessed part on one surface side of the deformed region D_{recess}, and the maximum height of protrusion on the rear surface side of the deformed region Dₚᵣₒₜᵣᵤₛᵢₒₙ are shown in Tables 2D to F.

Further, the space factor of the grain-oriented electrical steel sheet of each Test No. was evaluated in accordance with JIS C2550-5 (2020). The obtained space factor is shown in Tables 2D to F.

Further, the area fraction of abnormal grains in the deformed region of the grain-oriented electrical steel sheet of each Test No. was measured by the following method. That is, the crystal orientation of the region with the width of deformed region W was measured at a pitch of 2 mm in the width direction of the grain-oriented electrical steel sheet along the center line in the longitudinal direction of the deformed region using a Laue diffractometer. Then, from the crystal orientation of each measurement point, the number of measurement points indicating abnormal grains having a deviation angle of 15° or more from the Goss orientation was extracted, and the ratio of the number of these measurement points to the total number of measurement points was taken as the area fraction of abnormal grains. However, for the steel No. with an inferior magnetism of less than 1.93 T in the measurement of the magnetic characteristics described above, measurement of the area fraction of abnormal grains by a Laue diffractometer was not performed. The area fraction of the obtained abnormal grains is shown in Tables 2D to F.

With reference to Tables 2A to F, in steel Nos. 1 to 10, the instantaneous power density Ip was low, the rapid heating effect by laser heating was small, and the magnetic flux density was less than 1.93 T, which was inferior.

In steel Nos. 61 to 70, the instantaneous power density Ip was high, and defects due to laser heating were remarkably generated, whereby the magnetic flux density was deteriorated, and the magnetic flux density was less than 1.93 T, which was inferior.

In steel Nos. 11, 21, 31, 41, and 51, the irradiation energy density Up was low, the rapid heating effect by laser heating was small, and the magnetic flux density was less than 1.93 T, which was inferior.

In steel Nos. 10, 20, 30, 40, 50, and 60, the irradiation energy density Up was high, heat input by laser heating was excessive, and the magnetic flux density was less than 1.93 T, which was inferior.

In steel Nos. 7 to 9, 17 to 19, 27 to 29, 37 to 39, 47 to 49, and 57 to 59, the irradiation energy density Up was large relative to the focused diameter Dl, and the steepness was large. The D protrusion was also large, the space factor was significantly deteriorated, and the space factor was less than 96%, which was inferior. In the steel No. other than the above, since all the manufacturing step conditions were appropriate, the magnetic flux density was 1.93 T or more, which was excellent, and the space factor was also as high as 96% or more.

TABLE 2A

| | Laser irradiation conditions | | | | | | | | | |
|---|---|---|---|---|---|---|---|---|---|---|
| | | | | Focused | Focused | | | | | |
| | | | Steel | diameter | diameter | | | Irradiation | Instantaneous | Laser |
| | | Steel sheet | sheet | in rolling | in width | | Speed | energy | power | irradiation |
| Steel | | temperature | tension | direction | direction | Output | Vc | density Up | density Ip | interval |
| No. | Atmosphere | ° C. | kg/mm² | Dl mm | Dc mm | P W | mm/s | J/mm² | kW/mm² | L mm |
| 1 | Nitrogen | 400 | 0.8 | 0.60 | 2.50 | 45 | 32.0 | 3 | 0.04 | 10 |
| 2 | Nitrogen | 400 | 0.8 | 0.60 | 2.50 | 45 | 19.0 | 5 | 0.04 | 10 |
| 3 | Nitrogen | 400 | 0.8 | 0.60 | 2.50 | 45 | 14.0 | 7 | 0.04 | 10 |
| 4 | Nitrogen | 400 | 0.8 | 0.60 | 2.50 | 45 | 11.0 | 9 | 0.04 | 10 |
| 5 | Nitrogen | 400 | 0.8 | 0.60 | 2.50 | 45 | 6.4 | 15 | 0.04 | 10 |
| 6 | Nitrogen | 400 | 0.8 | 0.60 | 2.50 | 45 | 3.2 | 30 | 0.04 | 10 |
| 7 | Nitrogen | 400 | 0.8 | 0.60 | 2.50 | 45 | 2.4 | 40 | 0.04 | 10 |
| 8 | Nitrogen | 400 | 0.8 | 0.60 | 2.50 | 45 | 2.1 | 45 | 0.04 | 10 |
| 9 | Nitrogen | 400 | 0.8 | 0.60 | 2.50 | 45 | 1.9 | 50 | 0.04 | 10 |
| 10 | Nitrogen | 400 | 0.8 | 0.60 | 2.50 | 45 | 1.7 | 56 | 0.04 | 10 |
| 11 | Nitrogen | 400 | 0.8 | 0.60 | 2.00 | 45 | 31.8 | 3 | 0.05 | 10 |
| 12 | Nitrogen | 400 | 0.8 | 0.60 | 2.00 | 45 | 19.1 | 5 | 0.05 | 10 |
| 13 | Nitrogen | 400 | 0.8 | 0.60 | 2.00 | 45 | 13.6 | 7 | 0.05 | 10 |
| 14 | Nitrogen | 400 | 0.8 | 0.60 | 2.00 | 45 | 10.6 | 9 | 0.05 | 10 |
| 15 | Nitrogen | 400 | 0.8 | 0.60 | 2.00 | 45 | 6.4 | 15 | 0.05 | 10 |
| 16 | Nitrogen | 400 | 0.8 | 0.60 | 2.00 | 45 | 3.2 | 30 | 0.05 | 10 |
| 17 | Nitrogen | 400 | 0.8 | 0.60 | 2.00 | 45 | 2.4 | 40 | 0.05 | 10 |
| 18 | Nitrogen | 400 | 0.8 | 0.60 | 2.00 | 45 | 2.1 | 45 | 0.05 | 10 |
| 19 | Nitrogen | 400 | 0.8 | 0.60 | 2.00 | 45 | 1.9 | 50 | 0.05 | 10 |
| 20 | Nitrogen | 400 | 0.8 | 0.60 | 2.00 | 45 | 1.7 | 55 | 0.05 | 10 |

TABLE 2B

| | Laser irradiation conditions | | | | | | | | | |
|---|---|---|---|---|---|---|---|---|---|---|
| | | | | Focused | Focused | | | | | |
| | | | Steel | diameter | diameter | | | Irradiation | Instantaneous | Laser |
| | | Steel sheet | sheet | in rolling | in width | | Speed | energy | power | irradiation |
| Steel | | temperature | tension | direction | direction | Output | Vc | density Up | density Ip | interval |
| No. | Atmosphere | ° C. | kg/mm² | Dl mm | Dc mm | P W | mm/s | J/mm² | kW/mm² | L mm |
| 21 | Nitrogen | 400 | 0.8 | 0.60 | 0.50 | 45 | 31.8 | 3 | 0.19 | 10 |
| 22 | Nitrogen | 400 | 0.8 | 0.60 | 0.50 | 45 | 19.1 | 5 | 0.19 | 10 |
| 23 | Nitrogen | 400 | 0.8 | 0.60 | 0.50 | 45 | 13.6 | 7 | 0.19 | 10 |
| 24 | Nitrogen | 400 | 0.8 | 0.60 | 0.50 | 45 | 10.6 | 9 | 0.19 | 10 |
| 25 | Nitrogen | 400 | 0.8 | 0.60 | 0.50 | 45 | 6.4 | 15 | 0.19 | 10 |
| 26 | Nitrogen | 400 | 0.8 | 0.60 | 0.50 | 45 | 3.2 | 30 | 0.19 | 10 |
| 27 | Nitrogen | 400 | 0.8 | 0.60 | 0.50 | 45 | 2.4 | 40 | 0.19 | 10 |
| 28 | Nitrogen | 400 | 0.8 | 0.60 | 0.50 | 45 | 2.1 | 45 | 0.19 | 10 |
| 29 | Nitrogen | 400 | 0.8 | 0.60 | 0.50 | 45 | 1.9 | 50 | 0.19 | 10 |
| 30 | Nitrogen | 400 | 0.8 | 0.60 | 0.50 | 45 | 1.7 | 55 | 0.19 | 10 |
| 31 | Nitrogen | 400 | 0.8 | 0.60 | 0.10 | 45 | 31.8 | 3 | 0.95 | 10 |
| 32 | Nitrogen | 400 | 0.8 | 0.60 | 0.10 | 45 | 19.1 | 5 | 0.95 | 10 |
| 33 | Nitrogen | 400 | 0.8 | 0.60 | 0.10 | 45 | 13.6 | 7 | 0.95 | 10 |
| 34 | Nitrogen | 400 | 0.8 | 0.60 | 0.10 | 45 | 10.6 | 9 | 0.95 | 10 |
| 35 | Nitrogen | 400 | 0.8 | 0.60 | 0.10 | 45 | 6.4 | 15 | 0.95 | 10 |
| 36 | Nitrogen | 400 | 0.8 | 0.60 | 0.10 | 45 | 3.2 | 30 | 0.95 | 10 |
| 37 | Nitrogen | 400 | 0.8 | 0.60 | 0.10 | 45 | 2.4 | 40 | 0.95 | 10 |
| 38 | Nitrogen | 400 | 0.8 | 0.60 | 0.10 | 45 | 2.1 | 45 | 0.95 | 10 |
| 39 | Nitrogen | 400 | 0.8 | 0.60 | 0.10 | 45 | 1.9 | 50 | 0.95 | 10 |
| 40 | Nitrogen | 400 | 0.8 | 0.60 | 0.10 | 45 | 1.7 | 55 | 0.95 | 10 |

TABLE 2C

| | Laser irradiation conditions | | | | | | | | | |
|---|---|---|---|---|---|---|---|---|---|---|
| | | | | Focused | Focused | | | | | |
| | | | Steel | diameter | diameter | | | Irradiation | Instantaneous | Laser |
| | | Steel sheet | sheet | in rolling | in width | | Speed | energy | power | irradiation |
| Steel | | temperature | tension | direction | direction | Output | Vc | density Up | density Ip | interval |
| No. | Atmosphere | ° C. | kg/mm² | Dl mm | Dc mm | P W | mm/s | J/mm² | kW/mm² | L mm |
| 41 | Nitrogen | 400 | 0.8 | 0.60 | 0.02 | 45 | 31.8 | 3 | 4.77 | 10 |
| 42 | Nitrogen | 400 | 0.8 | 0.60 | 0.02 | 45 | 19.1 | 5 | 4.77 | 10 |
| 43 | Nitrogen | 400 | 0.8 | 0.60 | 0.02 | 45 | 13.6 | 7 | 4.77 | 10 |
| 44 | Nitrogen | 400 | 0.8 | 0.60 | 0.02 | 45 | 10.6 | 9 | 4.77 | 10 |
| 45 | Nitrogen | 400 | 0.8 | 0.60 | 0.02 | 45 | 6.4 | 15 | 4.77 | 10 |
| 46 | Nitrogen | 400 | 0.8 | 0.60 | 0.02 | 45 | 3.2 | 30 | 4.77 | 10 |
| 47 | Nitrogen | 400 | 0.8 | 0.60 | 0.02 | 45 | 2.4 | 40 | 4.77 | 10 |
| 48 | Nitrogen | 400 | 0.8 | 0.60 | 0.02 | 45 | 2.1 | 45 | 4.77 | 10 |
| 49 | Nitrogen | 400 | 0.8 | 0.60 | 0.02 | 45 | 1.9 | 50 | 4.77 | 10 |
| 50 | Nitrogen | 400 | 0.8 | 0.60 | 0.02 | 45 | 1.7 | 55 | 4.77 | 10 |
| 51 | Nitrogen | 400 | 0.8 | 0.60 | 0.02 | 47 | 33.5 | 3 | 4.99 | 10 |
| 52 | Nitrogen | 400 | 0.8 | 0.60 | 0.02 | 47 | 20.0 | 5 | 4.99 | 10 |
| 53 | Nitrogen | 400 | 0.8 | 0.60 | 0.02 | 47 | 14.0 | 7 | 4.99 | 10 |
| 54 | Nitrogen | 400 | 0.8 | 0.60 | 0.02 | 47 | 11.0 | 9 | 4.99 | 10 |
| 55 | Nitrogen | 400 | 0.8 | 0.60 | 0.02 | 47 | 7.0 | 14 | 4.99 | 10 |
| 56 | Nitrogen | 400 | 0.8 | 0.60 | 0.02 | 47 | 4.0 | 25 | 4.99 | 10 |
| 57 | Nitrogen | 400 | 0.8 | 0.60 | 0.02 | 47 | 2.5 | 40 | 4.99 | 10 |
| 58 | Nitrogen | 400 | 0.8 | 0.60 | 0.02 | 47 | 2.2 | 45 | 4.99 | 10 |
| 59 | Nitrogen | 400 | 0.8 | 0.60 | 0.02 | 47 | 2.0 | 50 | 4.99 | 10 |
| 60 | Nitrogen | 400 | 0.8 | 0.60 | 0.02 | 47 | 1.9 | 52 | 4.99 | 10 |
| 61 | Nitrogen | 400 | 0.8 | 0.60 | 0.02 | 48 | 34.0 | 3 | 5.09 | 10 |
| 62 | Nitrogen | 400 | 0.8 | 0.60 | 0.02 | 48 | 20.0 | 5 | 5.09 | 10 |
| 63 | Nitrogen | 400 | 0.8 | 0.60 | 0.02 | 48 | 15.0 | 7 | 5.09 | 10 |
| 64 | Nitrogen | 400 | 0.8 | 0.60 | 0.02 | 48 | 11.0 | 9 | 5.09 | 10 |
| 65 | Nitrogen | 400 | 0.8 | 0.60 | 0.02 | 48 | 7.0 | 15 | 5.09 | 10 |
| 66 | Nitrogen | 400 | 0.8 | 0.60 | 0.02 | 48 | 4.0 | 25 | 5.09 | 10 |
| 67 | Nitrogen | 400 | 0.8 | 0.60 | 0.02 | 48 | 2.5 | 41 | 5.09 | 10 |
| 68 | Nitrogen | 400 | 0.8 | 0.60 | 0.02 | 48 | 2.3 | 44 | 5.09 | 10 |
| 69 | Nitrogen | 400 | 0.8 | 0.60 | 0.02 | 48 | 2.1 | 49 | 5.09 | 10 |
| 70 | Nitrogen | 400 | 0.8 | 0.60 | 0.02 | 48 | 1.9 | 55 | 5.09 | 10 |

TABLE 2D

| | | | | Maximum | | | | | |
|---|---|---|---|---|---|---|---|---|---|
| | | | Maximum | height of | | | | | |
| | | | depth of | protrusion | | | | | |
| | | | recessed | on rear | | | | | |
| | | | part on | surface | | | | | |
| | Temperature | | laser | of laser | | | | | |
| | rising rate in | Width of | irradiated | irradiated | | | Magnetic | | |
| | decarburization | deformed | surface | portion | | Ratio of | flux | | |
| Steel | annealing step | region | D_{recess} | Dₚᵣₒₜᵣᵤₛᵢₒₙ | Steepness | abnormal | density | Space | |
| No. | V ° C./s | W mm | mm | mm | 2Dₚᵣₒₜᵣᵤₛᵢₒₙ/W | grains % | B8 T | factor % | Remarks |
| 1 | 1000 | 2.4 | 0.000 | 0.000 | 0.0000 | — | 1.92 | 98 | Comparative |
| | | | | | | | | | Example |
| 2 | 1000 | 2.2 | 0.001 | 0.001 | 0.0009 | — | 1.92 | 98 | Comparative |
| | | | | | | | | | Example |
| 3 | 1000 | 2.2 | 0.001 | 0.001 | 0.0009 | — | 1.92 | 98 | Comparative |
| | | | | | | | | | Example |
| 4 | 1000 | 2.3 | 0.002 | 0.002 | 0.0017 | — | 1.92 | 98 | Comparative |
| | | | | | | | | | Example |
| 5 | 1000 | 2.4 | 0.002 | 0.002 | 0.0017 | — | 1.92 | 97 | Comparative |
| | | | | | | | | | Example |
| 6 | 1000 | 2.6 | 0.004 | 0.005 | 0.0038 | — | 1.92 | 97 | Comparative |
| | | | | | | | | | Example |
| 7 | 1000 | 2.2 | 0.006 | 0.006 | 0.0055 | — | 1.91 | 95 | Comparative |
| | | | | | | | | | Example |
| 8 | 1000 | 2.3 | 0.007 | 0.007 | 0.0061 | — | 1.90 | 95 | Comparative |
| | | | | | | | | | Example |
| 9 | 1000 | 2.4 | 0.008 | 0.008 | 0.0067 | — | 1.90 | 95 | Comparative |
| | | | | | | | | | Example |
| 10 | 1000 | 2.4 | 0.010 | 0.010 | 0.0083 | — | 1.89 | 94 | Comparative |
| | | | | | | | | | Example |
| 11 | 1000 | 2.2 | 0.000 | 0.000 | 0.0000 | — | 1.92 | 98 | Comparative |
| | | | | | | | | | Example |
| 12 | 1000 | 2.2 | 0.001 | 0.001 | 0.0009 | 0 | 1.93 | 98 | Invention |
| | | | | | | | | | Example |
| 13 | 1000 | 2.6 | 0.001 | 0.001 | 0.0008 | 0 | 1.93 | 98 | Invention |
| | | | | | | | | | Example |
| 14 | 1000 | 2.4 | 0.001 | 0.001 | 0.0008 | 1 | 1.94 | 98 | Invention |
| | | | | | | | | | Example |
| 15 | 1000 | 2.3 | 0.002 | 0.002 | 0.0017 | 1 | 1.94 | 97 | Invention |
| | | | | | | | | | Example |
| 16 | 1000 | 2.4 | 0.004 | 0.004 | 0.0033 | 1 | 1.94 | 97 | Invention |
| | | | | | | | | | Example |
| 17 | 1000 | 2.2 | 0.007 | 0.006 | 0.0055 | 3 | 1.93 | 95 | Comparative |
| | | | | | | | | | Example |
| 18 | 1000 | 2.5 | 0.007 | 0.007 | 0.0056 | 2 | 1.93 | 95 | Comparative |
| | | | | | | | | | Example |
| 19 | 1000 | 2.4 | 0.008 | 0.008 | 0.0067 | 3 | 1.93 | 95 | Comparative |
| | | | | | | | | | Example |
| 20 | 1000 | 2.3 | 0.009 | 0.009 | 0.0078 | — | 1.91 | 94 | Comparative |
| | | | | | | | | | Example |

TABLE 2E

| | | | Maximum | Maximum | | | | | |
|---|---|---|---|---|---|---|---|---|---|
| | | | depth of | height of | | | | | |
| | Temperature | | recessed | protrusion on | | | | | |
| | rising rate in | Width of | part on | rear surface | | | Magnetic | | |
| | decarburization | deformed | laser | of laser | | Ratio of | flux | | |
| | annealing step | region | irradiated | irradiated | | abnormal | density | Space | |
| Steel | V | W | surface | portion | Steepness | grains | B8 | factor | |
| No. | ° C./s | mm | D_{recess} mm | Dₚᵣₒₜᵣᵤₛᵢₒₙ mm | 2Dₚᵣₒₜᵣᵤₛᵢₒₙ/W | % | T | % | Remarks |
| 21 | 1000 | 2.3 | 0.000 | 0.000 | 0.0000 | — | 1.92 | 98 | Comparative |
| | | | | | | | | | Example |
| 22 | 1000 | 2.6 | 0.001 | 0.001 | 0.0008 | 0 | 1.93 | 98 | Invention |
| | | | | | | | | | Example |
| 23 | 1000 | 1.9 | 0.001 | 0.001 | 0.0011 | 0 | 1.94 | 98 | Invention |
| | | | | | | | | | Example |
| 24 | 1000 | 2.0 | 0.002 | 0.002 | 0.0020 | 0 | 1.95 | 98 | Invention |
| | | | | | | | | | Example |
| 25 | 1000 | 2.0 | 0.002 | 0.003 | 0.0030 | 0 | 1.95 | 97 | Invention |
| | | | | | | | | | Example |
| 26 | 1000 | 2.5 | 0.004 | 0.006 | 0.0048 | 0 | 1.95 | 97 | Invention |
| | | | | | | | | | Example |
| 27 | 1000 | 2.4 | 0.006 | 0.007 | 0.0058 | 1 | 1.94 | 95 | Comparative |
| | | | | | | | | | Example |
| 28 | 1000 | 2.4 | 0.006 | 0.008 | 0.0067 | 2 | 1.93 | 95 | Comparative |
| | | | | | | | | | Example |
| 29 | 1000 | 2.4 | 0.007 | 0.008 | 0.0067 | 4 | 1.93 | 95 | Comparative |
| | | | | | | | | | Example |
| 30 | 1000 | 2.3 | 0.009 | 0.009 | 0.0078 | — | 1.91 | 94 | Comparative |
| | | | | | | | | | Example |
| 31 | 1000 | 2.2 | 0.000 | 0.000 | 0.0000 | — | 1.92 | 98 | Comparative |
| | | | | | | | | | Example |
| 32 | 1000 | 2.2 | 0.001 | 0.001 | 0.0009 | 0 | 1.93 | 98 | Invention |
| | | | | | | | | | Example |
| 33 | 1000 | 2.8 | 0.001 | 0.001 | 0.0007 | 0 | 1.94 | 98 | Invention |
| | | | | | | | | | Example |
| 34 | 1000 | 2.4 | 0.001 | 0.002 | 0.0017 | 0 | 1.95 | 98 | Invention |
| | | | | | | | | | Example |
| 35 | 1000 | 2.6 | 0.002 | 0.004 | 0.0031 | 0 | 1.95 | 97 | Invention |
| | | | | | | | | | Example |
| 36 | 1000 | 2.7 | 0.005 | 0.005 | 0.0037 | 0 | 1.95 | 97 | Invention |
| | | | | | | | | | Example |
| 37 | 1000 | 2.1 | 0.006 | 0.007 | 0.0067 | 1 | 1.94 | 95 | Comparative |
| | | | | | | | | | Example |
| 38 | 1000 | 2.4 | 0.007 | 0.008 | 0.0067 | 3 | 1.93 | 95 | Comparative |
| | | | | | | | | | Example |
| 39 | 1000 | 2.4 | 0.008 | 0.008 | 0.0067 | 4 | 1.93 | 95 | Comparative |
| | | | | | | | | | Example |
| 40 | 1000 | 2.4 | 0.009 | 0.010 | 0.0083 | — | 1.91 | 94 | Comparative |
| | | | | | | | | | Example |

TABLE 2F

| | | | Maximum | Maximum | | | | | |
|---|---|---|---|---|---|---|---|---|---|
| | | | depth of | height of | | | | | |
| | Temperature | | recessed | protrusion on | | | | | |
| | rising rate in | Width of | part on | rear surface | | | Magnetic | | |
| | decarburization | deformed | laser | of laser | | Ratio of | flux | | |
| | annealing step | region | irradiated | irradiated | | abnormal | density | Space | |
| Steel | V | W | surface | portion | Steepness | grains | B8 | factor | |
| No. | ° C./s | mm | D_{recess} mm | Dₚᵣₒₜᵣᵤₛᵢₒₙ mm | 2Dₚᵣₒₜᵣᵤₛᵢₒₙ/W | % | T | % | Remarks |
| 41 | 1000 | 2.1 | 0.000 | 0.001 | 0.0010 | 0 | 1.92 | 98 | Comparative |
| | | | | | | | | | Example |
| 42 | 1000 | 2.0 | 0.001 | 0.001 | 0.0010 | 0 | 1.93 | 98 | Invention |
| | | | | | | | | | Example |
| 43 | 1000 | 2.0 | 0.001 | 0.002 | 0.0020 | 0 | 1.94 | 98 | Invention |
| | | | | | | | | | Example |
| 44 | 1000 | 1.9 | 0.001 | 0.001 | 0.0011 | 0 | 1.95 | 98 | Invention |
| | | | | | | | | | Example |
| 45 | 1000 | 1.9 | 0.002 | 0.003 | 0.0032 | 0 | 1.95 | 97 | Invention |
| | | | | | | | | | Example |
| 46 | 1000 | 2.4 | 0.003 | 0.005 | 0.0042 | 0 | 1.95 | 97 | Invention |
| | | | | | | | | | Example |
| 47 | 1000 | 2.4 | 0.005 | 0.006 | 0.0050 | 1 | 1.94 | 95 | Comparative |
| | | | | | | | | | Example |
| 48 | 1000 | 1.8 | 0.007 | 0.007 | 0.0078 | 2 | 1.93 | 95 | Comparative |
| | | | | | | | | | Example |
| 49 | 1000 | 2.3 | 0.008 | 0.008 | 0.0070 | 2 | 1.93 | 95 | Comparative |
| | | | | | | | | | Example |
| 50 | 1000 | 2.4 | 0.009 | 0.010 | 0.0083 | — | 1.91 | 94 | Comparative |
| | | | | | | | | | Example |
| 51 | 1000 | 2.3 | 0.000 | 0.001 | 0.0009 | — | 1.92 | 98 | Comparative |
| | | | | | | | | | Example |
| 52 | 1000 | 2.4 | 0.001 | 0.001 | 0.0008 | 0 | 1.93 | 98 | Invention |
| | | | | | | | | | Example |
| 53 | 1000 | 2.3 | 0.001 | 0.001 | 0.0009 | 0 | 1.93 | 86 | Invention |
| | | | | | | | | | Example |
| 54 | 1000 | 2.6 | 0.001 | 0.002 | 0.0015 | 0 | 1.94 | 98 | Invention |
| | | | | | | | | | Example |
| 55 | 1000 | 2.5 | 0.002 | 0.002 | 0.0016 | 0 | 1.94 | 97 | Invention |
| | | | | | | | | | Example |
| 56 | 1000 | 2.6 | 0.004 | 0.004 | 0.0031 | 1 | 1.94 | 97 | Invention |
| | | | | | | | | | Example |
| 57 | 1000 | 2.4 | 0.005 | 0.007 | 0.0058 | 1 | 1.93 | 95 | Comparative |
| | | | | | | | | | Example |
| 58 | 1000 | 2.4 | 0.006 | 0.008 | 0.0067 | 2 | 1.93 | 95 | Comparative |
| | | | | | | | | | Example |
| 59 | 1000 | 2.2 | 0.007 | 0.008 | 0.0073 | 4 | 1.93 | 95 | Comparative |
| | | | | | | | | | Example |
| 60 | 1000 | 2.4 | 0.009 | 0.012 | 0.0100 | — | 1.90 | 94 | Comparative |
| | | | | | | | | | Example |
| 61 | 1000 | — | — | — | — | — | 1.88 | 97 | Comparative |
| | | | | | | | | | Example |
| 62 | 1000 | — | — | — | — | — | 1.89 | 97 | Comparative |
| | | | | | | | | | Example |
| 63 | 1000 | — | — | — | — | — | 1.90 | 97 | Comparative |
| | | | | | | | | | Example |
| 64 | 1000 | — | — | — | — | — | 1.91 | 97 | Comparative |
| | | | | | | | | | Example |
| 65 | 1000 | — | — | — | — | — | 1.91 | 96 | Comparative |
| | | | | | | | | | Example |
| 66 | 1000 | — | — | — | — | — | 1.91 | 96 | Comparative |
| | | | | | | | | | Example |
| 67 | 1000 | — | — | — | — | — | 1.90 | 94 | Comparative |
| | | | | | | | | | Example |
| 68 | 1000 | — | — | — | — | — | 1.89 | 94 | Comparative |
| | | | | | | | | | Example |
| 69 | 1000 | — | — | — | — | — | 1.88 | 94 | Comparative |
| | | | | | | | | | Example |
| 70 | 1000 | — | — | — | — | — | 1.86 | 93 | Comparative |
| | | | | | | | | | Example |

### 3. Example 3

A slab was prepared in which the chemical composition contained, in mass %, C: 0.08%, Si: 3.3%, Mn: 0.08%, S: 0.02%, sol.Al: 0.03%, and N: 0.01%, with the remainder being Fe and impurities.

This slab was heated to 1350° C. in a heating furnace. A hot rolling step was performed on the heated slab to manufacture a hot-rolled steel sheet having a sheet thickness of 2.3 mm. The hot-rolled steel sheet was subjected to a hot-band annealing step of annealing, and then to cold rolling to manufacture a cold-rolled steel sheet having a thickness of 0.22 mm. A decarburization annealing step was performed on the cold-rolled steel sheet after the cold rolling step. In this decarburization annealing step, partial rapid heating with a laser beam was performed on one surface of the steel sheet under the conditions shown in Tables 3A to C before the temperature was raised. The scanning direction of the laser was set to 90 degrees with respect to the rolling direction. At this time, the focused diameter in the width direction Dc and the operation speed Vc were varied such that the irradiation energy density Up and the instantaneous power density Ip were varied. The difference from Example 2 is the values of the focused diameter in the rolling direction Dl and the scanning speed Vc.

After the partial rapid heating, the steel sheet was primary recrystallized by heating in a non-oxidizing atmosphere containing hydrogen and nitrogen at the temperature rising rate shown in Tables 3D to F, then the decarburization annealing temperature was set to 830° C., and the steel sheet was soaked for 60 seconds. At this time, the atmosphere in the heat treatment furnace for performing the decarburization annealing treatment was a wet atmosphere containing hydrogen and nitrogen. An annealing separator (water slurry) containing MgO as a main component was applied to the surface of the steel sheet after decarburization annealing, and then the steel sheet was wound into a coil shape. The steel sheet wound in a coil shape was subjected to final annealing.

On the steel sheet after the final annealing step, an insulating film forming step was performed. In the insulating film forming step, an insulating coating agent mainly composed of colloidal silica and phosphate was applied to the surface (on the glass film) of the grain-oriented electrical steel sheet after the final annealing step, and then baking was performed. In this way, an insulating film as a high-tension insulating film was formed on the glass film. A grain-oriented electrical steel sheet of each Test No. was manufactured by the above manufacturing steps.

### 3-1. Removal of Film

The chemical composition of the base steel sheet can be measured by a well-known component analysis method. First, the primary film and the secondary film are removed from the base steel sheet by the following method. Specifically, the grain-oriented electrical steel sheet including the secondary film is immersed in a high-temperature alkaline solution to remove the secondary film. The composition and temperature of the alkali solution, and the immersion time may be appropriately adjusted. For example, the grain-oriented electrical steel sheet including a secondary film is immersed in a sodium hydroxide aqueous solution of NaOH: 30 to 50 mass %+H₂O: 50 to 70 mass % at 80 to 90° C. for 5 to 10 minutes, and after immersion, washed with water, and dried. By this step, the secondary film is removed from the grain-oriented electrical steel sheet.

Further, the grain-oriented electrical steel sheet from which the secondary film has been removed and on which the primary film remains is immersed in high-temperature hydrochloric acid to remove the primary film. The concentration and temperature of the hydrochloric acid, and the immersion time may be appropriately adjusted. For example, the grain-oriented electrical steel sheet from which the secondary film has been removed and on which the primary film remains is immersed in 30 to 40 mass % hydrochloric acid at 80 to 90° C. for 1 to 5 minutes, and after immersion, washed with water, and dried. Through the above steps, a base steel sheet from which the secondary film and the primary film have been removed is obtained.

### 3-2. Measurement Experiment of Chemical Composition of Base Steel Sheet

The chemical composition of the base steel sheet of the grain-oriented electrical steel sheet of each Test No. was measured by the following method. First, the primary film and the secondary film of the grain-oriented electrical steel sheet were removed by the above-described method to extract the base steel sheet. Using the base steel sheet, the chemical composition of the base steel sheet was analyzed based on the following

### [Method for Measuring Chemical Composition of Steel Sheet].

The chips were collected from the obtained base steel sheet. The collected chips were dissolved in an acid to obtain a solution. The solution was subjected to Inductively Coupled Plasma Atomic Emission Spectrometry (ICP-AES) to perform elemental analysis of chemical composition. The C content and the S content were determined by a well-known high frequency combustion method (combustion-infrared absorption method). The N content was determined using a well-known inert gas fusion-thermal conductivity method. Specifically, measurement was performed using a component analyzer (trade name: ICPS-8000) manufactured by Shimadzu Corporation.

The results of the analysis showed that the chemical composition of the base steel sheet in any of the Test Nos. in Example 3 contained, in mass %, C: 0.01% or less, Si: 3.3%, Mn: 0.08%, S: 0.01% or less, sol.Al: 0.01% or less, and N: 0.01% or less, with the remainder being Fe and impurities.

The magnetic characteristic (magnetic flux density B8 value) of the grain-oriented electrical steel sheet of each Test No. was evaluated in accordance with JIS C2556 (2015). The obtained magnetic flux density B8 is shown in Tables 3D to F.

The shape of the deformed region of the grain-oriented electrical steel sheet of each Test No. was measured by the following method. That is, using a commercially available surface roughness measurement device (SE3500, manufactured by Kosaka Laboratory Ltd.) and SE2555N (radius of tip curvature: 2 μm) as a stylus of the detection unit, under a setting of a measurement length in the rolling direction of 15 mm per measurement, measurement was performed continuously 5 times, whereby the surface roughness over a length of 75 mm in total was measured. The measurement was performed in both the front and the rear. W, Dₚᵣₒₜᵣᵤₛᵢₒₙ, and D_{recess} at each of five points in the measurement regions of the front and the rear were measured, and evaluated by an average value thereof. However, for the steel No. in which Ip was excessive and defects were obviously generated in the deformed region, evaluation with a roughness meter was not performed. The width of the obtained deformed region W, the maximum depth of recessed part on one surface side of the deformed region D_{recess}, and the maximum height of protrusion on the rear surface side of the deformed region Dₚᵣₒₜᵣᵤₛᵢₒₙ are shown in Tables 3D to F.

Further, the space factor of the grain-oriented electrical steel sheet of each Test No. was evaluated in accordance with JiS C2550-5 (2020). The obtained space factor is shown in Tables 3D to F.

Further, the area fraction of abnormal grains in the deformed region of the grain-oriented electrical steel sheet of each Test No. was measured by the following method. That is, the crystal orientation of the region with the width of deformed region W was measured at a pitch of 2 mm in the width direction of the grain-oriented electrical steel sheet along the center line in the longitudinal direction of the deformed region using a Laue diffractometer. Then, from the crystal orientation of each measurement point, the number of measurement points indicating abnormal grains having a deviation angle of 150 or more from the Goss orientation was extracted, and the ratio of the number of these measurement points to the total number of measurement points was taken as the area fraction of abnormal grains. However, for the steel No. with an inferior magnetism of less than 1.93 T in the measurement of the magnetic characteristics described above, measurement of the area fraction of abnormal grains by a Laue diffractometer was not performed. The area fraction of the obtained abnormal grains is shown in Tables 3D to F.

With reference to Tables 3A to F, in steel Nos. 1 to 10, the instantaneous power density Ip was low, the rapid heating effect by laser heating was small, and the magnetic flux density was less than 1.93 T, which was inferior.

In steel Nos. 61 to 70, the instantaneous power density Ip was high, and defects due to laser heating were remarkably generated, whereby the magnetic flux density was deteriorated, and the magnetic flux density was less than 1.93 T, which was inferior.

In steel Nos. 11, 21, 31, 41, and 51, the irradiation energy density Up was low, the rapid heating effect by laser heating was small, and the magnetic flux density was less than 1.93 T, which was inferior.

In steel Nos. 10, 20, 30, 40, 50, and 60, the irradiation energy density Up was high, heat input by laser heating was excessive, the magnetic flux density was deteriorated, and was less than 1.93 T.

In the steel No. other than the above, since all the manufacturing step conditions were appropriate, the magnetic flux density was 1.93 T or more, which was excellent, and the space factor was also as high as 96% or more.

TABLE 3A

| | Laser irradiation conditions | | | | | | | | | |
|---|---|---|---|---|---|---|---|---|---|---|
| | | | | Focused | Focused | | | | | |
| | | | Steel | diameter | diameter | | | Irradiation | Instantaneous | Laser |
| | | Steel sheet | sheet | in rolling | in width | | Speed | energy | power | irradiation |
| Steel | | temperature | tension | direction | direction | Output | Vc | density | density | interval |
| No. | Atmosphere | ° C. | kg/mm2 | Dl mm | Dc mm | PW | mm/s | Up J/mm² | Ip kW/mm² | L mm |
| 1 | Nitrogen | 400 | 0.8 | 2.00 | 0.70 | 45 | 10.0 | 3 | 0.04 | 10 |
| 2 | Nitrogen | 400 | 0.8 | 2.00 | 0.70 | 45 | 6.0 | 5 | 0.04 | 10 |
| 3 | Nitrogen | 400 | 0.8 | 2.00 | 0.70 | 45 | 4.0 | 7 | 0.04 | 10 |
| 4 | Nitrogen | 400 | 0.8 | 2.00 | 0.70 | 45 | 3.0 | 10 | 0.04 | 10 |
| 5 | Nitrogen | 400 | 0.8 | 2.00 | 0.70 | 45 | 2.0 | 14 | 0.04 | 10 |
| 6 | Nitrogen | 400 | 0.8 | 2.00 | 0.70 | 45 | 1.0 | 29 | 0.04 | 10 |
| 7 | Nitrogen | 400 | 0.8 | 2.00 | 0.70 | 45 | 0.8 | 36 | 0.04 | 10 |
| 8 | Nitrogen | 400 | 0.8 | 2.00 | 0.70 | 45 | 0.7 | 41 | 0.04 | 10 |
| 9 | Nitrogen | 400 | 0.8 | 2.00 | 0.70 | 45 | 0.6 | 48 | 0.04 | 10 |
| 10 | Nitrogen | 400 | 0.8 | 2.00 | 0.70 | 45 | 0.5 | 55 | 0.04 | 10 |
| 11 | Nitrogen | 400 | 0.8 | 2.00 | 0.60 | 45 | 10.0 | 3 | 0.05 | 10 |
| 12 | Nitrogen | 400 | 0.8 | 2.00 | 0.60 | 45 | 6.0 | 5 | 0.05 | 10 |
| 13 | Nitrogen | 400 | 0.8 | 2.00 | 0.60 | 45 | 4.0 | 7 | 0.05 | 10 |
| 14 | Nitrogen | 400 | 0.8 | 2.00 | 0.60 | 45 | 3.0 | 10 | 0.05 | 10 |
| 15 | Nitrogen | 400 | 0.8 | 2.00 | 0.60 | 45 | 2.0 | 14 | 0.05 | 10 |
| 16 | Nitrogen | 400 | 0.8 | 2.00 | 0.60 | 45 | 1.0 | 29 | 0.05 | 10 |
| 17 | Nitrogen | 400 | 0.8 | 2.00 | 0.60 | 45 | 0.8 | 36 | 0.05 | 10 |
| 18 | Nitrogen | 400 | 0.8 | 2.00 | 0.60 | 45 | 0.7 | 41 | 0.05 | 10 |
| 19 | Nitrogen | 400 | 0.8 | 2.00 | 0.60 | 45 | 0.6 | 48 | 0.05 | 10 |
| 20 | Nitrogen | 400 | 0.8 | 2.00 | 0.60 | 45 | 0.5 | 57 | 0.05 | 10 |

TABLE 3B

| | Laser irradiation conditions | | | | | | | | | |
|---|---|---|---|---|---|---|---|---|---|---|
| | | | | Focused | Focused | | | | | |
| | | | Steel | diameter | diameter | | | Irradiation | | Laser |
| | | Steel sheet | sheet | in rolling | in width | | Speed | energy | Instantaneous | irradiation |
| Steel | | temperature | tension | direction | direction | Output | Vc | density | power density | interval |
| No. | Atmosphere | ° C. | kg/mm² | Dl mm | Dc mm | PW | mm/s | Up J/mm² | Ip kW/mm² | L mm |
| 21 | Nitrogen | 400 | 0.8 | 2.00 | 0.15 | 45 | 10.0 | 3 | 0.19 | 10 |
| 22 | Nitrogen | 400 | 0.8 | 2.00 | 0.15 | 45 | 6.0 | 5 | 0.19 | 10 |
| 23 | Nitrogen | 400 | 0.8 | 2.00 | 0.15 | 45 | 4.0 | 7 | 0.19 | 10 |
| 24 | Nitrogen | 400 | 0.8 | 2.00 | 0.15 | 45 | 3.0 | 10 | 0.19 | 10 |
| 25 | Nitrogen | 400 | 0.8 | 2.00 | 0.15 | 45 | 2.0 | 14 | 0.19 | 10 |
| 26 | Nitrogen | 400 | 0.8 | 2.00 | 0.15 | 45 | 1.0 | 29 | 0.19 | 10 |
| 27 | Nitrogen | 400 | 0.8 | 2.00 | 0.15 | 45 | 0.8 | 36 | 0.19 | 10 |
| 28 | Nitrogen | 400 | 0.8 | 2.00 | 0.15 | 45 | 0.7 | 41 | 0.19 | 10 |
| 29 | Nitrogen | 400 | 0.8 | 2.00 | 0.15 | 45 | 0.6 | 48 | 0.19 | 10 |
| 30 | Nitrogen | 400 | 0.8 | 2.00 | 0.15 | 45 | 0.5 | 57 | 0.19 | 10 |
| 31 | Nitrogen | 400 | 0.8 | 2.00 | 0.03 | 45 | 10.0 | 3 | 0.95 | 10 |
| 32 | Nitrogen | 400 | 0.8 | 2.00 | 0.03 | 45 | 6.0 | 5 | 0.95 | 10 |
| 33 | Nitrogen | 400 | 0.8 | 2.00 | 0.03 | 45 | 4.0 | 7 | 0.95 | 10 |
| 34 | Nitrogen | 400 | 0.8 | 2.00 | 0.03 | 45 | 3.0 | 10 | 0.95 | 10 |
| 35 | Nitrogen | 400 | 0.8 | 2.00 | 0.03 | 45 | 2.0 | 14 | 0.95 | 10 |
| 36 | Nitrogen | 400 | 0.8 | 2.00 | 0.03 | 45 | 1.0 | 29 | 0.95 | 10 |
| 37 | Nitrogen | 400 | 0.8 | 2.00 | 0.03 | 45 | 0.8 | 36 | 0.95 | 10 |
| 38 | Nitrogen | 400 | 0.8 | 2.00 | 0.03 | 45 | 0.7 | 41 | 0.95 | 10 |
| 39 | Nitrogen | 400 | 0.8 | 2.00 | 0.03 | 45 | 0.6 | 48 | 0.95 | 10 |
| 40 | Nitrogen | 400 | 0.8 | 2.00 | 0.03 | 45 | 0.5 | 57 | 0.95 | 10 |

TABLE 3C

| | Laser irradiation conditions | | | | | | | | | |
|---|---|---|---|---|---|---|---|---|---|---|
| | | | | Focused | Focused | | | | | |
| | | | Steel | diameter | diameter | | | Irradiation | | Laser |
| | | Steel sheet | sheet | in rolling | in width | | Speed | energy | Instantaneous | irradiation |
| Steel | | temperature | tension | direction | direction | Output | Vc | density | power density | interval |
| No. | Atmosphere | ° C. | kg/mm² | Dl mm | Dc mm | PW | mm/s | Up J/mm² | Ip kW/mm² | L mm |
| 41 | Nitrogen | 400 | 0.8 | 2.00 | 0.01 | 45 | 10.0 | 3 | 2.86 | 10 |
| 42 | Nitrogen | 400 | 0.8 | 2.00 | 0.01 | 45 | 6.0 | 5 | 2.86 | 10 |
| 43 | Nitrogen | 400 | 0.8 | 2.00 | 0.01 | 45 | 4.0 | 7 | 2.86 | 10 |
| 44 | Nitrogen | 400 | 0.8 | 2.00 | 0.01 | 45 | 3.0 | 10 | 2.86 | 10 |
| 45 | Nitrogen | 400 | 0.8 | 2.00 | 0.01 | 45 | 2.0 | 14 | 2.86 | 10 |
| 46 | Nitrogen | 400 | 0.8 | 2.00 | 0.01 | 45 | 1.0 | 29 | 2.86 | 10 |
| 47 | Nitrogen | 400 | 0.8 | 2.00 | 0.01 | 45 | 0.8 | 36 | 2.86 | 10 |
| 48 | Nitrogen | 400 | 0.8 | 2.00 | 0.01 | 45 | 0.7 | 41 | 2.86 | 10 |
| 49 | Nitrogen | 400 | 0.8 | 2.00 | 0.01 | 45 | 0.6 | 48 | 2.86 | 10 |
| 50 | Nitrogen | 400 | 0.8 | 2.00 | 0.01 | 45 | 0.5 | 57 | 2.86 | 10 |
| 51 | Nitrogen | 400 | 0.8 | 2.00 | 0.01 | 75 | 17.0 | 3 | 4.77 | 10 |
| 52 | Nitrogen | 400 | 0.8 | 2.00 | 0.01 | 75 | 10.0 | 5 | 4.77 | 10 |
| 53 | Nitrogen | 400 | 0.8 | 2.00 | 0.01 | 75 | 7.0 | 7 | 4.77 | 10 |
| 54 | Nitrogen | 400 | 0.8 | 2.00 | 0.01 | 75 | 6.0 | 8 | 4.77 | 10 |
| 55 | Nitrogen | 400 | 0.8 | 2.00 | 0.01 | 75 | 3.0 | 16 | 4.77 | 10 |
| 56 | Nitrogen | 400 | 0.8 | 2.00 | 0.01 | 75 | 1.5 | 32 | 4.77 | 10 |
| 57 | Nitrogen | 400 | 0.8 | 2.00 | 0.01 | 75 | 1.3 | 37 | 4.77 | 10 |
| 58 | Nitrogen | 400 | 0.8 | 2.00 | 0.01 | 75 | 1.2 | 40 | 4.77 | 10 |
| 59 | Nitrogen | 400 | 0.8 | 2.00 | 0.01 | 75 | 1.1 | 43 | 4.77 | 10 |
| 60 | Nitrogen | 400 | 0.8 | 2.00 | 0.01 | 75 | 0.9 | 53 | 4.77 | 10 |
| 61 | Nitrogen | 400 | 0.8 | 2.00 | 0.01 | 90 | 19.0 | 3 | 5.73 | 10 |
| 62 | Nitrogen | 400 | 0.8 | 2.00 | 0.01 | 90 | 12.0 | 5 | 5.73 | 10 |
| 63 | Nitrogen | 400 | 0.8 | 2.00 | 0.01 | 90 | 8.0 | 7 | 5.73 | 10 |
| 64 | Nitrogen | 400 | 0.8 | 2.00 | 0.01 | 90 | 6.0 | 10 | 5.73 | 10 |
| 65 | Nitrogen | 400 | 0.8 | 2.00 | 0.01 | 90 | 4.0 | 14 | 5.73 | 10 |
| 66 | Nitrogen | 400 | 0.8 | 2.00 | 0.01 | 90 | 2.0 | 29 | 5.73 | 10 |
| 67 | Nitrogen | 400 | 0.8 | 2.00 | 0.01 | 90 | 1.5 | 38 | 5.73 | 10 |
| 68 | Nitrogen | 400 | 0.8 | 2.00 | 0.01 | 90 | 1.3 | 44 | 5.73 | 10 |
| 69 | Nitrogen | 400 | 0.8 | 2.00 | 0.01 | 90 | 1.2 | 48 | 5.73 | 10 |
| 70 | Nitrogen | 400 | 0.8 | 2.00 | 0.01 | 90 | 1.1 | 52 | 5.73 | 10 |

TABLE 3D

| | | | Maximum | Maximum | | | | | |
|---|---|---|---|---|---|---|---|---|---|
| | | | depth of | height of | | | | | |
| | | | recessed | protrusion on | | | | | |
| | Temperature | | part on | rear surface | | | Magnetic | | |
| | rising rate in | Width of | laser | of laser | | | flux | | |
| | decarburization | deformed | irradiated | irradiated | | Ratio of | density | Space | |
| Steel | annealing step | region | surface | portion | Steepness | abnormal | B8 | factor | |
| No. | V ° C./s | W mm | D_{recess} mm | Dₚᵣₒₜᵣᵤₛᵢₒₙ mm | 2Dₚᵣₒₜᵣᵤₛᵢₒₙ/W | grains % | T | % | Remarks |
| 1 | 1000 | 7.8 | 0.000 | 0.000 | 0.0000 | — | 1.91 | 98 | Comparative |
| | | | | | | | | | Example |
| 2 | 1000 | 8.2 | 0.001 | 0.001 | 0.0002 | — | 1.91 | 98 | Comparative |
| | | | | | | | | | Example |
| 3 | 1000 | 8.1 | 0.001 | 0.001 | 0.0002 | — | 1.91 | 98 | Comparative |
| | | | | | | | | | Example |
| 4 | 1000 | 8.3 | 0.001 | 0.002 | 0.0005 | — | 1.92 | 98 | Comparative |
| | | | | | | | | | Example |
| 5 | 1000 | 7.6 | 0.002 | 0.003 | 0.0008 | — | 1.92 | 97 | Comparative |
| | | | | | | | | | Example |
| 6 | 1000 | 7.5 | 0.005 | 0.005 | 0.0013 | — | 1.92 | 97 | Comparative |
| | | | | | | | | | Example |
| 7 | 1000 | 7.6 | 0.007 | 0.006 | 0.0016 | — | 1.91 | 97 | Comparative |
| | | | | | | | | | Example |
| 8 | 1000 | 8.1 | 0.007 | 0.007 | 0.0017 | — | 1.90 | 96 | Comparative |
| | | | | | | | | | Example |
| 9 | 1000 | 8.0 | 0.008 | 0.008 | 0.0020 | — | 1.89 | 96 | Comparative |
| | | | | | | | | | Example |
| 10 | 1000 | 8.0 | 0.009 | 0.009 | 0.0023 | — | 1.88 | 95 | Comparative |
| | | | | | | | | | Example |
| 11 | 1000 | 8.0 | 0.000 | 0.000 | 0.0000 | — | 1.92 | 98 | Comparative |
| | | | | | | | | | Example |
| 12 | 1000 | 7.9 | 0.001 | 0.001 | 0.0003 | 0 | 1.93 | 98 | Invention |
| | | | | | | | | | Example |
| 13 | 1000 | 7.9 | 0.001 | 0.001 | 0.0003 | 0 | 1.93 | 98 | Invention |
| | | | | | | | | | Example |
| 14 | 1000 | 8.0 | 0.001 | 0.002 | 0.0005 | 0 | 1.94 | 98 | Invention |
| | | | | | | | | | Example |
| 15 | 1000 | 7.6 | 0.002 | 0.002 | 0.0005 | 1 | 1.94 | 97 | Invention |
| | | | | | | | | | Example |
| 16 | 1000 | 7.5 | 0.005 | 0.005 | 0.0013 | 2 | 1.93 | 97 | Invention |
| | | | | | | | | | Example |
| 17 | 1000 | 8.3 | 0.006 | 0.007 | 0.0017 | 2 | 1.93 | 97 | Invention |
| | | | | | | | | | Example |
| 18 | 1000 | 8.3 | 0.007 | 0.007 | 0.0017 | 3 | 1.93 | 96 | Invention |
| | | | | | | | | | Example |
| 19 | 1000 | 8.6 | 0.008 | 0.008 | 0.0019 | 4 | 1.93 | 96 | Invention |
| | | | | | | | | | Example |
| 20 | 1000 | 8.4 | 0.009 | 0.009 | 0.0021 | — | 1.87 | 95 | Comparative |
| | | | | | | | | | Example |

TABLE 3E

| | | | Maximum | Maximum | | | | | |
|---|---|---|---|---|---|---|---|---|---|
| | | | depth of | height of | | | | | |
| | Temperature | | recessed | protrusion on | | | | | |
| | rising rate in | Width of | part on | rear surface | | | Magnetic | | |
| | decarburization | deformed | laser | of laser | | Ratio of | flux | | |
| | annealing step | region | irradiated | irradiated | | abnormal | density | Space | |
| Steel | V | W | surface | portion | Steepness | grains | B8 | factor | |
| No. | ° C./s | mm | D_{recess} mm | Dₚᵣₒₜᵣᵤₛᵢₒₙ mm | 2Dₚᵣₒₜᵣᵤₛᵢₒₙ/W | % | T | % | Remarks |
| 21 | 1000 | 8.1 | 0.000 | 0.000 | 0.0000 | — | 1.91 | 98 | Comparative |
| | | | | | | | | | Example |
| 22 | 1000 | 8.3 | 0.001 | 0.001 | 0.0002 | 0 | 1.93 | 98 | Invention |
| | | | | | | | | | Example |
| 23 | 1000 | 8.2 | 0.001 | 0.001 | 0.0002 | 0 | 1.94 | 98 | Invention |
| | | | | | | | | | Example |
| 24 | 1000 | 8.6 | 0.001 | 0.002 | 0.0005 | 0 | 1.95 | 98 | Invention |
| | | | | | | | | | Example |
| 25 | 1000 | 8.1 | 0.001 | 0.002 | 0.0005 | 0 | 1.95 | 97 | Invention |
| | | | | | | | | | Example |
| 26 | 1000 | 8.2 | 0.004 | 0.004 | 0.0010 | 0 | 1.95 | 97 | Invention |
| | | | | | | | | | Example |
| 27 | 1000 | 8.1 | 0.007 | 0.007 | 0.0017 | 1 | 1.94 | 97 | Invention |
| | | | | | | | | | Example |
| 28 | 1000 | 8.3 | 0.007 | 0.007 | 0.0017 | 1 | 1.94 | 96 | Invention |
| | | | | | | | | | Example |
| 29 | 1000 | 8.2 | 0.008 | 0.008 | 0.0020 | 2 | 1.93 | 96 | Invention |
| | | | | | | | | | Example |
| 30 | 1000 | 8.6 | 0.009 | 0.009 | 0.0021 | — | 1.87 | 95 | Comparative |
| | | | | | | | | | Example |
| 31 | 1000 | 8.4 | 0.000 | 0.000 | 0.0000 | 0 | 1.92 | 98 | Comparative |
| | | | | | | | | | Example |
| 32 | 1000 | 8.1 | 0.001 | 0.001 | 0.0002 | 0 | 1.93 | 98 | Invention |
| | | | | | | | | | Example |
| 33 | 1000 | 8.2 | 0.001 | 0.001 | 0.0002 | 0 | 1.94 | 98 | Invention |
| | | | | | | | | | Example |
| 34 | 1000 | 7.9 | 0.001 | 0.001 | 0.0003 | 0 | 1.95 | 98 | Invention |
| | | | | | | | | | Example |
| 35 | 1000 | 7.8 | 0.002 | 0.002 | 0.0005 | 0 | 1.95 | 97 | Invention |
| | | | | | | | | | Example |
| 36 | 1000 | 7.9 | 0.005 | 0.004 | 0.0010 | 0 | 1.94 | 97 | Invention |
| | | | | | | | | | Example |
| 37 | 1000 | 8.1 | 0.006 | 0.007 | 0.0017 | 1 | 1.94 | 97 | Invention |
| | | | | | | | | | Example |
| 38 | 1000 | 8.1 | 0.007 | 0.007 | 0.0017 | 2 | 1.93 | 96 | Invention |
| | | | | | | | | | Example |
| 39 | 1000 | 8.1 | 0.008 | 0.008 | 0.0020 | 4 | 1.93 | 96 | Invention |
| | | | | | | | | | Example |
| 40 | 1000 | 8.3 | 0.009 | 0.009 | 0.0022 | — | 1.85 | 95 | Comparative |
| | | | | | | | | | Example |

TABLE 3F

| | | | Maximum | Maximum | | | | | |
|---|---|---|---|---|---|---|---|---|---|
| | | | depth of | height of | | | | | |
| | Temperature | | recessed | protrusion on | | | | | |
| | rising rate in | Width of | part on | rear surface | | | Magnetic | | |
| | decarburization | deformed | laser | of laser | | Ratio of | flux | | |
| | annealing step | region | irradiated | irradiated | | abnormal | density | Space | |
| Steel | V | W | surface | portion | Steepness | grains | B8 | factor | |
| No. | ° C./s | mm | D_{recess} mm | Dₚᵣₒₜᵣᵤₛᵢₒₙ mm | 2Dₚᵣₒₜᵣᵤₛᵢₒₙ/W | % | T | % | Remarks |
| 41 | 1000 | 8.4 | 0.000 | 0.000 | 0.0000 | — | 1.91 | 98 | Comparative |
| | | | | | | | | | Example |
| 42 | 1000 | 8.1 | 0.001 | 0.001 | 0.0002 | 0 | 1.93 | 98 | Invention |
| | | | | | | | | | Example |
| 43 | 1000 | 8.3 | 0.001 | 0.001 | 0.0002 | 0 | 1.94 | 98 | Invention |
| | | | | | | | | | Example |
| 44 | 1000 | 7.5 | 0.001 | 0.001 | 0.0003 | 0 | 1.95 | 98 | Invention |
| | | | | | | | | | Example |
| 45 | 1000 | 7.6 | 0.002 | 0.003 | 0.0008 | 0 | 1.96 | 97 | Invention |
| | | | | | | | | | Example |
| 46 | 1000 | 7.8 | 0.004 | 0.005 | 0.0013 | 0 | 1.95 | 97 | Invention |
| | | | | | | | | | Example |
| 47 | 1000 | 8.0 | 0.006 | 0.006 | 0.0015 | 1 | 1.94 | 97 | Invention |
| | | | | | | | | | Example |
| 48 | 1000 | 7.9 | 0.007 | 0.007 | 0.0018 | 2 | 1.93 | 96 | Invention |
| | | | | | | | | | Example |
| 49 | 1000 | 8.0 | 0.008 | 0.008 | 0.0020 | 3 | 1.93 | 96 | Invention |
| | | | | | | | | | Example |
| 50 | 1000 | 8.8 | 0.009 | 0.009 | 0.0020 | — | 1.84 | 95 | Comparative |
| | | | | | | | | | Example |
| 51 | 1000 | 7.9 | 0.000 | 0.000 | 0.0000 | — | 1.91 | 98 | Comparative |
| | | | | | | | | | Example |
| 52 | 1000 | 7.9 | 0.001 | 0.001 | 0.0003 | 0 | 1.93 | 98 | Invention |
| | | | | | | | | | Example |
| 53 | 1000 | 8.6 | 0.001 | 0.001 | 0.0002 | 0 | 1.93 | 98 | Invention |
| | | | | | | | | | Example |
| 54 | 1000 | 8.0 | 0.001 | 0.001 | 0.0003 | 0 | 1.94 | 98 | Invention |
| | | | | | | | | | Example |
| 55 | 1000 | 8.1 | 0.002 | 0.002 | 0.0005 | 0 | 1.95 | 97 | Invention |
| | | | | | | | | | Example |
| 56 | 1000 | 8.3 | 0.004 | 0.005 | 0.0012 | 0 | 1.94 | 97 | Invention |
| | | | | | | | | | Example |
| 57 | 1000 | 8.1 | 0.005 | 0.006 | 0.0015 | 1 | 1.93 | 97 | Invention |
| | | | | | | | | | Example |
| 58 | 1000 | 8.5 | 0.006 | 0.007 | 0.0016 | 3 | 1.93 | 96 | Invention |
| | | | | | | | | | Example |
| 59 | 1000 | 8.6 | 0.008 | 0.008 | 0.0019 | 4 | 1.93 | 96 | Invention |
| | | | | | | | | | Example |
| 60 | 1000 | 8.0 | 0.009 | 0.009 | 0.0023 | — | 1.83 | 95 | Comparative |
| | | | | | | | | | Example |
| 61 | 1000 | — | — | — | — | — | 1.88 | 97 | Comparative |
| | | | | | | | | | Example |
| 62 | 1000 | — | — | — | — | — | 1.87 | 97 | Invention |
| | | | | | | | | | Example |
| 63 | 1000 | — | — | — | — | — | 1.89 | 97 | Invention |
| | | | | | | | | | Example |
| 64 | 1000 | — | — | — | — | — | 1.90 | 97 | Invention |
| | | | | | | | | | Example |
| 65 | 1000 | — | — | — | — | — | 1.91 | 96 | Invention |
| | | | | | | | | | Example |
| 66 | 1000 | — | — | — | — | — | 1.89 | 96 | Invention |
| | | | | | | | | | Example |
| 67 | 1000 | — | — | — | — | — | 1.87 | 96 | Invention |
| | | | | | | | | | Example |
| 68 | 1000 | — | — | — | — | — | 1.87 | 95 | Invention |
| | | | | | | | | | Example |
| 69 | 1000 | — | — | — | — | — | 1.86 | 95 | Invention |
| | | | | | | | | | Example |
| 70 | 1000 | — | — | — | — | — | 1.67 | 95 | Comparative |
| | | | | | | | | | Example |

### 4. Example 4

A slab was prepared in which the chemical composition contained, in mass %, C: 0.08%, Si: 3.3%, Mn: 0.08%, S: 0.02%, sol.A1: 0.03%, and N: 0.01%, with the remainder being Fe and impurities.

This slab was heated to 1350° C. in a heating furnace. A hot rolling step was performed on the heated slab to manufacture a hot-rolled steel sheet having a sheet thickness of 2.3 mm. The hot-rolled steel sheet was subjected to a hot-band annealing step of annealing, and then to cold rolling to manufacture a cold-rolled steel sheet having a thickness of 0.22 mm. A decarburization annealing step was performed on the cold-rolled steel sheet after the cold rolling step. In this decarburization annealing step, partial rapid heating with a laser beam was performed on one surface of the steel sheet under the conditions shown in Table 4A before the temperature was raised. The scanning direction of the laser was set to 90 degrees with respect to the rolling direction.

After the partial rapid heating, the steel sheet was primary recrystallized by heating in a non-oxidizing atmosphere containing hydrogen and nitrogen at the temperature rising rate shown in Table 4B, then the decarburization annealing temperature was set to 830° C., and the steel sheet was soaked for 60 seconds. In Example 4, the temperature rising rate was varied. At this time, the atmosphere in the heat treatment furnace for performing the decarburization annealing treatment was a wet atmosphere containing hydrogen and nitrogen. An annealing separator (water slurry) containing MgO as a main component was applied to the surface of the steel sheet after decarburization annealing, and then the steel sheet was wound into a coil shape. The steel sheet wound in a coil shape was subjected to final annealing.

On the steel sheet after the final annealing step, an insulating film forming step was performed. In the insulating film forming step, an insulating coating agent mainly composed of colloidal silica and phosphate was applied to the surface (on the glass film) of the grain-oriented electrical steel sheet after the final annealing step, and then baking was performed. In this way, an insulating film as a high-tension insulating film was formed on the glass film. A grain-oriented electrical steel sheet of each Test No. was manufactured by the above manufacturing steps.

### 4-1. Removal of Film

The chemical composition of the base steel sheet can be measured by a well-known component analysis method. First, the primary film and the secondary film are removed from the base steel sheet by the following method. Specifically, the grain-oriented electrical steel sheet including the secondary film is immersed in a high-temperature alkaline solution to remove the secondary film. The composition and temperature of the alkali solution, and the immersion time may be appropriately adjusted. For example, the grain-oriented electrical steel sheet including a secondary film is immersed in a sodium hydroxide aqueous solution of NaOH: 30 to 50 mass %+H₂O: 50 to 70 mass % at 80 to 90° C. for 5 to 10 minutes, and after immersion, washed with water, and dried. By this step, the secondary film is removed from the grain-oriented electrical steel sheet.

Further, the grain-oriented electrical steel sheet from which the secondary film has been removed and on which the primary film remains is immersed in high-temperature hydrochloric acid to remove the primary film. The concentration and temperature of the hydrochloric acid, and the immersion time may be appropriately adjusted. For example, the grain-oriented electrical steel sheet from which the secondary film has been removed and on which the primary film remains is immersed in 30 to 40 mass % hydrochloric acid at 80 to 90° C. for 1 to 5 minutes, and after immersion, washed with water, and dried. Through the above steps, a base steel sheet from which the secondary film and the primary film have been removed is obtained.

### 4-2. Measurement Experiment of Chemical Composition of Base Steel Sheet

The chemical composition of the base steel sheet of the grain-oriented electrical steel sheet of each Test No. was measured by the following method. First, the primary film and the secondary film of the grain-oriented electrical steel sheet were removed by the above-described method to extract the base steel sheet. Using the base steel sheet, the chemical composition of the base steel sheet was analyzed based on the following

### [Method for Measuring Chemical Composition of Steel Sheet].

The chips were collected from the obtained base steel sheet. The collected chips were dissolved in an acid to obtain a solution. The solution was subjected to Inductively Coupled Plasma Atomic Emission Spectrometry (ICP-AES) to perform elemental analysis of chemical composition. The C content and the S content were determined by a well-known high frequency combustion method (combustion-infrared absorption method). The N content was determined using a well-known inert gas fusion-thermal conductivity method. Specifically, measurement was performed using a component analyzer (trade name: ICPS-8000) manufactured by Shimadzu Corporation.

The results of the analysis showed that the chemical composition of the base steel sheet in any of the Test Nos. in Example 4 contained, in mass %, C: 0.01% or less, Si: 3.3%, Mn: 0.08%, S: 0.01% or less, sol.Al: 0.01% or less, and N: 0.01% or less, with the remainder being Fe and impurities.

The magnetic characteristic (magnetic flux density B8 value) of the grain-oriented electrical steel sheet of each Test No. was evaluated in accordance with JIS C2556 (2015). The obtained magnetic flux density B8 is shown in Table 4B.

The shape of the deformed region of the grain-oriented electrical steel sheet of each Test No. was measured by the following method. That is, using a commercially available surface roughness measurement device (SE3500, manufactured by Kosaka Laboratory Ltd.) and SE2555N (radius of tip curvature: 2 μm) as a stylus of the detection unit, under a setting of a measurement length in the rolling direction of 15 mm per measurement, measurement was performed continuously 5 times, whereby the surface roughness over a length of 75 mm in total was measured. The measurement was performed in both the front and the rear. W, Dₚᵣₒₜᵣᵤₛᵢₒₙ, and D_{recess} at each of five points in the measurement regions of the front and the rear were measured, and evaluated by an average value thereof. The width of the obtained deformed region W, the maximum depth of recessed part on one surface side of the deformed region D_{reccess}, and the maximum height of protrusion on the rear surface side of the deformed region Dₚᵣₒₜᵣᵤₛᵢₒₙ are shown in Table 4B.

Further, the space factor of the grain-oriented electrical steel sheet of each Test No. was evaluated in accordance with JiS C2550-5 (2020). The obtained space factor is shown in Table 4B.

Further, the area fraction of abnormal grains in the deformed region of the grain-oriented electrical steel sheet of each Test No. was measured by the following method. That is, the crystal orientation of the region with the width of deformed region W was measured at a pitch of 2 mm in the width direction of the grain-oriented electrical steel sheet along the center line in the longitudinal direction of the deformed region using a Laue diffractometer. Then, from the crystal orientation of each measurement point, the number of measurement points indicating abnormal grains having a deviation angle of 15° or more from the Goss orientation was extracted, and the ratio of the number of these measurement points to the total number of measurement points was taken as the area fraction of abnormal grains. However, for the steel No. with an inferior magnetism of less than 1.93 T in the measurement of the magnetic characteristics described above, measurement of the area fraction of abnormal grains by a Laue diffractometer was not performed. The area fraction of the obtained abnormal grains is shown in Table 4B.

With reference to Tables 4A and B, in steel Nos. 1, 14, and 27, the temperature rising rate was slow, the effect of providing secondary recrystallization nuclei depended on only the rapid heating effect by laser heating was insufficient, and the magnetic flux density was less than 1.93 T, which was inferior.

In steel Nos. 13, 26, and 39, the temperature rising rate was high, the coincidence site lattice orientation for promoting the growth of secondary recrystallization nuclei decreased, and the magnetic flux density was less than 1.93 T, which was inferior.

In the steel No. other than the above, since all the manufacturing step conditions were appropriate, the magnetic flux density was 1.93 T or more, which was excellent, and the space factor was also as high as 96% or more.

TABLE 4A

| | Laser irradiation conditions | | | | | | | | | |
|---|---|---|---|---|---|---|---|---|---|---|
| | | | | Focused | Focused | | | | | Laser |
| | | | Steel | diameter | diameter | | | Irradiation | Instantaneous | irradiation |
| | | Steel sheet | sheet | in rolling | in width | | Speed | energy | power | interval |
| Steel | | temperature | tension | direction | direction | Output | Vc | density | density | L |
| No. | Atmosphere | ° C. | kg/mm² | Dl mm | Dc mm | PW | mm/s | Up J/mm² | Ip kW/mm² | mm |
| 1 | Nitrogen | 400 | 0.8 | 0.60 | 1.00 | 45 | 10.0 | 10 | 0.10 | 10 |
| 2 | Nitrogen | 400 | 0.8 | 0.60 | 1.00 | 45 | 10.0 | 10 | 0.10 | 10 |
| 3 | Nitrogen | 400 | 0.8 | 0.60 | 1.00 | 45 | 10.0 | 10 | 0.10 | 10 |
| 4 | Nitrogen | 400 | 0.8 | 0.60 | 1.00 | 45 | 10.0 | 10 | 0.10 | 10 |
| 5 | Nitrogen | 400 | 0.8 | 0.60 | 1.00 | 45 | 10.0 | 10 | 0.10 | 10 |
| 6 | Nitrogen | 400 | 0.8 | 0.60 | 1.00 | 45 | 10.0 | 10 | 0.10 | 10 |
| 7 | Nitrogen | 400 | 0.8 | 0.60 | 1.00 | 45 | 10.0 | 10 | 0.10 | 10 |
| 8 | Nitrogen | 400 | 0.8 | 0.60 | 1.00 | 45 | 10.0 | 10 | 0.10 | 10 |
| 9 | Nitrogen | 400 | 0.8 | 0.60 | 1.00 | 45 | 10.0 | 10 | 0.10 | 10 |
| 10 | Nitrogen | 400 | 0.8 | 0.60 | 1.00 | 45 | 10.0 | 10 | 0.10 | 10 |
| 11 | Nitrogen | 400 | 0.8 | 0.60 | 1.00 | 45 | 10.0 | 10 | 0.10 | 10 |
| 12 | Nitrogen | 400 | 0.8 | 0.60 | 1.00 | 45 | 10.0 | 10 | 0.10 | 10 |
| 13 | Nitrogen | 400 | 0.8 | 0.60 | 1.00 | 45 | 10.0 | 10 | 0.10 | 10 |
| 14 | Nitrogen | 400 | 0.8 | 2.00 | 0.30 | 45 | 3.0 | 10 | 0.10 | 10 |
| 15 | Nitrogen | 400 | 0.8 | 2.00 | 0.30 | 45 | 3.0 | 10 | 0.10 | 10 |
| 16 | Nitrogen | 400 | 0.8 | 2.00 | 0.30 | 45 | 3.0 | 10 | 0.10 | 10 |
| 17 | Nitrogen | 400 | 0.8 | 2.00 | 0.30 | 45 | 3.0 | 10 | 0.10 | 10 |
| 18 | Nitrogen | 400 | 0.8 | 2.00 | 0.30 | 45 | 3.0 | 10 | 0.10 | 10 |
| 19 | Nitrogen | 400 | 0.8 | 2.00 | 0.30 | 45 | 3.0 | 10 | 0.10 | 10 |
| 20 | Nitrogen | 400 | 0.8 | 2.00 | 0.30 | 45 | 3.0 | 10 | 0.10 | 10 |
| 21 | Nitrogen | 400 | 0.8 | 2.00 | 0.30 | 45 | 3.0 | 10 | 0.10 | 10 |
| 22 | Nitrogen | 400 | 0.8 | 2.00 | 0.30 | 45 | 3.0 | 10 | 0.10 | 10 |
| 23 | Nitrogen | 400 | 0.8 | 2.00 | 0.30 | 45 | 3.0 | 10 | 0.10 | 10 |
| 24 | Nitrogen | 400 | 0.8 | 2.00 | 0.30 | 45 | 3.0 | 10 | 0.10 | 10 |
| 25 | Nitrogen | 400 | 0.8 | 2.00 | 0.30 | 45 | 3.0 | 10 | 0.10 | 10 |
| 26 | Nitrogen | 400 | 0.8 | 2.00 | 0.30 | 45 | 3.0 | 10 | 0.10 | 10 |
| 27 | Nitrogen | 400 | 0.8 | 5.00 | 0.11 | 45 | 1.1 | 10 | 0.10 | 10 |
| 28 | Nitrogen | 400 | 0.8 | 5.00 | 0.11 | 45 | 1.1 | 10 | 0.10 | 10 |
| 29 | Nitrogen | 400 | 0.8 | 5.00 | 0.11 | 45 | 1.1 | 10 | 0.10 | 10 |
| 30 | Nitrogen | 400 | 0.8 | 5.00 | 0.11 | 45 | 1.1 | 10 | 0.10 | 10 |
| 31 | Nitrogen | 400 | 0.8 | 5.00 | 0.11 | 45 | 1.1 | 10 | 0.10 | 10 |
| 32 | Nitrogen | 400 | 0.8 | 5.00 | 0.11 | 45 | 1.1 | 10 | 0.10 | 10 |
| 33 | Nitrogen | 400 | 0.8 | 5.00 | 0.11 | 45 | 1.1 | 10 | 0.10 | 10 |
| 34 | Nitrogen | 400 | 0.8 | 5.00 | 0.11 | 45 | 1.1 | 10 | 0.10 | 10 |
| 35 | Nitrogen | 400 | 0.8 | 5.00 | 0.11 | 45 | 1.1 | 10 | 0.10 | 10 |
| 36 | Nitrogen | 400 | 0.8 | 5.00 | 0.11 | 45 | 1.1 | 10 | 0.10 | 10 |
| 37 | Nitrogen | 400 | 0.8 | 5.00 | 0.11 | 45 | 1.1 | 10 | 0.10 | 10 |
| 38 | Nitrogen | 400 | 0.8 | 5.00 | 0.11 | 45 | 1.1 | 10 | 0.10 | 10 |
| 39 | Nitrogen | 400 | 0.8 | 5.00 | 0.11 | 45 | 1.1 | 10 | 0.10 | 10 |

TABLE 4B

| | | | Maximum | Maximum | | | | | |
|---|---|---|---|---|---|---|---|---|---|
| | | | depth of | height of | | | | | |
| | Temperature | | recessed | protrusion on | | | | | |
| | rising rate in | Width of | part on | rear surface | | | Magnetic | | |
| | decarburization | deformed | laser | of laser | | Ratio of | flux | | |
| | annealing step | region | irradiated | irradiated | | abnormal | density | | |
| Steel | V | W | surface | portion | Steepness | grains | B8 | Space | |
| No. | ° C./s | mm | D_{recess} mm | Dₚᵣₒₜᵣᵤₛᵢₒₙ mm | 2Dpᵣₒₜᵣᵤₛᵢₒₙ/W | % | T | factor | Remarks |
| 1 | 1 | 2.2 | 0.002 | 0.002 | 0.0018 | — | 1.76 | 98 | Comparative |
| | | | | | | | | | Example |
| 2 | 5 | 2.2 | 0.001 | 0.001 | 0.0009 | 0 | 1.93 | 98 | Invention |
| | | | | | | | | | Example |
| 3 | 20 | 2.1 | 0.001 | 0.002 | 0.0019 | 0 | 1.94 | 98 | Invention |
| | | | | | | | | | Example |
| 4 | 50 | 2.3 | 0.002 | 0.002 | 0.0017 | 0 | 1.94 | 98 | Invention |
| | | | | | | | | | Example |
| 5 | 100 | 2.4 | 0.001 | 0.002 | 0.0017 | 0 | 1.96 | 98 | Invention |
| | | | | | | | | | Example |
| 6 | 200 | 2.3 | 0.002 | 0.002 | 0.0017 | 0 | 1.96 | 98 | Invention |
| | | | | | | | | | Example |
| 7 | 400 | 2.3 | 0.001 | 0.001 | 0.0009 | 0 | 1.96 | 98 | Invention |
| | | | | | | | | | Example |
| 8 | 600 | 1.9 | 0.002 | 0.002 | 0.0021 | 0 | 1.95 | 98 | Invention |
| | | | | | | | | | Example |
| 9 | 800 | 2.2 | 0.002 | 0.002 | 0.0018 | 0 | 1.95 | 98 | Invention |
| | | | | | | | | | Example |
| 10 | 1000 | 2.4 | 0.002 | 0.002 | 0.0017 | 0 | 1.95 | 98 | Invention |
| | | | | | | | | | Example |
| 11 | 1500 | 2.4 | 0.002 | 0.002 | 0.0017 | 0 | 1.94 | 98 | Invention |
| | | | | | | | | | Example |
| 12 | 2000 | 2.3 | 0.001 | 0.002 | 0.0017 | 0 | 1.93 | 98 | Invention |
| | | | | | | | | | Example |
| 13 | 2500 | 2.4 | 0.002 | 0.002 | 0.0017 | — | 1.92 | 98 | Comparative |
| | | | | | | | | | Example |
| 14 | 1 | 7.5 | 0.002 | 0.002 | 0.0005 | — | 1.83 | 98 | Comparative |
| | | | | | | | | | Example |
| 15 | 5 | 7.8 | 0.001 | 0.002 | 0.0005 | 0 | 1.93 | 98 | Invention |
| | | | | | | | | | Example |
| 16 | 20 | 8.0 | 0.001 | 0.001 | 0.0003 | 0 | 1.95 | 98 | Invention |
| | | | | | | | | | Example |
| 17 | 50 | 7.5 | 0.002 | 0.002 | 0.0005 | 0 | 1.94 | 98 | Invention |
| | | | | | | | | | Example |
| 18 | 100 | 7.6 | 0.001 | 0.001 | 0.0003 | 0 | 1.96 | 98 | Invention |
| | | | | | | | | | Example |
| 19 | 200 | 7.8 | 0.002 | 0.002 | 0.0005 | 0 | 1.96 | 98 | Invention |
| | | | | | | | | | Example |
| 20 | 400 | 7.5 | 0.001 | 0.002 | 0.0005 | 0 | 1.95 | 98 | Invention |
| | | | | | | | | | Example |
| 21 | 600 | 7.8 | 0.002 | 0.002 | 0.0005 | 0 | 1.94 | 98 | Invention |
| | | | | | | | | | Example |
| 22 | 800 | 7.9 | 0.002 | 0.002 | 0.0005 | 0 | 1.94 | 98 | Invention |
| | | | | | | | | | Example |
| 23 | 1000 | 8.0 | 0.001 | 0.002 | 0.0005 | 0 | 1.94 | 98 | Invention |
| | | | | | | | | | Example |
| 24 | 1500 | 8.0 | 0.002 | 0.002 | 0.0005 | 0 | 1.93 | 98 | Invention |
| | | | | | | | | | Example |
| 25 | 2000 | 7.9 | 0.001 | 0.001 | 0.0003 | 0 | 1.93 | 98 | Invention |
| | | | | | | | | | Example |
| 26 | 2500 | 7.9 | 0.002 | 0.002 | 0.0005 | — | 1.91 | 98 | Comparative |
| | | | | | | | | | Example |
| 27 | 1 | 9.2 | 0.001 | 0.001 | 0.0002 | — | 1.84 | 98 | Comparative |
| | | | | | | | | | Example |
| 28 | 5 | 10.1 | 0.002 | 0.002 | 0.0004 | 0 | 1.93 | 98 | Invention |
| | | | | | | | | | Example |
| 29 | 20 | 10.6 | 0.002 | 0.002 | 0.0004 | 0 | 1.95 | 98 | Invention |
| | | | | | | | | | Example |
| 30 | 50 | 9.8 | 0.001 | 0.001 | 0.0002 | 0 | 1.95 | 98 | Invention |
| | | | | | | | | | Example |
| 31 | 100 | 9.9 | 0.001 | 0.002 | 0.0004 | 0 | 1.96 | 98 | Invention |
| | | | | | | | | | Example |
| 32 | 200 | 9.9 | 0.001 | 0.001 | 0.0002 | 0 | 1.95 | 98 | Invention |
| | | | | | | | | | Example |
| 33 | 400 | 10.0 | 0.001 | 0.001 | 0.0002 | 0 | 1.95 | 98 | Invention |
| | | | | | | | | | Example |
| 34 | 600 | 10.2 | 0.001 | 0.001 | 0.0002 | 0 | 1.94 | 98 | Invention |
| | | | | | | | | | Example |
| 35 | 800 | 9.9 | 0.001 | 0.002 | 0.0004 | 0 | 1.94 | 98 | Invention |
| | | | | | | | | | Example |
| 36 | 1000 | 10.2 | 0.001 | 0.001 | 0.0002 | 0 | 1.93 | 98 | Invention |
| | | | | | | | | | Example |
| 37 | 1500 | 9.2 | 0.001 | 0.001 | 0.0002 | 0 | 1.93 | 98 | Invention |
| | | | | | | | | | Example |
| 38 | 2000 | 9.6 | 0.001 | 0.001 | 0.0002 | 0 | 1.93 | 98 | Invention |
| | | | | | | | | | Example |
| 39 | 2500 | 9.4 | 0.001 | 0.002 | 0.0004 | — | 1.92 | 98 | Comparative |
| | | | | | | | | | Example |

### 5. Example 5

A slab was prepared in which the chemical composition contained, in mass %, C: 0.08%, Si: 3.3%, Mn: 0.08%, S: 0.02%, sol.Al: 0.03%, and N: 0.01%, with the remainder being Fe and impurities.

This slab was heated to 1350° C. in a heating furnace. A hot rolling step was performed on the heated slab to manufacture a hot-rolled steel sheet having a sheet thickness of 2.3 mm. The hot-rolled steel sheet was subjected to a hot-band annealing step of annealing, and then to cold rolling to manufacture a cold-rolled steel sheet having a thickness of 0.22 mm. A decarburization annealing step was performed on the cold-rolled steel sheet after the cold rolling step. In this decarburization annealing step, partial rapid heating with a laser beam was performed on one surface of the steel sheet under the conditions shown in Table 5A before the temperature was raised. The scanning direction of the laser was set to 90 degrees with respect to the rolling direction. In Example 5, the tension applied to the cold-rolled steel sheet at the time of laser beam irradiation and the temperature of the cold-rolled steel sheet were varied.

After the partial rapid heating, the steel sheet was primary recrystallized by heating in a non-oxidizing atmosphere containing hydrogen and nitrogen at the temperature rising rate shown in Table 5B, then the decarburization annealing temperature was set to 830° C., and the steel sheet was soaked for 60 seconds. At this time, the atmosphere in the heat treatment furnace for performing the decarburization annealing treatment was a wet atmosphere containing hydrogen and nitrogen. An annealing separator (water slurry) containing MgO as a main component was applied to the surface of the steel sheet after decarburization annealing, and then the steel sheet was wound into a coil shape. The steel sheet wound in a coil shape was subjected to final annealing.

On the steel sheet after the final annealing step, an insulating film forming step was performed. In the insulating film forming step, an insulating coating agent mainly composed of colloidal silica and phosphate was applied to the surface (on the glass film) of the grain-oriented electrical steel sheet after the final annealing step, and then baking was performed. In this way, an insulating film as a high-tension insulating film was formed on the glass film. A grain-oriented electrical steel sheet of each Test No. was manufactured by the above manufacturing steps.

### 5-1. Removal of Film

The chemical composition of the base steel sheet can be measured by a well-known component analysis method. First, the primary film and the secondary film are removed from the base steel sheet by the following method. Specifically, the grain-oriented electrical steel sheet including the secondary film is immersed in a high-temperature alkaline solution to remove the secondary film. The composition and temperature of the alkali solution, and the immersion time may be appropriately adjusted. For example, the grain-oriented electrical steel sheet including a secondary film is immersed in a sodium hydroxide aqueous solution of NaOH: 30 to 50 mass %+H₂O: 50 to 70 mass % at 80 to 90° C. for 5 to 10 minutes, and after immersion, washed with water, and dried. By this step, the secondary film is removed from the grain-oriented electrical steel sheet.

Further, the grain-oriented electrical steel sheet from which the secondary film has been removed and on which the primary film remains is immersed in high-temperature hydrochloric acid to remove the primary film. The concentration and temperature of the hydrochloric acid, and the immersion time may be appropriately adjusted. For example, the grain-oriented electrical steel sheet from which the secondary film has been removed and on which the primary film remains is immersed in 30 to 40 mass % hydrochloric acid at 80 to 90° C. for 1 to 5 minutes, and after immersion, washed with water, and dried. Through the above steps, a base steel sheet from which the secondary film and the primary film have been removed is obtained.

### 5-2. Measurement Experiment of Chemical Composition of Base Steel Sheet

The chemical composition of the base steel sheet of the grain-oriented electrical steel sheet of each Test No. was measured by the following method. First, the primary film and the secondary film of the grain-oriented electrical steel sheet were removed by the above-described method to extract the base steel sheet. Using the base steel sheet, the chemical composition of the base steel sheet was analyzed based on the following

### [Method for Measuring Chemical Composition of Steel Sheet].

The chips were collected from the obtained base steel sheet. The collected chips were dissolved in an acid to obtain a solution. The solution was subjected to Inductively Coupled Plasma Atomic Emission Spectrometry (ICP-AES) to perform elemental analysis of chemical composition. The C content and the S content were determined by a well-known high frequency combustion method (combustion-infrared absorption method). The N content was determined using a well-known inert gas fusion-thermal conductivity method. Specifically, measurement was performed using a component analyzer (trade name: ICPS-8000) manufactured by Shimadzu Corporation.

The results of the analysis showed that the chemical composition of the base steel sheet in any of the Test Nos. in Example 5 contained, in mass %, C: 0.01% or less, Si: 3.3%, Mn: 0.08%, S: 0.01% or less, sol.Al: 0.01% or less, and N: 0.01% or less, with the remainder being Fe and impurities.

The magnetic characteristic (magnetic flux density B8 value) of the grain-oriented electrical steel sheet of each Test No. was evaluated in accordance with JIS C2556 (2015). The obtained magnetic flux density B8 is shown in Table 5B.

The shape of the deformed region of the grain-oriented electrical steel sheet of each Test No. was measured by the following method. That is, using a commercially available surface roughness measurement device (SE3500, manufactured by Kosaka Laboratory Ltd.) and SE2555N (radius of tip curvature: 2 μm) as a stylus of the detection unit, under a setting of a measurement length in the rolling direction of 15 mm per measurement, measurement was performed continuously 5 times, whereby the surface roughness over a length of 75 mm in total was measured. The measurement was performed in both the front and the rear. W, Dₚᵣₒₜᵣᵤₛᵢₒₙ, and D_{recess} at each of five points in the measurement regions of the front and the rear were measured, and evaluated by an average value thereof. The width of the obtained deformed region W, the maximum depth of recessed part on one surface side of the deformed region D_{recess}, and the maximum height of protrusion on the rear surface side of the deformed region Dₚᵣₒₜᵣᵤₛᵢₒₙ are shown in Table 5B.

Further, the space factor of the grain-oriented electrical steel sheet of each Test No. was evaluated in accordance with JIS C2550-5 (2020). The obtained space factor is shown in Table 5B.

Further, the area fraction of abnormal grains in the deformed region of the grain-oriented electrical steel sheet of each Test No. was measured by the following method. That is, the crystal orientation of the region with the width of deformed region W was measured at a pitch of 2 mm in the width direction of the grain-oriented electrical steel sheet along the center line in the longitudinal direction of the deformed region using a Laue diffractometer. Then, from the crystal orientation of each measurement point, the number of measurement points indicating abnormal grains having a deviation angle of 150 or more from the Goss orientation was extracted, and the ratio of the number of these measurement points to the total number of measurement points was taken as the area fraction of abnormal grains. However, for the steel No. with an inferior magnetism of less than 1.93 T in the measurement of the magnetic characteristics described above, measurement of the area fraction of abnormal grains by a Laue diffractometer was not performed. The area fraction of the obtained abnormal grains is shown in Table 5B.

With reference to Tables 5A and 5B, in steel Nos. 1 to 5, the tension at the time of laser heating was low, the recess and the protrusion in the deformed region were large, the steepness was 0.01 or more, and the space factor was less than 96%.

In steel Nos. 21 to 25, the tension at the time of laser heating was high, causing deterioration of primary recrystallization texture, the magnetic characteristics were inferior, and the magnetic flux density B8 was less than 1.93 T.

In steel Nos. 6, 11, and 16, the temperature at the time of laser heating was low, shape deterioration associated with a rapid temperature change in the deformed region was significant, the recess and the protrusion in the deformed region were large, the steepness was 0.01 or more, and the space factor was less than 96%.

In steel Nos. 10, 15, and 20, the temperature at the time of laser heating was high, recrystallization proceeded before laser heating, and a partial rapid heating effect was not obtained, whereby the magnetic flux density was inferior, and was less than 1.93 T.

In the steel No. other than the above, since all the manufacturing step conditions were appropriate, the magnetic flux density was 1.93 T or more, which was excellent, and the space factor was also as high as 96% or more.

TABLE 5A

| | Laser irradiation conditions | | | | | | | | | |
|---|---|---|---|---|---|---|---|---|---|---|
| | | | | Focused | Focused | | | | | Laser |
| | | | Steel | diameter | diameter | | | Irradiation | Instantaneous | irradiation |
| | | Steel sheet | sheet | in rolling | in width | | Speed | energy | power | interval |
| Steel | | temperature | tension | direction | direction | Output | Vc | density | density | L |
| No. | Atmosphere | ° C. | kg/mm² | Dl mm | Dc mm | PW | mm/s | Up J/mm² | Ip kW/mm² | mm |
| 1 | Nitrogen | 150 | 0.1 | 0.60 | 0.40 | 45 | 15.0 | 6 | 0.24 | 10 |
| 2 | Nitrogen | 200 | 0.1 | 0.60 | 0.40 | 45 | 15.0 | 6 | 0.24 | 10 |
| 3 | Nitrogen | 400 | 0.1 | 0.60 | 0.40 | 45 | 15.0 | 6 | 0.24 | 10 |
| 4 | Nitrogen | 550 | 0.1 | 0.60 | 0.40 | 45 | 15.0 | 6 | 0.24 | 10 |
| 5 | Nitrogen | 600 | 0.1 | 0.60 | 0.40 | 45 | 15.0 | 6 | 0.24 | 10 |
| 6 | Nitrogen | 150 | 0.2 | 0.60 | 0.40 | 45 | 15.0 | 6 | 0.24 | 10 |
| 7 | Nitrogen | 200 | 0.2 | 0.60 | 0.40 | 45 | 15.0 | 6 | 0.24 | 10 |
| 8 | Nitrogen | 400 | 0.2 | 0.60 | 0.40 | 45 | 15.0 | 6 | 0.24 | 10 |
| 9 | Nitrogen | 550 | 0.2 | 0.60 | 0.40 | 45 | 15.0 | 6 | 0.24 | 10 |
| 10 | Nitrogen | 600 | 0.2 | 0.60 | 0.40 | 45 | 15.0 | 6 | 0.24 | 10 |
| 11 | Nitrogen | 150 | 0.5 | 0.60 | 0.40 | 45 | 15.0 | 6 | 0.24 | 10 |
| 12 | Nitrogen | 200 | 0.5 | 0.60 | 0.40 | 45 | 15.0 | 6 | 0.24 | 10 |
| 13 | Nitrogen | 400 | 0.5 | 0.60 | 0.40 | 45 | 15.0 | 6 | 0.24 | 10 |
| 14 | Nitrogen | 550 | 0.5 | 0.60 | 0.40 | 45 | 15.0 | 6 | 0.24 | 10 |
| 15 | Nitrogen | 600 | 0.5 | 0.60 | 0.40 | 45 | 15.0 | 6 | 0.24 | 10 |
| 16 | Nitrogen | 150 | 1.2 | 0.60 | 0.40 | 45 | 15.0 | 6 | 0.24 | 10 |
| 17 | Nitrogen | 200 | 1.2 | 0.60 | 0.40 | 45 | 15.0 | 6 | 0.24 | 10 |
| 18 | Nitrogen | 400 | 1.2 | 0.60 | 0.40 | 45 | 15.0 | 6 | 0.24 | 10 |
| 19 | Nitrogen | 550 | 1.2 | 0.60 | 0.40 | 45 | 15.0 | 6 | 0.24 | 10 |
| 20 | Nitrogen | 600 | 1.2 | 0.60 | 0.40 | 45 | 15.0 | 6 | 0.24 | 10 |
| 21 | Nitrogen | 150 | 1.4 | 0.60 | 0.40 | 45 | 15.0 | 6 | 0.24 | 10 |
| 22 | Nitrogen | 200 | 1.4 | 0.60 | 0.40 | 45 | 15.0 | 6 | 0.24 | 10 |
| 23 | Nitrogen | 400 | 1.4 | 0.60 | 0.40 | 45 | 15.0 | 6 | 0.24 | 10 |
| 24 | Nitrogen | 550 | 1.4 | 0.60 | 0.40 | 45 | 15.0 | 6 | 0.24 | 10 |
| 25 | Nitrogen | 600 | 1.4 | 0.60 | 0.40 | 45 | 15.0 | 6 | 0.24 | 10 |

TABLE 5B

| | | | Maximum | Maximum | | | | | |
|---|---|---|---|---|---|---|---|---|---|
| | | | depth of | height of | | | | | |
| | Temperature | | recessed | protrusion on | | | | | |
| | rising rate in | Width of | part on | rear surface | | | Magnetic | | |
| | decarburization | deformed | laser | of laser | | Ratio of | flux | | |
| | annealing step | region | irradiated | irradiated | | abnormal | density | Space | |
| Steel | V | W | surface | portion | Steepness | grains | B8 | factor | |
| No. | ° C./s | mm | D_{recess} mm | Dₚᵣₒₜᵣᵤₛᵢₒₙ mm | 2Dₚᵣₒₜᵣᵤₛᵢₒₙ/W | % | T | % | Remarks |
| 1 | 1000 | 2.5 | 0.010 | 0.011 | 0.0088 | 0 | 1.95 | 93 | Comparative |
| | | | | | | | | | Example |
| 2 | 1000 | 2.6 | 0.009 | 0.009 | 0.0069 | 0 | 1.95 | 94 | Comparative |
| | | | | | | | | | Example |
| 3 | 1000 | 2.4 | 0.007 | 0.008 | 0.0067 | 0 | 1.95 | 95 | Comparative |
| | | | | | | | | | Example |
| 4 | 1000 | 2.2 | 0.006 | 0.006 | 0.0055 | 0 | 1.95 | 95 | Comparative |
| | | | | | | | | | Example |
| 5 | 1000 | 2.4 | 0.006 | 0.006 | 0.0050 | — | 1.91 | 95 | Comparative |
| | | | | | | | | | Example |
| 6 | 1000 | 2.4 | 0.006 | 0.007 | 0.0058 | 0 | 1.95 | 95 | Comparative |
| | | | | | | | | | Example |
| 7 | 1000 | 2.4 | 0.004 | 0.004 | 0.0033 | 0 | 1.95 | 97 | Invention |
| | | | | | | | | | Example |
| 8 | 1000 | 2.2 | 0.002 | 0.002 | 0.0018 | 0 | 1.95 | 98 | Invention |
| | | | | | | | | | Example |
| 9 | 1000 | 2.5 | 0.001 | 0.001 | 0.0008 | 0 | 1.95 | 98 | Invention |
| | | | | | | | | | Example |
| 10 | 1000 | 2.6 | 0.001 | 0.001 | 0.0008 | — | 1.91 | 98 | Comparative |
| | | | | | | | | | Example |
| 11 | 1000 | 2.4 | 0.006 | 0.006 | 0.0050 | 0 | 1.94 | 95 | Comparative |
| | | | | | | | | | Example |
| 12 | 1000 | 2.4 | 0.003 | 0.004 | 0.0033 | 0 | 1.94 | 97 | Invention |
| | | | | | | | | | Example |
| 13 | 1000 | 2.3 | 0.003 | 0.003 | 0.0026 | 0 | 1.94 | 97 | Invention |
| | | | | | | | | | Example |
| 14 | 1000 | 2.3 | 0.002 | 0.002 | 0.0017 | 0 | 1.94 | 98 | Invention |
| | | | | | | | | | Example |
| 15 | 1000 | 2.6 | 0.001 | 0.001 | 0.0008 | — | 1.91 | 98 | Comparative |
| | | | | | | | | | Example |
| 16 | 1000 | 2.2 | 0.006 | 0.007 | 0.0064 | 0 | 1.93 | 95 | Comparative |
| | | | | | | | | | Example |
| 17 | 1000 | 2.4 | 0.004 | 0.004 | 0.0033 | 0 | 1.93 | 97 | Invention |
| | | | | | | | | | Example |
| 18 | 1000 | 2.8 | 0.003 | 0.003 | 0.0021 | 0 | 1.93 | 97 | Invention |
| | | | | | | | | | Example |
| 19 | 1000 | 2.9 | 0.002 | 0.003 | 0.0021 | 0 | 1.93 | 97 | Invention |
| | | | | | | | | | Example |
| 20 | 1000 | 2.4 | 0.002 | 0.002 | 0.0017 | — | 1.91 | 98 | Comparative |
| | | | | | | | | | Example |
| 21 | 1000 | 2.3 | 0.008 | 0.008 | 0.0070 | — | 1.89 | 95 | Comparative |
| | | | | | | | | | Example |
| 22 | 1000 | 2.4 | 0.005 | 0.005 | 0.0042 | — | 1.92 | 97 | Comparative |
| | | | | | | | | | Example |
| 23 | 1000 | 2.3 | 0.005 | 0.005 | 0.0043 | — | 1.92 | 97 | Comparative |
| | | | | | | | | | Example |
| 24 | 1000 | 2.4 | 0.004 | 0.004 | 0.0033 | — | 1.92 | 97 | Comparative |
| | | | | | | | | | Example |
| 25 | 1000 | 2.4 | 0.003 | 0.003 | 0.0025 | — | 1.89 | 97 | Comparative |
| | | | | | | | | | Example |

### 6. EXAMPLE 6

A slab was prepared in which the chemical composition contained the components shown in Table 6A with the remainder being Fe and impurities. This slab was heated to 1350° C. in a heating furnace. A hot rolling step was performed on the heated slab to manufacture a hot-rolled steel sheet having a sheet thickness of 2.3 mm. The hot-rolled steel sheet was subjected to a hot-band annealing step of annealing, and then to cold rolling to manufacture a cold-rolled steel sheet having a thickness of 0.22 mm. A decarburization annealing step was performed on the cold-rolled steel sheet after the cold rolling step. In this decarburization annealing step, partial rapid heating with a laser beam was performed on one surface of the steel sheet under the conditions shown in Table 6B before the temperature was raised. The scanning direction of the laser was set to 90 degrees with respect to the rolling direction.

After the partial rapid heating, the steel sheet was primary recrystallized by heating in a non-oxidizing atmosphere containing hydrogen and nitrogen at the temperature rising rate shown in Table 6C, then the decarburization annealing temperature was set to 830° C., and the steel sheet was soaked for 60 seconds. At this time, the atmosphere in the heat treatment furnace for performing the decarburization annealing treatment was a wet atmosphere containing hydrogen and nitrogen. An annealing separator (water slurry) containing MgO as a main component was applied to the surface of the steel sheet after decarburization annealing, and then the steel sheet was wound into a coil shape. The steel sheet wound in a coil shape was subjected to final annealing.

On the steel sheet after the final annealing step, an insulating film forming step was performed. In the insulating film forming step, an insulating coating agent mainly composed of colloidal silica and phosphate was applied to the surface (on the glass film) of the grain-oriented electrical steel sheet after the final annealing step, and then baking was performed. In this way, an insulating film as a high-tension insulating film was formed on the glass film. A grain-oriented electrical steel sheet of each Test No. was manufactured by the above manufacturing steps.

### 6-1. Removal of Film

The chemical composition of the base steel sheet can be measured by a well-known component analysis method. First, the primary film and the secondary film are removed from the base steel sheet by the following method. Specifically, the grain-oriented electrical steel sheet including the secondary film is immersed in a high-temperature alkaline solution to remove the secondary film. The composition and temperature of the alkali solution, and the immersion time may be appropriately adjusted. For example, the grain-oriented electrical steel sheet including a secondary film is immersed in a sodium hydroxide aqueous solution of NaOH: 30 to 50 mass %+H₂O: 50 to 70 mass % at 80 to 90° C. for 5 to 10 minutes, and after immersion, washed with water, and dried. By this step, the secondary film is removed from the grain-oriented electrical steel sheet.

Further, the grain-oriented electrical steel sheet from which the secondary film has been removed and on which the primary film remains is immersed in high-temperature hydrochloric acid to remove the primary film. The concentration and temperature of the hydrochloric acid, and the immersion time may be appropriately adjusted. For example, the grain-oriented electrical steel sheet from which the secondary film has been removed and on which the primary film remains is immersed in 30 to 40 mass % hydrochloric acid at 80 to 90° C. for 1 to 5 minutes, and after immersion, washed with water, and dried. Through the above steps, a base steel sheet from which the secondary film and the primary film have been removed is obtained.

### 6-2. Measurement Experiment of Chemical Composition of Base Steel Sheet

The chemical composition of the base steel sheet of the grain-oriented electrical steel sheet of each Test No. was measured by the following method. First, the primary film and the secondary film of the grain-oriented electrical steel sheet were removed by the above-described method to extract the base steel sheet. Using the base steel sheet, the chemical composition of the base steel sheet was analyzed based on the following

### [Method for Measuring Chemical Composition of Steel Sheet].

The chips were collected from the obtained base steel sheet. The collected chips were dissolved in an acid to obtain a solution. The solution was subjected to Inductively Coupled Plasma Atomic Emission Spectrometry (ICP-AES) to perform elemental analysis of chemical composition. The C content and the S content were determined by a well-known high frequency combustion method (combustion-infrared absorption method). The N content was determined using a well-known inert gas fusion-thermal conductivity method. Specifically, measurement was performed using a component analyzer (trade name: ICPS-8000) manufactured by Shimadzu Corporation.

The results of the analysis showed that the chemical composition of the base steel sheet in Example 6 contained the components described in Table 6A with the remainder being Fe and impurities.

The magnetic characteristic (magnetic flux density B8 value) of the grain-oriented electrical steel sheet of each Test No. was evaluated in accordance with JIS C2556 (2015). The obtained magnetic flux density B8 is shown in Table 6C.

The shape of the deformed region of the grain-oriented electrical steel sheet of each Test No. was measured by the following method. That is, using a commercially available surface roughness measurement device (SE3500, manufactured by Kosaka Laboratory Ltd.) and SE2555N (radius of tip curvature: 2 μm) as a stylus of the detection unit, under a setting of a measurement length in the rolling direction of 15 mm per measurement, measurement was performed continuously 5 times, whereby the surface roughness over a length of 75 mm in total was measured. The measurement was performed in both the front and the rear. W, Dₚᵣₒₜᵣᵤₛᵢₒₙ, and D_{recess} at each of five points in the measurement regions of the front and the rear were measured, and evaluated by an average value thereof. The width of the obtained deformed region W, the maximum depth of recessed part on one surface side of the deformed region D_{recess}, and the maximum height of protrusion on the rear surface side of the deformed region Dₚᵣₒₜᵣᵤₛᵢₒₙ are shown in Table 6C.

Further, the space factor of the grain-oriented electrical steel sheet of each Test No. was evaluated in accordance with JIS C2550-5 (2020). The obtained space factor is shown in Table 6C.

Further, the area fraction of abnormal grains in the deformed region of the grain-oriented electrical steel sheet of each Test No. was measured by the following method. That is, the crystal orientation of the region with the width of deformed region W was measured at a pitch of 2 mm in the width direction of the grain-oriented electrical steel sheet along the center line in the longitudinal direction of the deformed region using a Laue diffractometer. Then, from the crystal orientation of each measurement point, the number of measurement points indicating abnormal grains having a deviation angle of 150 or more from the Goss orientation was extracted, and the ratio of the number of these measurement points to the total number of measurement points was taken as the area fraction of abnormal grains. However, for the steel No. with an inferior magnetism of less than 1.93 T in the measurement of the magnetic characteristics described above, measurement of the area fraction of abnormal grains by a Laue diffractometer was not performed. The area fraction of the obtained abnormal grains is shown in Table 6C.

With reference to Tables 6A to C, in steel Nos. 1 to 19, since the chemical composition of the slab was appropriate and all manufacturing step conditions were appropriate, the magnetic flux density was 1.93 T or more, which was excellent, and the space factor was also as high as 96% or more.

TABLE 6A

| Steel | Chemical composition of slab (mass %) | | | | | | | Chemical composition of steel sheet (mass %) | | | | | | |
|---|---|---|---|---|---|---|---|---|---|---|---|---|---|---|
| No. | C | Si | Sol-Al | Mn | N | S | Others | C | Si | Sol-Al | Mn | N | S | Others |
| 1 | 0.08 | 3.3 | 0.03 | 0.08 | 0.01 | 0.02 | | 0.00 | 3.3 | 0.00 | 0.08 | 0.00 | 0.00 | |
| 2 | 0.08 | 3.5 | 0.03 | 0.06 | 0.01 | 0.01 | | 0.00 | 3.5 | 0.00 | 0.06 | 0.00 | 0.00 | |
| 3 | 0.06 | 2.6 | 0.02 | 0.10 | 0.02 | 0.02 | | 0.00 | 2.6 | 0.00 | 0.10 | 0.01 | 0.00 | |
| 4 | 0.07 | 2.9 | 0.02 | 0.04 | 0.01 | 0.01 | | 0.00 | 2.9 | 0.00 | 0.04 | 0.00 | 0.00 | |
| 5 | 0.09 | 3.6 | 0.03 | 0.12 | 0.01 | 0.03 | | 0.01 | 3.6 | 0.01 | 0.12 | 0.00 | 0.01 | |
| 6 | 0.08 | 3.2 | 0.03 | 0.08 | 0.01 | 0.02 | 0.03 P | 0.00 | 3.3 | 0.00 | 0.08 | 0.00 | 0.00 | 0.03 P |
| 7 | 0.08 | 3.4 | 0.02 | 0.08 | 0.01 | 0.02 | 0.01 Sb | 0.00 | 3.4 | 0.00 | 0.08 | 0.00 | 0.00 | 0.01 Sb |
| 8 | 0.05 | 2.9 | 0.01 | 0.14 | 0.01 | 0.01 | 0.08 Sn | 0.00 | 2.9 | 0.00 | 0.14 | 0.00 | 0.00 | 0.08 Sn |
| 9 | 0.08 | 3.3 | 0.03 | 0.08 | 0.01 | 0.02 | 0.05 Cr | 0.00 | 3.3 | 0.00 | 0.08 | 0.00 | 0.00 | 0.05 Cr |
| 10 | 0.08 | 3.3 | 0.03 | 0.08 | 0.01 | 0.02 | 0.05 Cu | 0.00 | 3.3 | 0.00 | 0.08 | 0.00 | 0.00 | 0.05 Cu |
| 11 | 0.08 | 3.4 | 0.03 | 0.08 | 0.01 | 0.02 | 0.04 Ni | 0.00 | 3.4 | 0.00 | 0.08 | 0.00 | 0.00 | 0.04 Ni |
| 12 | 0.08 | 3.3 | 0.03 | 0.08 | 0.01 | 0.02 | 0.0020 Bi | 0.00 | 3.3 | 0.00 | 0.08 | 0.00 | 0.00 | 0.0020 Bi |
| 13 | 0.09 | 3.4 | 0.03 | 0.08 | 0.01 | 0.02 | 0.01 P, 0.10 Sn | 0.00 | 3.4 | 0.00 | 0.08 | 0.00 | 0.00 | 0.01 P, 0.10 Sn |
| 14 | 0.08 | 3.3 | 0.03 | 0.08 | 0.01 | 0.02 | 0.01 P, 0.05 Cu | 0.00 | 3.3 | 0.00 | 0.08 | 0.00 | 0.00 | 0.01 P, 0.05 Cu |
| 15 | 0.08 | 3.2 | 0.03 | 0.08 | 0.02 | 0.02 | 0.10 Sn, 0.0012 Bi | 0.00 | 3.2 | 0.00 | 0.08 | 0.01 | 0.00 | 0.10 Sn, 0.0012 Bi |
| 16 | 0.08 | 3.2 | 0.02 | 0.08 | 0.01 | 0.02 | 0.03 Cr ,0.05 Ni, 0.01 Sb | 0.00 | 3.2 | 0.00 | 0.08 | 0.00 | 0.00 | 0.03 Cr, 0.05 Ni, 0.01 Sb |
| 17 | 0.08 | 3.4 | 0.03 | 0.08 | 0.01 | 0.02 | 0.20 Sn, 0.01 P, 0.03 Ni | 0.00 | 3.4 | 0.00 | 0.08 | 0.00 | 0.00 | 0.20 Sn, 0.01 P, 0.03 Ni |
| 18 | 0.08 | 3.3 | 0.03 | 0.06 | 0.01 | 0.01 | 0.01 Se | 0.00 | 3.3 | 0.01 | 0.06 | 0.00 | 0.00 | 0.01 Se |
| 19 | 0.08 | 3.3 | 0.03 | 0.07 | 0.01 | 0.01 | 0.01 Se, 0.06 Sn, 0.05 P | 0.00 | 3.3 | 0.00 | 0.07 | 0.00 | 0.00 | 0.01 Se, 0.06 Sn, 0.05 P |

TABLE 6B

| | Laser irradiation conditions | | | | | | | | | |
|---|---|---|---|---|---|---|---|---|---|---|
| | | | | Focused | Focused | | | | | Laser |
| | | | Steel | diameter | diameter | | | Irradiation | Instantaneous | irradiation |
| | | Steel sheet | sheet | in rolling | in width | | Speed | energy | power | interval |
| Steel | | temperature | tension | direction | direction | Output | Vc | density | density | L |
| No. | Atmosphere | ° C. | kg/mm² | Dl mm | Dc mm | PW | mm/s | Up J/mm² | Ip kW/mm² | mm |
| 1 | Nitrogen | 400 | 1.0 | 0.60 | 0.50 | 45 | 12 | 8 | 0.19 | 10 |
| 2 | Nitrogen | 400 | 1.0 | 0.60 | 0.50 | 45 | 12 | 8 | 0.19 | 10 |
| 3 | Nitrogen | 400 | 1.0 | 0.60 | 0.50 | 45 | 12 | 8 | 0.19 | 10 |
| 4 | Nitrogen | 400 | 1.0 | 0.60 | 0.50 | 45 | 12 | 8 | 0.19 | 10 |
| 5 | Nitrogen | 400 | 1.0 | 0.60 | 0.50 | 45 | 12 | 8 | 0.19 | 10 |
| 6 | Nitrogen | 400 | 1.0 | 0.60 | 0.50 | 45 | 12 | 8 | 0.19 | 10 |
| 7 | Nitrogen | 400 | 1.0 | 0.60 | 0.50 | 45 | 12 | 8 | 0.19 | 10 |
| 8 | Nitrogen | 400 | 1.0 | 0.60 | 0.50 | 45 | 12 | 8 | 0.19 | 10 |
| 9 | Nitrogen | 400 | 1.0 | 0.60 | 0.50 | 45 | 12 | 8 | 0.19 | 10 |
| 10 | Nitrogen | 400 | 1.0 | 0.60 | 0.50 | 45 | 12 | 8 | 0.19 | 10 |
| 11 | Nitrogen | 400 | 1.0 | 0.60 | 0.50 | 45 | 12 | 8 | 0.19 | 10 |
| 12 | Nitrogen | 400 | 1.0 | 0.60 | 0.50 | 45 | 12 | 8 | 0.19 | 10 |
| 13 | Nitrogen | 400 | 1.0 | 0.60 | 0.50 | 45 | 12 | 8 | 0.19 | 10 |
| 14 | Nitrogen | 400 | 1.0 | 0.60 | 0.50 | 45 | 12 | 8 | 0.19 | 10 |
| 15 | Nitrogen | 400 | 1.0 | 0.60 | 0.50 | 45 | 12 | 8 | 0.19 | 10 |
| 16 | Nitrogen | 400 | 1.0 | 0.60 | 0.50 | 45 | 12 | 8 | 0.19 | 10 |
| 17 | Nitrogen | 400 | 1.0 | 0.60 | 0.50 | 45 | 12 | 8 | 0.19 | 10 |
| 18 | Nitrogen | 400 | 1.0 | 0.60 | 0.50 | 45 | 12 | 8 | 0.19 | 10 |
| 19 | Nitrogen | 400 | 1.0 | 0.60 | 0.50 | 45 | 12 | 8 | 0.19 | 10 |

TABLE 6C

| | | | Maximum | Maximum | | | | | |
|---|---|---|---|---|---|---|---|---|---|
| | | | depth of | height of | | | | | |
| | Temperature | | recessed | protrusion on | | | | | |
| | rising rate in | Width of | part on | rear surface | | | Magnetic | | |
| | decarburization | deformed | laser | of laser | | Ratio of | flux | | |
| | annealing step | region | irradiated | irradiated | | abnormal | density | Space | |
| Steel | V | W | surface | portion | Steepness | grains | B8 | factor | |
| No. | ° C./s | mm | D_{recess} mm | Dₚᵣₒₜᵣᵤₛᵢₒₙ mm | 2Dₚᵣₒₜᵣᵤₛᵢₒₙ/W | % | T | % | Remarks |
| 1 | 1000 | 2.0 | 0.001 | 0.001 | 0.0010 | 0 | 1.93 | 97 | Invention |
| | | | | | | | | | Example |
| 2 | 1000 | 2.4 | 0.002 | 0.002 | 0.0017 | 0 | 1.93 | 97 | Invention |
| | | | | | | | | | Example |
| 3 | 1000 | 2.2 | 0.002 | 0.002 | 0.0018 | 0 | 1.94 | 97 | Invention |
| | | | | | | | | | Example |
| 4 | 1000 | 1.8 | 0.001 | 0.002 | 0.0022 | 0 | 1.94 | 97 | Invention |
| | | | | | | | | | Example |
| 5 | 1000 | 2.6 | 0.001 | 0.002 | 0.0015 | 0 | 1.93 | 97 | Invention |
| | | | | | | | | | Example |
| 6 | 1000 | 2.0 | 0.001 | 0.002 | 0.0020 | 0 | 1.93 | 97 | Invention |
| | | | | | | | | | Example |
| 7 | 1000 | 2.2 | 0.002 | 0.002 | 0.0018 | 0 | 1.93 | 97 | Invention |
| | | | | | | | | | Example |
| 8 | 1000 | 2.4 | 0.001 | 0.002 | 0.0017 | 0 | 1.94 | 97 | Invention |
| | | | | | | | | | Example |
| 9 | 1000 | 2.4 | 0.001 | 0.002 | 0.0017 | 0 | 1.93 | 98 | Invention |
| | | | | | | | | | Example |
| 10 | 1000 | 2.2 | 0.001 | 0.001 | 0.0009 | 0 | 1.94 | 97 | Invention |
| | | | | | | | | | Example |
| 11 | 1000 | 2.6 | 0.001 | 0.002 | 0.0015 | 0 | 1.93 | 97 | Invention |
| | | | | | | | | | Example |
| 12 | 1000 | 2.4 | 0.001 | 0.002 | 0.0017 | 0 | 1.95 | 98 | Invention |
| | | | | | | | | | Example |
| 13 | 1000 | 2.4 | 0.001 | 0.001 | 0.0008 | 0 | 1.94 | 98 | Invention |
| | | | | | | | | | Example |
| 14 | 1000 | 2.3 | 0.001 | 0.001 | 0.0009 | 0 | 1.94 | 98 | Invention |
| | | | | | | | | | Example |
| 15 | 1000 | 2.4 | 0.001 | 0.001 | 0.0008 | 0 | 1.96 | 98 | Invention |
| | | | | | | | | | Example |
| 16 | 1000 | 2.5 | 0.002 | 0.001 | 0.0008 | 0 | 1.93 | 98 | Invention |
| | | | | | | | | | Example |
| 17 | 1000 | 2.4 | 0.001 | 0.001 | 0.0008 | 0 | 1.94 | 98 | Invention |
| | | | | | | | | | Example |
| 18 | 1000 | 2.4 | 0.001 | 0.002 | 0.0017 | 0 | 1.93 | 97 | Invention |
| | | | | | | | | | Example |
| 19 | 1000 | 2.9 | 0.002 | 0.002 | 0.0014 | 0 | 1.93 | 97 | Invention |
| | | | | | | | | | Example |

Although the preferred embodiments of the present invention have been described in detail with reference to the accompanying drawings, the present invention is not limited to such examples. It is obvious that a person having ordinary knowledge in the technical field to which the present invention belongs can conceive various changes or modifications within the scope of the technical idea described in the claims, and it is naturally understood that these also belong to the technical scope of the present invention.

1. A grain-oriented electrical steel sheet comprising:
a base steel sheet having a chemical composition that contains, in mass %,
Si: 2.5 to 4.5%,
Mn: 0.01 to 1.00%,
N: 0.01% or less,
C: 0.01% or less,
sol.Al: 0.01% or less,
S: 0.01% or less,
Se: 0.01% or less,
P: 0.00 to 0.05%,
Sb: 0.00 to 0.50%,
Sn: 0.00 to 0.30%,
Cr: 0.00 to 0.50%,
Cu: 0.00 to 0.50%,
Ni: 0.00 to 0.50%, and
Bi: 0.0000 to 0.0100%,
with a remainder including Fe and impurities,
wherein a magnetic flux density B8 in a rolling direction of the grain-oriented electrical steel sheet is 1.93 T or more, a deformed region extending over an entire width of the grain-oriented electrical steel sheet is periodically formed at an interval L of 3 mm or more and 30 mm or less, in a direction intersecting the rolling direction of the grain-oriented electrical steel sheet,
the deformed region has a width W of 0.2 mm or more and 30.6 mm or less,
a protrusion having a maximum height Dₚᵣₒₜᵣᵤₛᵢₒₙ of 1 μm or more and 5 μm or less is formed on one surface of the deformed region, and a recessed part having a maximum depth D_{recess} of 1 μm or more and 4 μm or less is formed on an opposite surface.

2. A grain-oriented electrical steel sheet comprising:
a base steel sheet having a chemical composition that contains, in mass %,
Si: 2.5 to 4.5%,
Mn: 0.01 to 1.00%,
N: 0.01% or less,
C: 0.01% or less,
sol.Al: 0.01% or less,
S: 0.01% or less,
Se: 0.01% or less,
P: 0.00 to 0.05%,
Sb: 0.00 to 0.50%,
Sn: 0.00 to 0.30%,
Cr: 0.00 to 0.50%,
Cu: 0.00 to 0.50%,
Ni: 0.00 to 0.50%, and
Bi: 0.0000 to 0.0100%,
with a remainder including Fe and impurities,
wherein a magnetic flux density B8 in a rolling direction of the grain-oriented electrical steel sheet is 1.93 T or more, a deformed region extending over an entire width of the grain-oriented electrical steel sheet is periodically formed at an interval L of 3 mm or more and 30 mm or less, in a direction intersecting the rolling direction of the grain-oriented electrical steel sheet,
the deformed region has a width W of 0.2 mm or more and 30.6 mm or less,
a protrusion having a maximum height Dₚᵣₒₜᵣᵤₛᵢₒₙ of 1 μm or more and 8 μm or less is formed on one surface of the deformed region, a recessed part having a maximum depth D_{recess} of 1 μm or more and 8 μm or less is formed on an opposite surface, and the protrusion has a steepness 2Dₚᵣₒₜᵣᵤₛᵢₒₙ/W of 0.0001 or more and less than 0.0050.

3. The grain-oriented electrical steel sheet according to claim 1, wherein in the deformed region, a ratio of an area of grains whose crystal orientation is deviated from Goss orientation by 15° or more to an entire area of the deformed region is 5% or less.

4. The grain-oriented electrical steel sheet according to claim 1,
wherein the base steel sheet having a chemical composition that contains, in mass %, one or more of
P: 0.01 to 0.05%,
Sb: 0.01 to 0.50%,
Sn: 0.01 to 0.30%,
Cr: 0.01 to 0.50%,
Cu: 0.01 to 0.50%,
Ni: 0.01 to 0.50%, and
Bi: 0.0001 to 0.0100%.

5. A method for manufacturing a grain-oriented electrical steel sheet, the method comprising:
a hot rolling step of heating a slab having a chemical composition that contains, in mass %,
Si: 2.5 to 4.5%,
Mn: 0.01 to 1.00%,
N: 0.002 to 0.020%,
C: 0.02 to 0.10%,
sol.Al: 0.01 to 0.05%,
a total of one or two of S and Se: 0.01 to 0.05%,
P: 0.00 to 0.05%,
Sn: 0.00 to 0.30%,
Sb: 0.00 to 0.50%,
Cr: 0.00 to 0.50%,
Cu: 0.00 to 0.50%,
Ni: 0.00 to 0.50%, and
Bi: 0.0000 to 0.0100%,
with a remainder including Fe and impurities, and hot rolling the slab that has been heated to form a hot-rolled steel sheet;
a hot-band annealing step of annealing the hot-rolled steel sheet;
a cold rolling step of performing cold rolling on the hot-rolled steel sheet after the hot-band annealing step to form a cold-rolled steel sheet;
a decarburization annealing step of subjecting the cold-rolled steel sheet to decarburization annealing to form a decarburized annealed steel sheet;
a final annealing step of applying an annealing separator to the decarburized annealed steel sheet and then performing final annealing that forms a glass film on a surface of the decarburized annealed steel sheet to form a final annealed sheet; and
an insulating film forming step of applying an insulating film-forming liquid to the final annealed sheet and then performing heat treatment to form an insulating film on a surface of the final annealed sheet,
wherein the decarburization annealing step comprises a partial rapid heating step of heating the cold-rolled steel sheet to a temperature of 200° C. or more and 550° C. or less in a non-oxidizing atmosphere and under a tension of 0.2 kg/mm² or more and 1.2 kg/mm² or less and partial rapid heating a surface of the cold-rolled steel sheet over an entire width of the cold-rolled steel sheet, at an interval L within a range represented by Expression (1), in a direction intersecting a rolling direction; and
a temperature-raising step of raising a temperature of the cold-rolled steel sheet after the partial rapid heating step from a temperature range of 550° C. or lower to a temperature range of 750 to 950° C. at an average heating rate of 5° C./s or more and 2000° C./s or less in a non-oxidizing atmosphere; and
Expressions (2) to (4) are satisfied
when an average intensity applied to a portion to be partially and rapidly heated that is subjected to the partial rapid heating is denoted by P (W),
a diameter in a rolling direction of the portion to be partially and rapidly heated is denoted by Dl (mm),
a diameter in a sheet width direction of the portion to be partially and rapidly heated is denoted by Dc (mm),
a scanning speed in a sheet width direction of the portion to be partially and rapidly heated is denoted by Vc (mm/s),
an irradiation energy density is denoted by Up=4/π×P/(Dl×Vc), and
an instantaneous power density is denoted by Ip=4/π×P/(Dl×Dc),
$$3 mm \leq L \leq 30 mm \qquad ( 1 )$$
$$L / 50 \leq D 1 \leq L / 2 \qquad ( 2 )$$
$$5 J / {mm}^{2} \leq Up \leq 48 J / {mm}^{2} \qquad ( 3 )$$
$$0.05 kW / {mm}^{2} \leq Ip \leq 4.99 kW / {mm}^{2} \qquad ( 4 )$$

6. The method for manufacturing a grain-oriented electrical steel sheet according to claim 5, wherein the irradiation energy density Up further satisfies Expression (5),
$$5 J / {mm}^{2} \leq U p < 62.5 \times D 1 J / {mm}^{2} \qquad ( 5 )$$

7. The method for manufacturing a grain-oriented electrical steel sheet according to claim 5,
wherein the slab having a chemical composition that contains, in mass %, one or more of
P: 0.01 to 0.05%,
Sn: 0.01 to 0.30%,
Sb: 0.01 to 0.50%,
Cr: 0.01 to 0.50%,
Cu: 0.01 to 0.50%,
Ni: 0.01 to 0.50%, and
Bi: 0.0001 to 0.0100%.
